(19) United States
(12) Patent Application Publication
(10) Pub. No.: US 2025/0369857 A1
(43) Pub. Date: Dec. 4, 2025

(54) CLOUD-BASED SERVER AND WEB BASED APPLICATIONS FOR FORMING FLOW CYTOMETER PANELS, SIMULATING PERFORMANCE, AND INTERFACING WITH LAB EQUIPMENT

(71) Applicant: Cytek Biosciences, Inc., Fremont, CA (US)

(72) Inventors: Patrick Duncker, Fremont, CA (US); Zhenxiang Gong, Fremont, CA (US); Albert Mach, Fremont, CA (US); Zhenyu Zhang, Fremont, CA (US)

(73) Assignee: Cytek Biosciences, Inc., Fremont, CA (US)

(21) Appl. No.: 19/195,706

(22) Filed: Apr. 30, 2025

Related U.S. Application Data
(60) Provisional application No. 63/640,881, filed on Apr. 30, 2024.
(60) Provisional application No. 63/641,950, filed on May 2, 2024.

(51) Int. Cl. G01N 15/14; G01N 15/10; H04L 67/02; H04L 67/10

(52) U.S. Cl. CPC G01N 15/14; H04L 67/02; H04L 67/10; G01N 2015/1006

(57) ABSTRACT

In one embodiment, a method is disclosed to determine one or more biological cells of interest to identify and count in a mixed biological sample fluid with differing biological cells. The method can include selecting cell markers associated for biological cells to which conjugated antibodies can attach with differing fluorescent dyes; displaying a panel builder graphical user interface window to display a co-expression matrix by biological cell type to assist in selecting cell markers to assign co-expression; and selecting cell markers to assign co-expression with an input device.

### COPYRIGHT/TRADEMARK NOTICE

A portion of the disclosure of this patent document contains material to which a claim for copyright and trademark is made. The copyright and trademark owner has no objection to the reproduction of the patent document or the patent disclosure, as it appears in the U.S. Patent Office records, but reserves all other copyright and trademark rights whatsoever.

### CROSS-REFERENCE TO RELATED APPLICATIONS

This patent application claims the benefit of U.S. Provisional Patent Application No. 63/640,881 titled CLOUD-BASED SERVER AND WEB BASED APPLICATIONS FOR FORMING FLOW CYTOMETER PANELS, SIMULATING PERFORMANCE, AND INTERFACING WITH LAB EQUIPMENT filed on Apr. 30, 2024, by inventors Patrick Duncker et al., incorporated herein by reference for all intents and purposes. This patent application also claims the benefit of United States (US) Provisional Patent Application No. 63/641,950 titled CLOUD-BASED SERVER AND WEB BASED APPLICATIONS FOR FORMING FLOW CYTOMETER PANELS, SIMULATING PERFORMANCE, AND INTERFACING WITH LAB EQUIPMENT filed on May 2, 2024, by inventors Patrick Duncker et al., incorporated herein by reference for all intents and purposes.

This patent application is related to U.S. Non-Provisional patent application Ser. No. 17/304,843 titled METHODS OF FORMING MULTI-COLOR FLUORESCENCE-BASED FLOW CYTOMETRY PANEL filed on Jun. 26, 2021, by inventors Maria Jaimes et al., incorporated herein by reference for all intents and purposes. U.S. Non-Provisional patent application Ser. No. 17/304,843 claims the benefit of U.S. Provisional Patent Application No. 63/045,040 titled METHODS OF FORMING MULTI-COLOR FLUORESCENCE-BASED FLOW CYTOMETRY PANEL filed on Jun. 26, 2020, by inventors Maria Jaimes et al., incorporated herein by reference for all intents and purposes. Non-Provisional patent application Ser. No. 17/304,843 also claims the benefit of U.S. Provisional Patent Application No. 63/045,103 titled METHODS OF FORMING MULTI-COLOR FLUORESCENCE-BASED FLOW CYTOMETRY PANEL filed on Jun. 27, 2020, by inventors Maria Jaimes et al., incorporated herein by reference for all intents and purposes.

This patent application is further related to U.S. patent application Ser. No. 15/659,610 titled COMPACT DETECTION MODULE FOR FLOW CYTOMETERS filed on Jul. 25, 2017, by inventors Ming Yan et al., incorporated herein by reference for all intents and purposes. This patent application is further related to U.S. patent application Ser. No. 15/498,397 titled COMPACT MULTI-COLOR FLOW CYTOMETER filed on Apr. 26, 2017, by David Vrane et al. that describes a flow cytometer with which the embodiments can be used and is incorporated herein by reference for all intents and purposes. This patent application is further related to U.S. patent application Ser. No. 16/418,942 titled FAST RECOMPENSATION OF FLOW CYTOMETERY DATA FOR SPILLOVER READJUSTMENTS filed on May 21, 2019, by Zhenyu Zhang that describes matrices with which the embodiments can be used and is incorporated herein by reference for all intents and purposes.

### FIELD

The embodiments of the invention relate generally to web based software to support flow cytometers and flow cytometry experiments.

### BACKGROUND

Determining the chemicals to use in order to run experiments on different types of biological cells in a biological sample can be difficult. Preserving the liquid volume of a sample can make the determination even more challenging when desiring to run numerous tests with lab equipment. Previously, the determination of the chemicals to use to run flow cytometry experiments was simple with few lasers and few detectors, so much so that a manual determination could readily be made using an excel spreadsheet. With more lasers and a greater number of detectors to run many more tests on the same sample, a manual determination of the reagents (monoclonal antibodies) and the fluorochromes (fluorescent tags, fluorophores, fluorescent dyes) has become exceeding difficult. Much time has been devoted to selecting the different combinations of chemicals/reagents (conjugated antibodies) to optimize the end results of the flow cytometry experiments to gain information (e.g., types, counts, live/dead, etc.) about the mixture of biological cells in a biological sample. It is desirable to case the formation of flow cytometry experiments for biological samples. It is desirable to quickly optimize the selection of chemicals/reagents (conjugated antibodies) for flow cytometry experiments of biological samples with various configurations of flow cytometry lab equipment.

In some cases, chemical/reagent (conjugated antibodies) kits for some flow cytometry experiments of biological samples are prepared in advance for predetermined flow cytometry experiments. However, when new research is desirable, custom combinations of chemicals are often required that are more complex than basic predetermined flow cytometry experiments. It is desirable to support the formation of more complex flow cytometry experiments.

Preparing for and carrying out flow cytometry experiments often requires many steps and involves different workflows. Preparing for a biology experiment with a flow cytometer is typically a separate workflow. The acquisition of data from the biology experiment with the flow cytometer is typically a separate work flow. The analysis of output data from flow cytometry experiments is also typically a separate workflow. It is desirable to simplify the workflow of preparing flow cytometry experiments, carrying out the experiments, acquiring data from the experiments, and analyzing the data results of the experiments.

### BRIEF SUMMARY

The embodiments are generally summarized by the claims that follow below.

However, in some aspects the techniques described herein relate to a method for an interactive graphical user interface in communication with a flow cytometer cloud server, the method including: displaying a popup window on a display device with a user selectable button to transfer a paired assignment of a plurality of fluorescent tags (fluorochromes, fluorophores, fluorescent dyes) to a plurality of cell markers associated with a generated multi-color panel to an experiment builder; receiving a selection of the user selectable button; transferring the paired assignment of the plurality of fluorescent tags (fluorochromes, fluorophores, fluorescent dyes) and the plurality of cell markers to the experiment builder; auto-populating an experiment wizard of the experiment builder with the paired assignment of the plurality of fluorescent tags (fluorochromes, fluorophores, fluorescent dyes) and the plurality of cell markers; and displaying a fluorescent tag assignment window on the display device including an available fluorescent tags list, and a selected fluorescent tag list.

In some aspects, the techniques described herein relate to a method, further including displaying a sample loader version pull down menu for user selection of a sample loading device; displaying a carrier type pull down menu for a user selection of a manual tube, a tube rack, or one or more differing well plates based on the user selection of sample loading device;

In some aspects, the techniques described herein relate to a method, further including: displaying a reference group button for user selection; receiving a selection of reference group button; displaying a pop up window for user selection of one or more reference controls to form a single control sample for one or more fluorescent tags (fluorochromes) of the generated multi-color panel; receiving the selection; displaying the one or more single control samples for the selected one or more reference controls;

In some aspects, the techniques described herein relate to a method, further including displaying a user selection button for to add one or more biological samples to the list of samples to run within an experiment; and selecting the one or more biological samples to the list.

In some aspects, the techniques described herein relate to a method, further including displaying a marker GUI window prepopulated with the one or more markers, further including: exporting the experiment to a flow cytometer instrument. Wherein the exporting includes generating a zip (compressed data) file of the experiment template and one or more flow cytometer visualization worksheets associated with the experiment template; saving the zip file into the UADB of the cloud server; and downloading the zip file into a computer associated with the flow cytometer instrument.

In some aspects, the techniques described herein relate to a method, further including receiving one or more edits to the assignment of markers to fluorochromes in the interactive marker GUI window.

In some aspects, the techniques described herein relate to a method, further including: displaying a keywords GUI window including a chart displaying the sample listing of samples for the experiment and a plurality of cells to associate one or more keywords of meta data to one or more samples in the sample list and a keywords list sub window of available keywords to add to the chart; and receiving one or more selections of keywords from the keywords list to add to cells in the chart in a keyword column associated with one or more samples in the sample list.

In some aspects, the techniques described herein relate to a method, wherein: the one or more selections of keywords are added to cells by selecting the keyword from the keywords list and dragging and dropping it into a cell under the keyword column associated with the sample.

In some aspects, the techniques described herein relate to a method, wherein: receiving one or more values in one or more cells in a value column in the chart paired with the one or more keywords in the keyword column.

In some aspects, the techniques described herein relate to a method, further including displaying a default visualization worksheet; receiving one or more edits to the assignment of markers to fluorochromes in the interactive marker GUI window.

In some aspects, the techniques described herein relate to a method, further including exporting the experiment to a flow cytometer instrument.

In some aspects, the techniques described herein relate to a method, wherein the exporting includes Generating a zip (compressed data) file of the experiment template that includes experiment data and information prepared by the wizard, and one or more flow cytometer visualization worksheets associated with the experiment template; Saving the zip file into the UADB of the cloud server; and Downloading the zip file into a computer associated with the flow cytometer instrument.

In some aspects, the techniques described herein relate to an apparatus including: a display device; and a processor coupled to the display device, the processor executing instructions to perform the function of displaying an interactive assign co-expression graphical user interface window on the display device including: displaying a co-expression by marker button and a co-expression by cell type button for selection one at a time by a user; receiving a selection of the co-expression by cell type button; and displaying a co-expression matrix of markers by cell type.

In some aspects, the techniques described herein relate to an apparatus, wherein the displaying of the co-expression matrix includes displaying in a header of the co-expression matrix a plurality of selected cell markers for a multicolor panel; displaying in a pull down menu a list of a plurality of cell types associated with the plurality of selected cell markers; receiving a selection of one or more cell types selected from the pull down menu; displaying in a row index of the co-expression matrix one or more selected cell types; and receiving one or more selections in the co-expression matrix wherein a selection indicates the cell type in the row expresses the marker in the column so that fluorochromes can be subsequently assigned to the marker.

In some aspects, the techniques described herein relate to an apparatus, wherein the displaying of the co-expression matrix includes displaying in a row index of the co-expression matrix a plurality of selected cell markers for a multicolor panel; displaying in a pull down menu a list of a plurality of cell types associated with the plurality of selected cell markers; receiving a selection of one or more cell types selected from the pull down menu; displaying in a header of the co-expression matrix one or more selected cell types; and receiving one or more selections in the co-expression matrix wherein a selection indicates the cell type in the column expresses the marker in the row so that fluorochromes can be subsequently assigned to the marker.

In some aspects, the techniques described herein relate to an apparatus, wherein the displaying of the co-expression matrix further includes displaying in a sub-header under the header an interactive selectable pixel area under each marker to show if all or less than all of the cells are selected for co-expression with a given marker.

In some aspects, the techniques described herein relate to an apparatus, wherein the interactive selectable pixel area under each marker to further receive a selection that all of the cells are selected for co-expression with the given marker.

In some aspects, the techniques described herein relate to an apparatus, wherein the interactive selectable pixel area under each marker to further receive a selection that none of the cells are selected for co-expression with the given marker and the interactive selectable pixel area is displayed as being empty.

In some aspects, the techniques described herein relate to an apparatus, wherein the selectable pixel area is a selectable check box.

In some aspects, the techniques described herein relate to an apparatus, wherein the selectable pixel area shows a check mark in the selectable check box to indicate that all of the cells are selected for co-expression with the given marker.

In some aspects, the techniques described herein relate to an apparatus, wherein the selectable pixel area shows a dash in the selectable check box to indicate that all of the cells are selected for co-expression with the given marker.

In some aspects, the techniques described herein relate to an apparatus, wherein the displaying of the co-expression matrix includes displaying grid lines along rows and columns to show interactive selectable pixel areas defined by the grid lines.

In some aspects, the techniques described herein relate to an apparatus, wherein the plurality of cell types displayed for selection in the pull down menu includes two or more of CD4 T cells, CD8 T cells, monocytes, NK cells NKT cells, gd T cells, pDC, and B cells.

In some aspects, the techniques described herein relate to an apparatus, wherein the plurality of cell markers in the heading including two or more of CD4, CD8, CD56, CD3, TCR ad, CD335, CD14, CD45, MHC Class II (HLA-DR), CD45RA, CD25, CD123, and CD19.

In some aspects, the techniques described herein relate to an apparatus, further including receiving a selection of the co-expression by marker button; and displaying a co-expression matrix of markers by marker.

In some aspects, the techniques described herein relate to an apparatus, wherein the displaying a co-expression matrix of markers by marker includes: displaying in a header and a row index of the co-expression matrix a plurality of pre-selected cell markers for a multicolor panel; receiving one or more selections in the co-expression matrix wherein a selection indicates the marker in the row expresses with the marker in the column so that fluorochromes can be subsequently assigned to the marker.

In some aspects, the techniques described herein relate to an apparatus, wherein the receiving one or more selections in the co-expression matrix includes: receiving a selection in a top triangle of the co-expression matrix; and mirroring the selection across a diagonal into a bottom triangle of the co-expression matrix.

In some aspects, the techniques described herein relate to an apparatus, wherein the receiving one or more selections in the co-expression matrix includes: receiving a selection in a bottom triangle of the co-expression matrix; and mirroring the selection across a diagonal into a top triangle of the co-expression matrix.

In some aspects, the techniques described herein relate to an apparatus, wherein the displaying of the co-expression matrix further includes displaying in a sub-index adjacent the row index an interactive selectable pixel area adjacent each marker to show if all or less than all of the markers are selected for co-expression with a given marker.

In some aspects, the techniques described herein relate to an apparatus, wherein the interactive selectable pixel area adjacent each marker to further receive a selection that all of the markers are selected for co-expression with the given marker.

In some aspects, the techniques described herein relate to an apparatus, wherein the interactive selectable pixel area adjacent each marker to further receive a selection that none of the markers are selected for co-expression with the given marker and the interactive selectable pixel area is displayed as being empty.

In some aspects, the techniques described herein relate to an apparatus, wherein the selectable pixel area is a selectable check box.

In some aspects, the techniques described herein relate to an apparatus, wherein the selectable pixel area shows a check mark in the selectable check box to indicate that all of the markers are selected for co-expression with the given marker.

In some aspects, the techniques described herein relate to an apparatus, wherein the selectable pixel area shows a dash in the selectable check box to indicate that not all of the markers are selected for co-expression with the given marker.

In some aspects, the techniques described herein relate to an apparatus, wherein the selectable pixel area shows empty to indicate that none of the markers are selected for co-expression with the given marker.

In some aspects, the techniques described herein relate to an apparatus, wherein the displaying of the co-expression matrix includes displaying grid lines along rows and columns to show interactive selectable pixel areas defined by the grid lines.

In some aspects, the techniques described herein relate to an apparatus, wherein the grid lines define interactive selectable pixel areas as selectable check boxes and a check mark in a selectable check box indicates that marker in the row is selected for co-expression with the differing marker in the column.

In some aspects, the techniques described herein relate to an apparatus, wherein the receiving one or more selections in the co-expression matrix includes: receiving a selection of a button to display a top triangle of the co-expression by marker matrix; displaying a top triangle of the co-expression matrix; and receiving the one or more selections in the top triangle of the co-expression matrix.

In some aspects, the techniques described herein relate to an apparatus, wherein the receiving one or more selections in the co-expression matrix includes: receiving a selection of a button to display a bottom triangle of the co-expression by marker matrix; and displaying a bottom triangle of the co-expression matrix; and receiving the one or more selections in the bottom triangle of the co-expression matrix.

In some aspects, the techniques described herein relate to an apparatus, wherein the co-expression matrix of markers by marker is prepopulated with selections of co-expression by cell type; and the co-expression matrix of markers by marker is shown grayed out to indicate that it is non-interactive.

In some aspects, the techniques described herein relate to an apparatus, further including: displaying an enable button to edit the selections in the co-expression by marker matrix; receiving a selection to enable the editing of the selections in the co-expression by marker matrix; and receiving one or more edits to the pre-populated selections in the co-expression by marker matrix wherein a selection indicates the marker in the row expresses with the marker in the column so that fluorochromes can be subsequently assigned to the marker.

In some aspects, the techniques described herein relate to an apparatus, further including: a graphics processor coupled to and between the display device and the processor to generate user interface windows for display on the display device.

In some aspects, the techniques described herein relate to an apparatus, further including: a network interface controller coupled to the processor, the network interface controller further coupled in communication with a flow cytometer cloud server and a universal aggregate data base, the processor to gain access to the flow cytometer cloud server and the universal aggregate data base via a user account to execute applications to build one or more multicolor flow cytometer panels and to build one or more biological experiments for a selected configuration of a flow cytometer.

In some aspects, the techniques described herein relate to an apparatus, further including: a network interface controller coupled to the processor, the network interface controller further coupled in communication with a flow cytometer cloud server and a universal aggregate data base, the processor to gain access to the flow cytometer cloud server and the universal aggregate data base via an instrument account to interface with a flow cytometer having a selected configuration to execute one or more biological experiments with flow cytometer.

In some aspects, the techniques described herein relate to an apparatus including a display device; and a processor coupled to the display device, wherein the processor executes instructions stored in a storage device to perform various functions to display windows of a graphical user interface. The various functions can include displaying an interactive panel editor graphical user interface window further, receiving a selection of the panel matrix button; and displaying, in a selectable sub window portion, an interactive generated multicolor panel matrix.

In some aspects, the techniques described herein relate to an apparatus, wherein one of the plurality of buttons is a similarity matrix button that is selected; and the displaying the interactive panel editor graphical user interface window further includes: displaying, in the selectable sub window portion, a similarity matrix for the fluorochromes selected in the interactive generated multicolor panel matrix.

In some aspects, the techniques described herein relate to an apparatus, wherein one of the plurality of buttons is a stain index reduction button that is selected; and the displaying the interactive panel editor graphical user interface window further includes: displaying, in the selectable sub window portion, a stain index reduction matrix for the fluorochromes selected in the interactive generated multicolor panel matrix.

In some aspects, the techniques described herein relate to an apparatus, wherein one of the plurality of buttons is a spillover spreading matrix (SSM) button that is selected; and the displaying the interactive panel editor graphical user interface window further includes: displaying, in the selectable sub window portion, a spillover spreading matrix for the fluorochromes selected in the interactive generated multicolor panel matrix.

In some aspects, the techniques described herein relate to an apparatus, wherein displaying the interactive panel editor graphical user interface window includes displaying a computed complexity index value for the fluorochromes in the generated multicolor panel matrix.

In some aspects, the techniques described herein relate to an apparatus, wherein displaying the interactive panel editor graphical user interface window further includes receiving a change to a fluorescent tag (fluorochrome) in the interactive fluorescent tag assignment list; and updating in real time the interactive generated multicolor panel matrix and the spectrum view signature chart to reflect the change in the fluorescent tag; and recomputing a score. That is, when a fluorescent tag and marker pair assignment in the generated multicolor panel matrix are changed, the interactive fluorescent tag assignment list and the interactive spectrum view signature chart are updated in real time to reflect the change in the fluorescent tag and marker pair assignment. Moving a marker pair and selecting a new fluorochrome paired to the marker in the generated multicolor panel matrix from a first laser and a first center detection wavelength pair to a second laser and a second center emission wavelength, the interactive fluorescent tag assignment list and the interactive spectrum view signature chart are updated in real time to reflect the change in the laser and the center detection wavelength pair. When moving a marker and selecting a new fluorochrome paired to the marker in the generated multicolor panel matrix from a first laser and a first center emission wavelength pair to the first laser and a second center emission wavelength, the interactive fluorescent tag assignment list and the interactive spectrum view signature chart are updated in real time to reflect the change in the center detection wavelength. When changing a fluorescent tag in the generated multicolor panel matrix, the interactive fluorescent tag assignment list and the interactive spectrum view signature chart are updated in real time to reflect the change in the fluorescent tag.

In some aspects, selecting a plot in the spectrum viewer window brings up a text window that indicates the selected fluorochrome.

In some aspects, displaying a selectable bar with a plurality of buttons are displayed to select what is displayed in a window. When a show coexpression button is selected, a panel matrix is displayed with color boxes around the marker names in the panel matrix that are coexpressed. In some aspects, an apparatus further performed functions including displaying a pull down menu to select a single marker to display coexpression; displaying a popup window to select a matrix to display in the matrix window; and reducing the size of matrices (SIR Matrix, SSM, similarity) based on the markers that are coexpressed.

In some aspects, the techniques described herein relate to an apparatus: wherein changing a fluorescent tag in the interactive fluorescent tag assignment list or the interactive generated multicolor panel matrix such that values for the matrices (SIR Matrix, SSM, similarity) are computed and updated in real time to reflect the change in the fluorescent tag and the value of the score of the displayed complexity index is updated in real time to reflect the change in the fluorescent tag.

In some aspects, the techniques described herein relate to a computer device including: a processor to execute instructions; a display device in communication with the processor; an input device coupled in communication with the processor; and a storage device coupled in communication with the processor, the storage device to store instructions for execution by the processor, the instructions when executed by the processor perform functions including: receiving, from the input device, a selection of one or more biological cell markers associated with one or more biological cells to which conjugated antibodies can attach with differing fluorescent dyes so the one or more biological cells can be identified and counted in a biological sample fluid; displaying on the display device, a third panel builder graphical user interface window with a pair of buttons to select co-expression by biological cell marker or co-expression by biological cell type in a co-expression matrix, wherein co-expression by biological cell type is selected for illustrating the co-expression matrix selecting cell markers to assign co-expression; displaying on the display device, in the third panel builder graphical user interface, the co-expression matrix by biological cell type based on the selected button; and in the co-expression matrix displayed by the panel builder graphical user interface on the display device, selecting with the input device, cell markers to assign co-expression to one or more biological cells expected within a biological sample.

In some aspects, the techniques described herein relate to a method for building a flow cytometer multi-color experimental panel to analyze, identify, and count differing biological cells of interest in a mixed biological sample fluid, the method including: receiving a selection of one or more biological cell markers associated with one or more biological cells to which conjugated antibodies can attach with differing fluorescent dyes so the one or more biological cells can be identified and counted in a biological sample fluid; displaying, on a display device, a third panel builder graphical user interface window with a pair of buttons to select co-expression by biological cell marker or co-expression by biological cell type in a co-expression matrix, wherein co-expression by biological cell type is selected for illustrating the co-expression matrix selecting cell markers to assign co-expression; displaying, in the third panel builder graphical user interface, the co-expression matrix by biological cell type based on the selected button; and in the co-expression matrix displayed by the panel builder graphical user interface, selecting, with an input device, cell markers to assign co-expression to one or more biological cells expected within a biological sample.

In some aspects, the techniques described herein relate to a method, wherein a second panel builder graphical user interface window is displayed on the display device for selecting the biological cell markers associated with the one or more biological cells.

In some aspects, the techniques described herein relate to a method, further including, displaying a first panel builder graphical user interface window to enter a panel name with the input device to identify the flow cytometer color experimental panel.

In some aspects, the techniques described herein relate to a method, wherein the input device is a touch-screen, keyboard, or mouse.

In some aspects, the techniques described herein relate to a method, wherein the co-expression matrix is displayed in the third panel builder graphical user interface window with a plurality of cell types along the Y axis and a plurality of biological cell markers along the X axis.

In some aspects, the techniques described herein relate to a method, further including displaying a transpose button in the third panel builder graphical user interface window to transpose axes in the co-expression matrix so that the co-expression matrix is displayed in the third panel builder graphical user interface window with a plurality of cell types along the X axis and a plurality of biological cell markers along the Y axis.

In some aspects, the techniques described herein relate to a method, further including displaying a fourth panel builder graphical user interface window with a picture in picture window overlay to enter requirements to associate fluorescent tags (dyes) with the selected markers in the co-expression matrix.

In some aspects, the techniques described herein relate to a method, wherein: the requirements include restricting fluorescent tags to primary lasers, excluding one or more of fluorescent tags, excluding one or more suppliers of reagents (conjugated antibodies), and prioritizing user selected suppliers of reagents (conjugated antibodies).

In some aspects, the techniques described herein relate to a method, wherein: the picture in picture window overlay includes a run button to generate a multicolor panel based on the entered requirements and the selections within the co-expression matrix assigning co-expression of cell markers to biological cells.

In some aspects, the techniques described herein relate to a method, further including: generating a multicolor panel in response to the run button being selected; and displaying an interactive panel builder window based on the generated multicolor panel including a tag assignment window portion for the multicolor panel in the multicolor panel window illustrating a plurality of fluorescent tags assigned to the plurality of biological cell markers associated with the plurality of cells of interest; a spectral chart view window portion plotting fluorescent light intensity for each of the plurality of assigned fluorescent tags over detector channels in a selected configuration of a flow cytometer; and a panel matrix window portion charting the markers and associated assigned fluorescent tags for each excitation laser of the flow cytometer that excites the associated assigned fluorescent tags per the emission generated by the associated assigned fluorescent tags.

In some aspects, the techniques described herein relate to a method, wherein displaying the interactive panel builder window further includes in the tag assignment window portion displaying a first variable length color bar adjacent each marker, wherein a length of the first variable length color bar represents a level of expression of the respective marker; and a plurality of variable length color bars differing from the first adjacent each assigned differing fluorescent tag, wherein a color of the plurality of variable length color bars represents the associated laser that excites the respective fluorescent tag, and a length of the plurality of variable length color bars represents a level of fluorescent light intensity of the respective fluorescent tag.

In some aspects, the techniques described herein relate to a method, wherein displaying the interactive panel builder window further includes in the panel matrix window portion displaying a first variable length color bar adjacent each marker, wherein a length of the first variable length color bar represents a level of expression of the respective marker; and a plurality of variable length color bars differing from the first adjacent each assigned differing fluorescent tag, wherein a color of the plurality of variable length color bars represents the associated laser that excites the respective fluorescent tag, and a length of the plurality of variable length color bars represents a level of fluorescent light intensity of the respective fluorescent tag.

In some aspects, the techniques described herein relate to a computer network including: a cloud server in communication with a wide area network, the cloud server including at least one processor, a memory, and a storage device to execute web based applications associated with flow cytometry. The computer network further includes at least one spectral flow cytometer coupled in communication with the cloud server over the wide area network to receive the user developed biology experiments. associated with multi-color flow cytometer panels. The at least one spectral flow cytometer can be a full spectrum flow cytometer having a preselected configuration associated with the flow cytometer panel and the user developed biology experiment. The at least one spectral flow cytometer executes the user developed biology experiment associated with the flow cytometer panel on a biology sample.

In some aspects, the techniques described herein relate to a computer network, wherein the at least one user interface displayed by the at least one client device requests the cloud server perform a data analysis on the stored event results; and the cloud server recalls the stored event results associated with the generated user developed biology experiment from the unified aggregated database and performs the data analysis on the event results under direction of the at least one client device and displays the data analysis on the display device of the at least one client device.

In some aspects, the techniques described herein relate to a computer network, that further includes at least one laboratory equipment; a lab computer coupled in communication with the least lab equipment and the cloud server over the wide area network. The lab computer has a processor executing instructions for an instrument cloud account coupling the least one laboratory equipment in communication with the cloud server over the wide area network to synchronize data and information regarding the at least one laboratory equipment stored in the uniform aggregated data base in order to support flow cytometry biology experiments with a flow cytometer or cell sorter (sorting flow cytometer). The generated multi-color panel for the biology experiment is generated with a first user account. The generated multicolor panel and the biology experiment are shared with a second user account to read and run the biology experiment with a spectral flow cytometer to obtain event results with a biological sample.

In some aspects, the techniques described herein relate to a computer network, wherein the cloud server communicates with the computer associated with the at least one lab equipment to download the generated multicolor panel and the biology experiment to the computer associated with the at least one lab equipment to prepare the biology experiment.

In some aspects, the techniques described herein relate to a computer network, wherein the cloud server to upload the generated multicolor panel and biology experiment to the at least one lab equipment to prepare the biology experiment.

In some aspects, the techniques described herein relate to a computer network, wherein the at least one lab equipment to upload the event results of the biology experiment to the cloud server for data analysis.

In some aspects, the techniques described herein relate to a computer network, wherein the wide area network is the internet (world wide web); the cloud server is located in a data center coupled in communication with the internet; the at least one laboratory equipment is remotely located in a laboratory coupled in communication with the internet to communicate with the cloud server; and the at least one client device is remotely located and coupled in communication with the internet to communicate with the cloud server.

In some aspects, the techniques described herein relate to a computer server for preparing biology experiments for laboratory equipment, the computer server including: at least one microprocessor to execute software instructions; at least one memory device coupled to the at least one microprocessor to store software instructions for execution by the at least one microprocessor; a network interface device coupled to the at least one microprocessor to couple the computer server in communication with a wide area network, wherein the wide area network is the world wide web or the internet; a storage drive coupled to the at least one microprocessor, the storage drive to store at least portions of a unified aggregated data base for a flow cytometry lab equipment network and a plurality of software instructions for flow cytometer server applications executed by the at least one microprocessor, the flow cytometer server applications including a periodic downloader to periodically search the internet for suppliers of chemicals and reagents for flow cytometer biology experiments, the periodic downloader to download specifications and information regarding a plurality of reagent antibodies and a plurality of fluorochromes used in the flow cytometer biology experiments, wherein the information includes a supplier name, an ordering name or number, and a uniform resource locator (URL) or internet protocol (IP) address to order the respective reagent antibody and/or fluorochrome; and a specification translator in communication with the periodic web crawler and the unified aggregated data base, the specification translator to translate the specifications of the plurality of reagents into a universal reagent specification format and store the translated specifications of the plurality of reagents into the unified aggregated data base, the specification translator to further translate the specifications of the plurality of fluorochromes into a universal fluorochrome specification format and store the translated specifications of the plurality of fluorochromes into the unified aggregated data base.

In some aspects, the techniques described herein relate to a computer server, wherein the periodic downloader periodically downloads specifications and information regarding a plurality of buffer chemicals, wherein the information includes a supplier name, an ordering name or number, and a uniform resource locator (URL) or internet protocol (IP) address to order the respective buffer chemical; and the specification translator to further translate the specifications of the plurality of buffer chemicals into a universal buffer specification format and store the translated specifications of the plurality of buffer chemicals into the unified aggregated data base.

In some aspects, the techniques described herein relate to a computer server, wherein the flow cytometer server applications further include: a flow cytometer multicolor panel builder to generate a flow cytometer multicolor panel based on user selected cell surface markers specifying reagent antibodies that attach to the cell surface marker, user selected fluorochrome requirements, and a full spectrum flow cytometer configuration, wherein the generated flow cytometer multicolor panel includes the plurality of user selected cell surface markers, a plurality of reagents associated with the user selected cell surface markers, and a plurality of automatically chosen fluorochromes associated with the plurality of reagents.

In some aspects, the techniques described herein relate to a computer server, wherein the flow cytometer server applications further include: a flow cytometer spectrum viewer to generate a chart, for display on a display device, of spectral signatures of all of the chosen fluorochromes in the generated flow cytometer multicolor panel, wherein the chart displays normalized intensity versus detector channel for plots of each spectral signature of all the chosen fluorochromes.

In some aspects, the techniques described herein relate to a computer server, wherein the flow cytometer server applications further include: an experiment editor to receive the generated flow cytometer multicolor panel and form an experiment template for the configuration of the full spectrum flow cytometer based on the generated multicolor panel, wherein the experiment template indicates calibration test tubes and sample test tubes with the respective reagents and the respective fluorochromes run through the configuration of the full spectrum flow cytometer.

In some aspects, the techniques described herein relate to a computer server, wherein the flow cytometer server applications further include: an auto populator executed in a background process instead of a foreground process to receive one or more user changes and calculate output results in real time based on the one or more user changes, and populate the one or more user changes and respective output results to each of the flow cytometer server applications so that output results can be displayed in real time in an interactive graphical user interface.

In some aspects, the techniques described herein relate to a computer server, wherein the flow cytometer server applications further include: an experiment editor to receive the generated flow cytometer multicolor panel and form an experiment template for the configuration of the full spectrum flow cytometer based on the generated multicolor panel, wherein the experiment template indicates calibration test tubes and sample test tubes with the respective reagents and the respective fluorochromes run through the configuration of the full spectrum flow cytometer.

In some aspects, the techniques described herein relate to a computer server, wherein the flow cytometer server applications further include: an auto populator software application executed in a background process instead of a foreground process to receive one or more user changes, to calculate output results in real time based on the one or more user changes, and to populate the one or more user changes and respective output results to each of the flow cytometer server applications so that output results can be displayed in real time in an interactive graphical user interface.

### BRIEF DESCRIPTIONS OF THE DRAWINGS

This patent or application file contains at least one drawing executed in color. Copies of this patent or patent application publication with color drawing(s) will be provided by the United States Patent and Trademark Office upon request and payment of the necessary fec.

These drawings and other features, aspects will become better understood with regards to the following description, appended claims, and accompanying drawings where:

FIG. 1 shows a functional block diagram of a flow cytometer cloud network computer system.

FIG. 2 shows a functional block diagram of a flow cytometer cloud server system with a unified aggregated data base (UADB) networked to a client computer to display user interfaces of a flow cytometer cloud based software platform.

FIG. 3A shows a functional block diagram of data aggregated into the unified aggregated data base (UADB) and its interface to the web browser software applications of the flow cytometer cloud based software platform to provide the various graphical user interfaces.

FIG. 3B shows a functional block diagram of acquiring, translating, and uniformly aggregating specification data of chemicals from chemical suppliers into the unified aggregated data base (UADB).

FIG. 3C shows a functional block diagram of components of the flow cytometer cloud server software interfacing with the unified aggregated data base (UADB) and the generation of interactive graphical user interfaces in a web browser.

FIG. 3D shows a block diagram of web applications provided by the flow cytometer cloud server and some of the data in the unified aggregated data base (UADB) that is stored and accessed in the generation of interactive graphical user interfaces in a web browser.

FIG. 4A shows a functional block diagram of a login user interface screen displayed by a processor on a display device for access to the flow cytometer cloud network.

FIG. 4B shows a block diagram of data saved in the unified aggregated data base (UADB) for a user account.

FIG. 4C shows a block diagram of data saved in the unified aggregated data base (UADB) for a user account.

FIG. 5A shows a user interface of saved flow cytometry color experimental panels (often referred to as “multicolor panels” herein) associated with a user that is logged into the flow cytometer cloud network.

FIG. 5B shows an expanded side bar of the user interface when logged into the flow cytometer cloud network.

FIG. 5C shows a panel detail pop up window with details of a panel matrix representing a multicolor panel that was selected by a user.

FIG. 6 shows a user interface of a find panels window generated by the flow cytometer cloud system and displayed by a web browser on a display device.

FIGS. 7, 8A-8D, 9A-9D, 10A-10B, 11A-11C, 12A-1 through 12B, 13, 14A-1 through 14K, 15, and 16A-16C illustrate various user interface windows of the tabs associated with the software routines generated by the panel builder software.

FIGS. 17-20 and 21A illustrate various graphical user interface windows associated with the tabs associated with software routines generated by the experiment editor (builder) software.

FIG. 21B illustrates a default gating worksheet for the export of an experiment to a flow cytometer instrument.

FIG. 21C illustrates a customized gating worksheet for the export of an experiment to a flow cytometer instrument.

FIGS. 22-23 illustrate views of graphical user interface (GUI) windows generated by a library editor displayed on a monitor of a computer system.

FIGS. 24A-1 through 24A-5, 24B-1 through 24B-2, 24C-1 through 24C-2, and 24D-1 through 24D-2 illustrate graphical user interface (GUI) windows generated by a spectrum viewer software application displayed on a monitor of a computer system.

FIGS. 25A-25B illustrate graphical user interface (GUI) windows generated by a flow cytometer data analysis software application displayed on a monitor of a computer system.

FIG. 26 is a basic conceptual diagram of a flow cytometer system.

FIG. 27A is a conceptual diagram of a fluorochrome (fluorescent tag), a monoclonal antibody, and a cell.

FIG. 27B is a conceptual diagram of forming a reference sample with a bead.

FIG. 28A is an overall method for performing an experiment with a biological sample and/or running calibration beads through a flow cytometer.

FIG. 28B is a diagram of a calibrating process of a flow cytometer with single stained compensation controls to generate an initial spillover matrix or reference matrix with levels of compensation.

FIG. 28C is a diagram of running a sample through the flow cytometer resulting in a mixed sample event vector with an overlapping spectral profile due to multi-stained cells or particles.

FIG. 28D is a diagram of a processing using an inverse matrix (determined from the initial spillover matrix and/or the initial reference matrix with fine adjustments) on the event data to generate a compensated sample event vector or an unmixed sample event vector.

FIG. 28E-1 is a schematic diagram of a full spectrum flow cytometer.

FIG. 28E-2 are spectral graphs of wavelengths of light over which the detector modules of the full spectrum flow cytometer can detect.

FIG. 28F shows configuration details of the photo detectors in the detector modules for a full spectrum flow cytometer.

FIGS. 28G (28G-1 and 28G-2) illustrates the individual spectrum signature of each color laser and combined full spectrum signature of an exemplary fluorochrome.

FIG. 29 is a listing of the exemplary cell markers and fluorochromes in a 28 color Optimized Multicolor Immunofluorescence Panel (OMIP).

FIG. 30A illustrates the spectrum signature of BUV737.

FIG. 30B illustrates the spectrum signature of BV421.

FIG. 31 is a top view of an optical plate assembly in a modular flow cytometry system with three excitation lasers.

FIG. 32 is a top view of an optical plate assembly in a modular flow cytometry system with five excitation lasers, including a UV excitation laser, of the full spectrum flow cytometer.

FIG. 33 illustrates a plurality of configurations for the modular flow cytometer.

FIGS. 34A-34B are block diagrams of a computer system that can execute software instructions to display a graphical user interface and remotely interact with web-based flow cytometer software applications served by the flow cytometer cloud server.

### DETAILED DESCRIPTION

In the following detailed description of the disclosed embodiments, numerous specific details are set forth in order to provide a thorough understanding. However, it will be obvious to one skilled in the art that the disclosed embodiments may be practiced without these specific details. In other instances, well known methods, procedures, components, and subsystems have not been described in detail so as not to unnecessarily obscure aspects of the disclosed embodiments.

Generally, a flow cytometer cloud network includes client computers and one or more computer servers that provide a suite of web based applications (online tools) to simply working with flow cytometers and other laboratory equipment in laboratories to perform flow cytometry experiments on biological cells in biological samples. The suite of web based applications include a panel builder to build flow cytometry color experimental panels, and an experiment editor to build the experiments to run with a flow cytometer. For example, the panel builder web based application can generate a multicolor panel based on user criteria and simulate its performance using a flow cytometer and view the full spectrum signature of the fluorochromes that are used in the multicolor panel to identify different cells in a biological sample.

Once a user is satisfied with the flow cytometer multi-color experiment panel, another web based application of the flow cytometer cloud network can be used to prepare for an experiment by ordering the associated chemicals/reagents (conjugated antibodies) and fluorescent tags (fluorochromes, fluorophores, fluorescent dyes) for the multicolor panel over the internet or world wide web from the one or more suppliers that can supply those chemicals/reagents. Experiments can be formed using an experiment builder and its editor to form the experimental workflow for a flow cytometer using the multicolor panel. After the chemicals/reagents are known to be available, the multicolor panel information saved in the flow cytometer cloud network can be uploaded into various lab equipment in the network. For example, the multicolor panel information can be downloaded into a cocktail mixer to mix the chemicals/reagents into one or more test tubes ready to receive the biological sample. The multicolor panel information saved in flow cytometer cloud network can be downloaded into a flow cytometer in the network for initial set up and calibration so that an experiment can be run with the biological sample and the mixed chemicals.

The event data results output by the lab equipment (flow cytometer) or instrument associated with the multicolor panel experiment run on biological samples can be acquired from the lab equipment, uploaded/transmitted to a cloud server, and stored in a universal aggregated database associated with the multicolor panel experiment. The stored data from the lab equipment can then be analyzed with analysis software. A user can compare past results run using the same multicolor panel experiment and lab equipment with newer results of a different biological sample. The repeated experiments and saved results can verify the past research by different users using the same multicolor panel experiment with the same testing chemicals and similar lab equipment. Remote independent labs with lab technicians can be contracted out by researchers of research companies to perform the multicolor panel flow cytometer experiments. The researchers can share the multicolor panel and the associated experiment information with lab technicians through the flow cytometer cloud system.

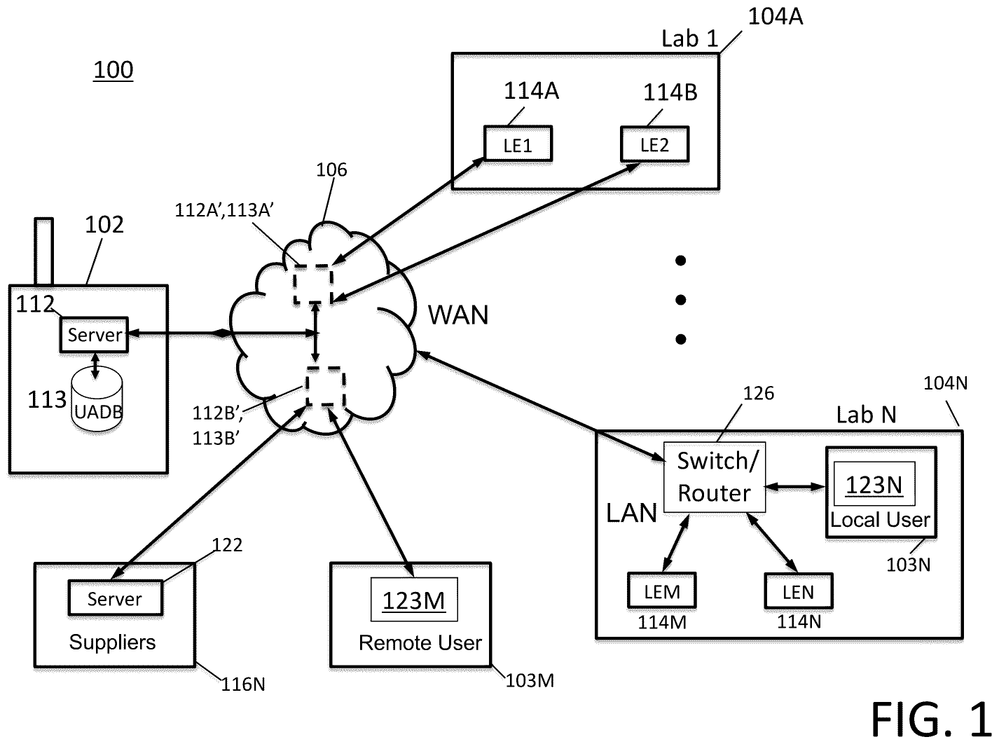

Referring now to FIG. 1, a flow cytometer cloud system 100 is shown. The flow cytometer cloud system 100 includes one or more flow cytometer cloud servers 112, 112A′, 112B′ (collectively referred to herein by reference number 112) coupled to one or more of a unified aggregated data base (UADB) 113, 113A′, 113B′ (collectively referred to herein by reference number 113). The cloud server 112, 112A′, 112B′ is communication with a plurality of lab equipment devices LE1-LEN 114A-114N at a plurality of laboratories LAB1-LABN 104A-104N, one or more remote users 103M by remote client computer devices 123M, and one or more local users 103N by local client computer devices 123N. The cloud server 112, 112A′, 112B′ can be in communication with one or more reagent suppliers 116N through their respective servers 122N as well so that a user 103N, 103M can order reagents to a laboratory.

The cloud server 112, 112A′, 112B′ and its database are provided to streamline biology experiment workflows. Panel design tools are centralized with the cloud server to generate multicolor panels to design experiments on biological samples with flow cytometers. The web based applications executed by the server and displayed on display devices by a user's processor provide a simple organized graphical user interfaces to build optimal multicolor panels with case. The computers of the lab instruments have their own instrument accounts so they can be accessible and remotely controlled through the cloud server. Data acquisition software associated with the flow cytometer lab instruments is integrated into the cloud server so event data from instruments is readily available in the uniform aggregated data base. The multicolor panels that are generated using the cloud server can be exported into experiment templates that can be used with a flow cytometer. The experiment templates can be further edited remotely to add customization to obtain the desired event data that can be further analyzed. Advantageously, a user can spend more time away from a lab in preparation for running their desired biology experiments on a flow cytometer in the lab.

A remote user at a remote client computer device 123M can remotely control (start up, shut down, operating, status check) a remote lab equipment device 114A-1134M. The lab equipment can prepare a flow cytometer for usage such as remote startup by powering on the instrument, warming the lasers, self-testing of the electronics, fluidics, optics to get the instrument ready to use.

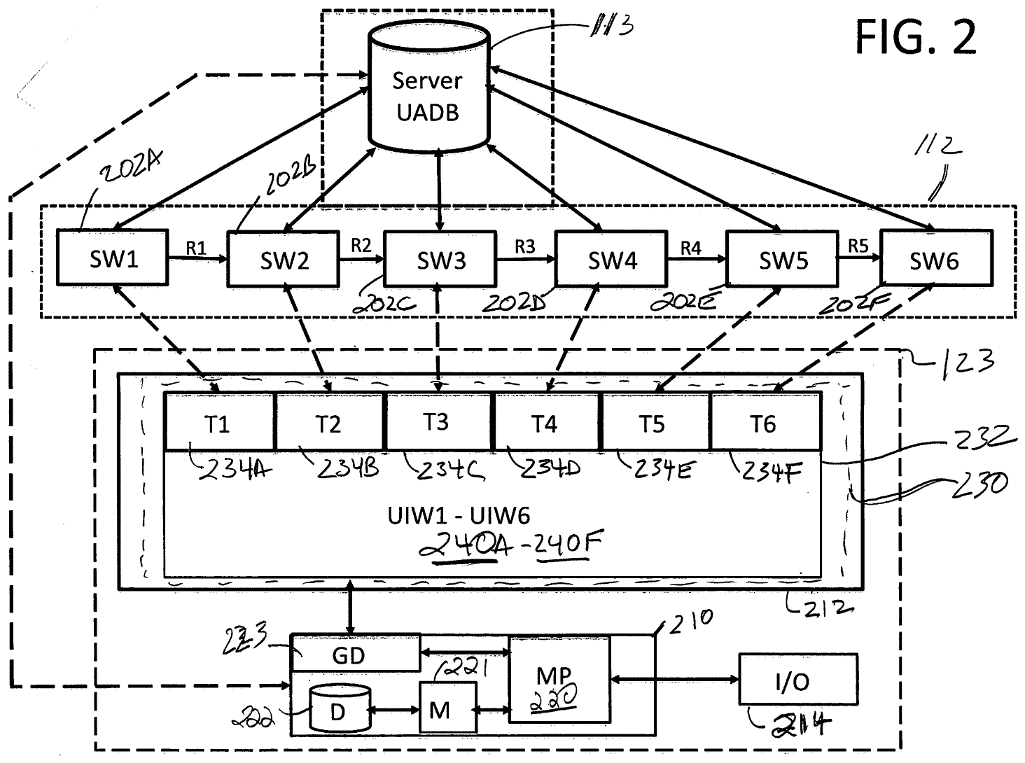

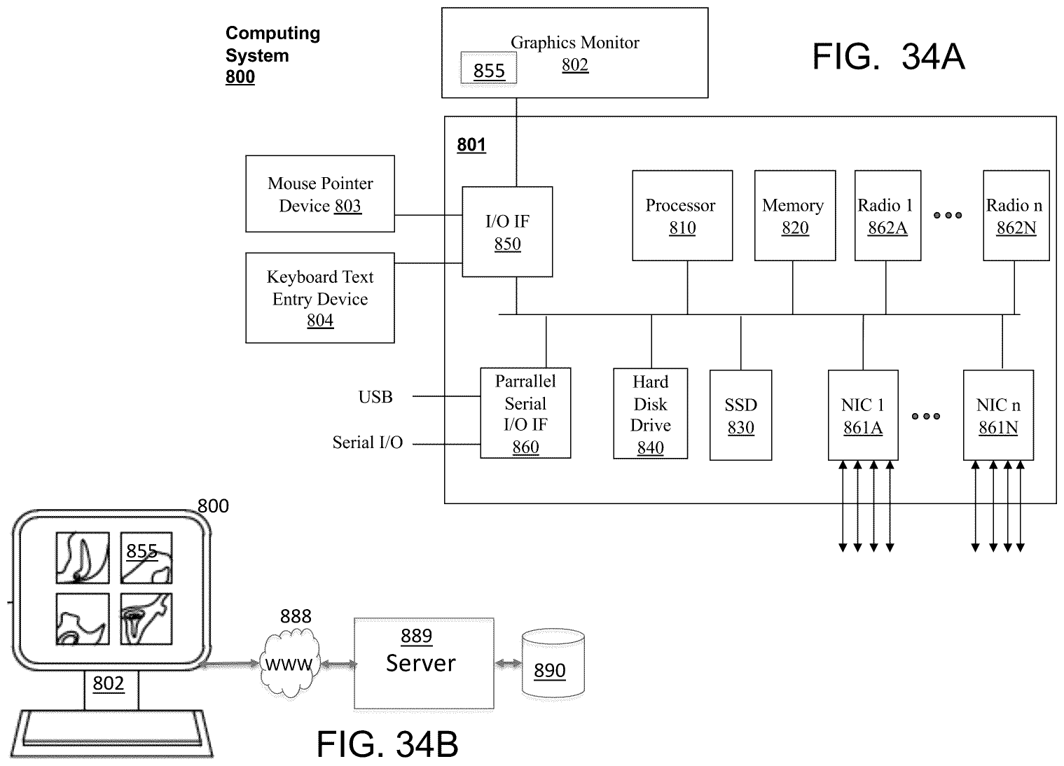

The lab equipment devices and their computers, the remote and local client devices and their computers, the servers and their computers, and the cloud server and its computers are coupled in communication together by a wide area network (WAN) cloud 106, such as the internet or world wide web facilitated by network routers, switches, and other WAN network infrastructure. FIGS. 34A-34B illustrate block diagrams of a computer system that can be used to execute software instructions for the cloud server, the supplier servers, the clients, or each lab equipment. Each of the one or more lab equipment 114A-114N in the labs 104A-140N also has a computer (such as that shown in FIGS. 34A-34B or computer 210 shown in FIG. 2) coupled to and between it and the cloud server 112, 113A′, 112B′. The computer can be a separate component or an integrated component of each lab equipment. In some labs, such as lab N 104N, the computers of the local lab equipment 114M-114N and a local user 103N can be coupled in local communication together by a switch/router 126 which in turn is coupled to the WAN cloud 106. The cloud server 112 and database 113 can located and maintained by a lab equipment manufacturer or a software service provider in their offices and/or at remote data centers (112A′, 113A′; 112B′, 113B′) in the cloud around the world.

The cloud server 112 can maintain two different types of functional accounts that can have access to data and information stored in the unified aggregated data base 113 that can be shared with and between computers and lab equipment in the flow cytometer cloud system 100. A plurality of users can be assigned respectively to a plurality of user accounts with the cloud server 112 to access and share data and information in the unified aggregated data base 113. Each of the one or more lab equipment in the flow cytometer cloud system 100 can be assigned respectively one or more instrument accounts with the cloud server 112 to access and share data and information in the unified aggregated data base 113. Differing software applications executed by the cloud server can support the user accounts and the instrument accounts with both having access to portions of the unified aggregated data base 113 in order to share data and information.

Given they are coupled in bidirectional communication together by the flow cytometer cloud system 100, data and information of the plurality of lab equipment devices LE1-LEN 114A-114N in the plurality of laboratories LAB1-LABN 104A-104N can readily and automatically be synchronized in real time into database 113 through their respective computers with the instrument accounts by way of the cloud server 112. Likewise, data and information in the database 113 can be readily and automatically bidirectionally synchronized in real time out to the plurality of lab equipment devices LE1-LEN 114A-114N in the plurality of laboratories LAB1-LABN 104A-104N through their respective computers with the instrument accounts by way of the cloud server 112. User information, instrument information, instrument data, user generated data and user preferences can be stored in the database 113 and bidirectionally synchronized with the cloud server and its database by the user accounts and the instrument accounts. An alternate way of staying synchronized, is to push data and information regarding the lab equipment out to the server. The server can also poll each of the plurality of lab equipment for data, information, and any updates to receive (pull) any data, information, and any updates regarding the lab equipment. Similarly, data, information, and any updates that are relevant for each lab equipment can be pushed out by the server to the respective lab equipment. Each of the respective lab equipment can poll the server for relevant data and information to receive relevant data, information, and any updates.

At least one of the plurality of lab equipment devices LE1-LEN 114A-114N at one or more of the plurality of laboratories LAB1-LABN 104A-104N can be a full spectrum flow cytometer or a sorting full spectrum flow cytometer (full spectrum cell sorter). Others of the plurality of lab equipment devices LE1-LEN 114A-114N at the one or more of the plurality of laboratories LAB1-LABN 104A-104N can be fluid handlers, reagent cocktail makers, plate handlers, or other devices to further automate or robotically control the flow cytometry process of testing or running experiments on samples of biological fluids. A full spectrum flow cytometer and a sorting full spectrum flow cytometer (full spectrum cell sorter) can acquire the full spectrum of each event data of cell interrogation (laser striking cell w/wo fluorochrome and semiconductor photodetectors with A/D converters) in a digital signal matrix format for subsequent processing of results data with compensation and/or spillover matrices to obtain accurate spectrum signatures of each event. The flow cytometer cloud server software provided (executed) by the server 112 and database 113 can further control the operation of the lab equipment (e.g., flow cytometer), the data acquisition by lab equipment, and data analysis with subsequent processing (e.g., data compensation, gating, and generation of dot plots) of event data after it is acquired from the lab equipment (e.g., flow cytometer).

FIG. 2 illustrates a functional block diagram of a client computer device 123 coupled in communication with the flow cytometer cloud server 112 and the unified aggregated data base (UADB) 113. The unified aggregated data base (UADB) 113 can be included as an element of the flow cytometer cloud server 112. The flow cytometer cloud server 112 includes a plurality of software applications SW1-SW6 202A-202F, each of which can be executed by one or more processors of the server and interface to the UADB 113. The plurality of software applications SW1-SW6 202A-202F are web based applications that can be called by a web browser after logging into the flow cytometer cloud system 100. Results R1-R5 from one software application can be readily transferred to a next software application in the series of software applications SW1-SW6 202A-202F. For example, results R1 of the first software application SW1 202A are coupled into the second software application SW2 202B. Results R1 of the second software application SW2 202B are coupled into the third software application SW3 202C and so on and so forth. Results R5 of the next to last software application SW5 202E are coupled into the last software application SW6 202F. The plurality of software applications SW1-SW6 202A-202F are coupled in communication with the unified aggregated data base (UADB) 113 to pull data in and save results thereto after processing the input data.

The client computer device 123 includes a computer 210, a display device 212, and input/output devices 214 (e.g., keyboard, mouse, touch-screen, printer) coupled in communication together. The computer 210 includes a microprocessor (MP) 220, a memory device (M) 221, a hard drive (D) 222, and a graphics control device (GD) 223 coupled in communication together. The microprocessor 220 executes instructions of an interactive web browser 230 that can communicate to the server 112 to log into the flow cytometer cloud system 100 and call up to execute the plurality of software applications SW1-SW6 202A-202F in tabs of a unified interactive user interface window 232. A plurality of tabs T1-T6 234A-234F of the unified interactive user interface window 232 are respectively associated with the plurality of software applications SW1-SW6 202A-202F. Selecting one of the plurality of tabs T1-T6 234A-234F calls a respective one of the plurality of software applications SW1-SW6 202A-202F to generate a respective user interface window portion UIW1-UIW6 240A-240F. Selecting a next tab, calls the next software application in the series to generate a next user interface window portion UIW1-UIW6 240A-240F in real time on the display device. Each of the respective user interface window portion UIW1-UIW6 240A-240F can have one or more sub-window portions within the user interface window portion. In some of the user interface window portions, a smaller window portion may be overlaid onto it in the foreground, such as in a picture in picture (PIP) window overlay format. In this case, the remainder of the user interface window in the background can be displayed with less intensity or somewhat shown in gray (grayed-out) color.

The results R1-R5 and user interface window portions UIW1-UIW6 240A-240F are not generated by batch processing that would require starting from the very beginning of a computational process. Instead, the results R1-R5 and user interface window portions UIW1-UIW6 240A-240F are generated in real time by the plurality of software applications SW1-SW6 202A-202F. The plurality of software applications SW1-SW6 202A-202F interact with each other in the background. While a foreground process may be generating a graphical user interface portions that is visible to the user, background processes are running to make calculations of the plurality of software applications SW1-SW6 202A-202F, so they are ready to be immediately displayed. For example, a user may be interacting with Tab T3 234C and its user interface window portion UIW3 240C. The plurality of software applications SW1-SW6 202A-202F interact with each other so that they can process an input so that the results are changed on the user interface window portion UIW3 240C as needed. A background auto populating tool auto-populates user selected items and calculated results across the plurality of web-based software applications SW1-SW6 202A-202F in real time. Accordingly, a user need not start over at the very beginning with the initial tab of the panel builder software.

The results in one tab are communicated to the next tabs, as well as the back tabs when something changes. Final results of one software tool can be passed on or exported to another software tool. Moreover, results of one software tool (e.g., experiment builder) can be exported to lab equipment (e.g., flow cytometer, reagent cocktail maker) to run an experiment on biological cells. The output results from running the experiment on biological cells with analyzing lab equipment (flow cytometer) can be imported (acquired) from the lab equipment and analyzed with the data analysis software tools in the flow cytometer cloud.

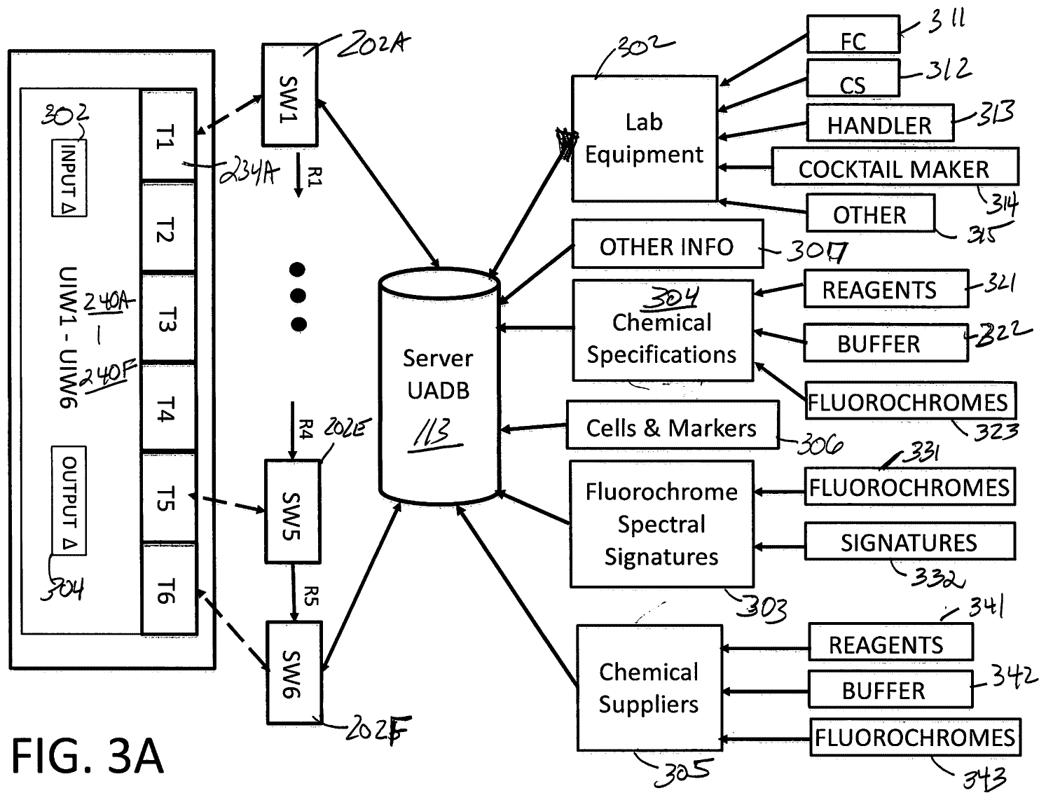

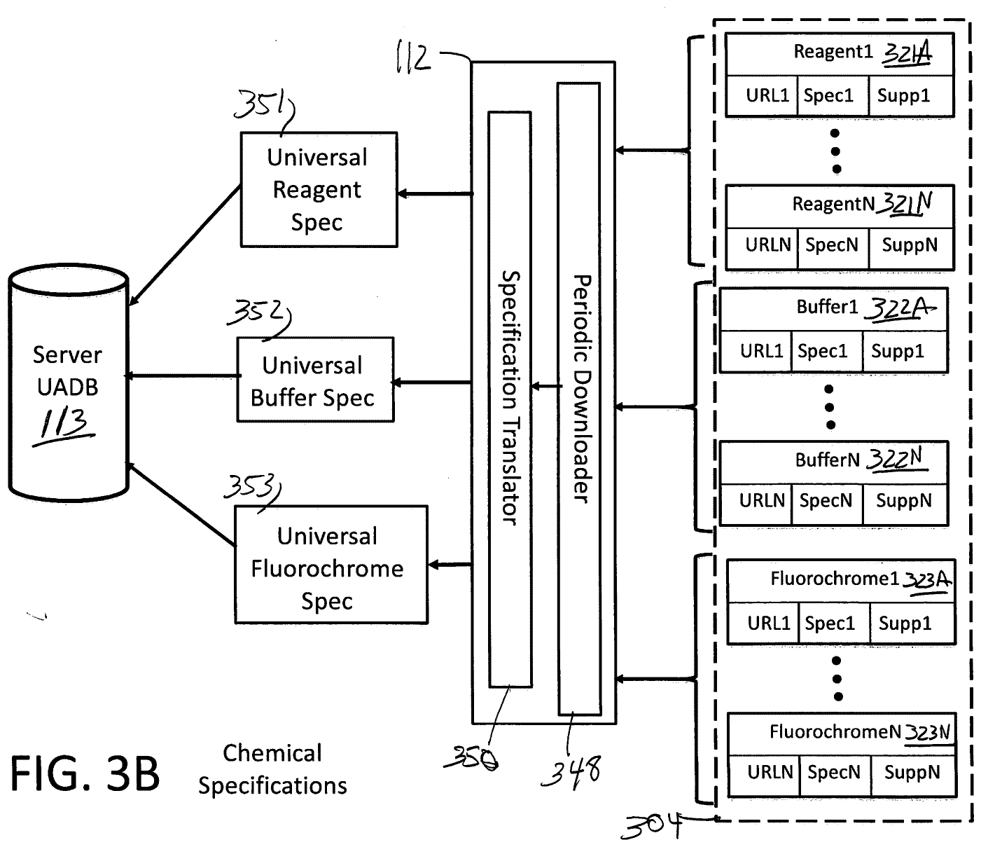

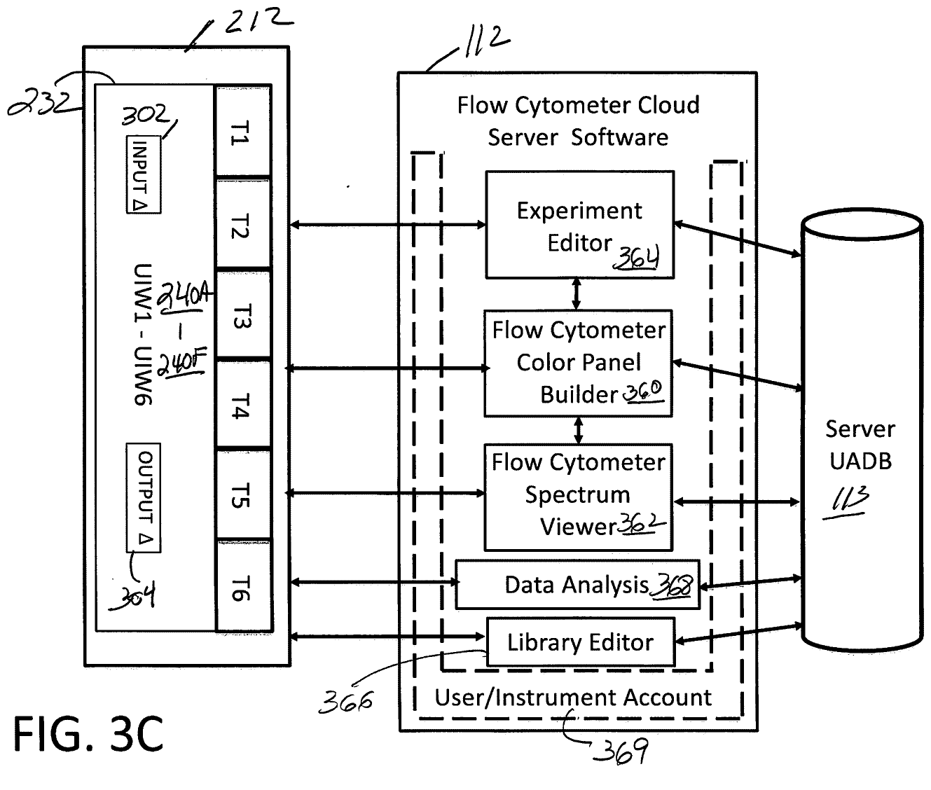

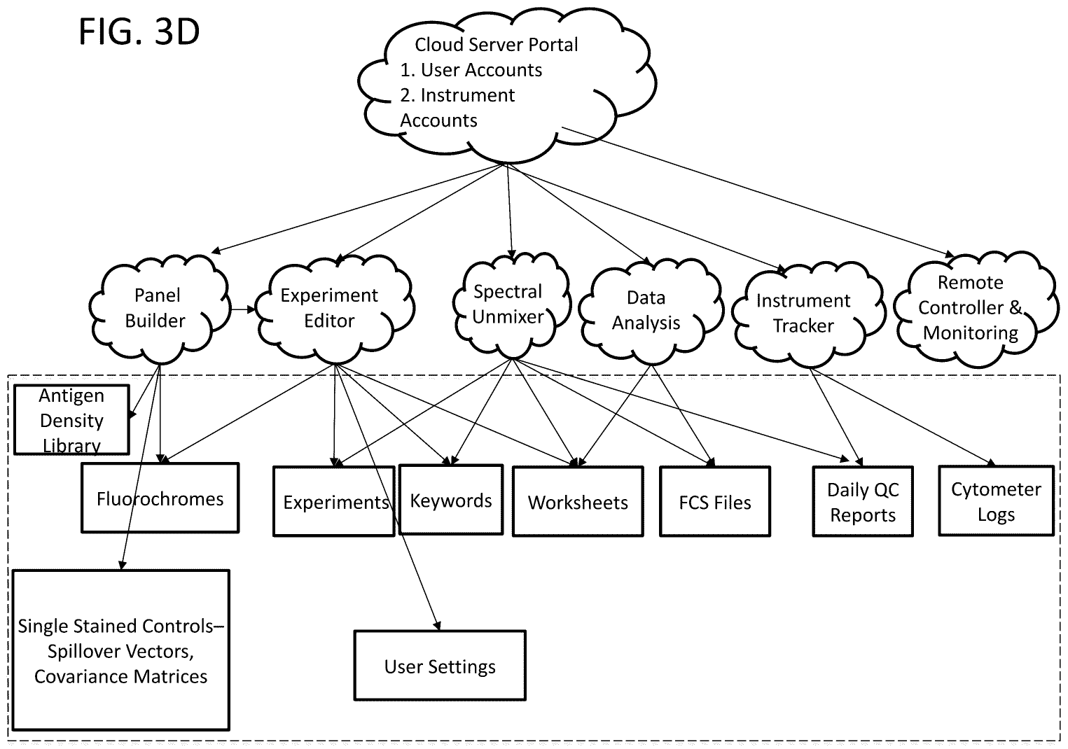

Referring now to FIG. 3A, a functional block diagram is illustrated to show data linkage with the unified aggregated data base (UADB) 113. The flow cytometer cloud server software provided on the server 112 aggregates data and information into the server database 113 in a uniform or standardized manner. Lab equipment can have different configurations and perform different functions. For example, flow cytometers can have different configurations of lasers and detectors that can constrain or expand their experimental capabilities and lead to using differing flow cytometer multicolor panels to run biological experiments. The lab equipment is assigned an instrument account so its processor or computer can log into the cloud server and bidirectionally share data and information with the unified aggregated data base (UADB) 113, including its full preselected configuration and functional capabilities. The instrument accounts for the lab equipment can be set so that its data and information 302 can be publicly open to all users or can be limited to select user accounts associated with one or more domains.

Different vendors or suppliers can use different names for their supplies of chemicals, monoclonal antibodies, and/or their fluorochromes (fluorescent tags). The different vendors or suppliers can also provide different specifications. The configuration of lab equipment coupled in communication with the cloud server can vary as to how samples are handled and what features (e.g., detectors, lasers) are available to analyze biological samples. Internet data regarding prebuilt color panels that is publicly available can be desirable to use. Data and information about lab equipment 302 in the flow cytometer cloud network, fluorochrome spectral signatures 303, chemical (buffer, reagent conjugated antibodies, fluorochromes) specifications 304, chemical suppliers 305, cells and markers 306, and other data and information (e.g., remote OMIP panel information, user stored panels and associated event data) 307 can be stored in the UADB 113 for remote access by users through their user accounts and the cloud (web) based applications provided by the cloud server.

The data and information about lab equipment 302 includes data and information regarding flow cytometers (FC) 311, cell sorters (CS) 312, fluid handlers 313, cocktail makers 314, and other 315 related lab equipment. For flow cytometers (FC) 311 and cell sorters (CS) 312 this information includes the available sample loaders, the number and detector channels of photodetectors, and the number and type of lasers for which they are configured.

The data and information about fluorochrome spectral signatures 303 includes the identifying information such as supplier name and model, excitation wavelengths, laser wavelengths/color excited by, peak intensity levels, and the associated spectral signature 332 of each with flow cytometer configuration when run through a full spectrum flow cytometer with calibrating beads or other particles as a single stain. Spillover across all detectors can also be determined by the full spectra signature that is generated.

The data and information about chemical specifications 304 includes reagents 321, buffers 322, and fluorescent tags (fluorochromes, fluorophores) 343 and identifying information such as supplier name, model, species type, markers, clone name, etc. The chemical suppliers 305 includes information of the supplier name, the ordering number of reagents (monoclonal antibodies) 341, buffers 342, and/or fluorochromes 343, and the web based internet protocol (IP) address or uniform resource locator (URL) address of the supplier or distributor where the chemical can be readily ordered by a user of the flow cytometer cloud system. In some cases, the cloned antibody reagents are conjugated or pre-attached to fluorochromes so that they are specified together and sold by a single supplier or vender with a single URL.

The cell and markers information 306 saved in the server UADB provides the surface marker names that are available on the various cells associated with cell names and types. It can also include the marker density (expression) of the markers that are available on the respective cell. The marker expression is useful so a measure of antigen density (concentration) can be selected by a user for the antibody clone to have some influence in achieving a desired fluorescent light intensity of an assigned fluorochrome. A slider can be used and displayed in the interactive graphical user interfaces for each available surface marker (antigen) to select antigen density.

The other data and information 307 can include remote information that the server can search for and crawl to store in a uniform format. For example, remote OMIP multicolor panel information can be downloaded from the internet, translated into a uniform format, and saved in the UADB so that it searched by a find panel window and listed for accessing OMIP panel information. Other data and information that can be stored includes user stored multicolor panels and associated event data from the experiments that a user runs.

### Real Time Updates

As mentioned herein, the results R1-R5 and user interface window portions UIW1-UIW6 240A-240F are generated in real time by the plurality of software applications SW1-SW6 202A-202F. The user interface windows are not just displaying static information. The plurality of software applications SW1-SW6 202A-202F simultaneously interact with each other in the background to calculate data in real time when a user changes something. While a foreground process may be generating interactive graphical user interface portions that are visible to the user, background processes are running to make calculations of the plurality of software applications SW1-SW6 202A-202F so that results are ready to be displayed in real time without waiting for batch processes to start from scratch and propagate forward. Multiple matrices and multiple plots in the user interface windows can be affected by a single input change so the calculations are performed in real time in the background in response to that input change.

A user may be interacting with Tab T1 234A and its user interface window portion UIW1 240A. The user may update or change an input value 334 in the interactive user interface portion UIW1 240A. The plurality of software applications SW1-SW6 202A-202F interact with each other so that they can process the change in the input value 334 so that an output result 304 is updated on the user interface window portion UIW1 240A as needed in real time. Similarly, if the input value 334 is changed in the user interface window UIW6 240F in the interactions with the Tab T6 234F, the input value 334 is automatically propagated backward to the other user interface windows and the other software applications so that the output result 304 in the user interface window UIW6 240F is updated in real time without having to go back and manually update prior tabs that were visited by a user using the panel builder software.

For example, a user may select a fluorochrome for their multicolor panel in a first user interface window. Data associated with that fluorochrome is retrieved from the UADB into a background process, output results are generated, and then displayed on the first user interface window and ready to be displayed in other user interface windows for the software applications in flow cytometer cloud server software. A number of matrices are displayed with information that is updated in real time if one or more fluorochromes (fluorescent tag) are added, changed, or updated. Similarly, if one or more markers (antibodies) are added, changed, or updated that affects one or more matrices, the values displayed in the one or more matrices can be updated in real time in response.

A user can see the changes in values on the same user interface window in response to a selection or a change. A user can also see changes in values when the user moves back or moves forward to the next user interface window. Because there are often interactions between each selected fluorochromes and each selected marker at the same time, it is desirous to show value changes in real time to the user. Moreover, the values being shown are not extrapolated from a static reference matrix to a smaller matrix or to a larger matrix. The matrix and its values are calculated on the fly in real time and recalculated on the fly in real time in response to a new selection or change. By avoiding extrapolation, the matrices have meaningful information that considers what has actually been selected/changed, and how that selection/change relates to each of the others.

### Unified and Aggregated Data Base (UADB)

Referring now to FIG. 3B, the flow cytometer server 112 has software that can download data and information over the internet about the flow cytometer chemicals and reagents 304, such as the antibody clone reagents, buffer chemicals, and fluorochrome dyes or stains, for storage in the servers' universal aggregated data base 113. The server 112 has web crawler software (periodic web crawler) 348 that occasionally or periodically searches the internet to include a plurality of supplier information with their product names of chemical/reagent products and the associated specifications. They are regularly and periodically downloaded to update the associated specifications for those chemical/reagent products as they change over time. They are also periodically downloaded to determine if the chemical/reagent products remain available for purchase. One or more supplier icons can be used in windows to provide an indication of availability and to provide a link to purchase a suggested chemical/reagent product such as a fluorochrome or an antibody.

A plurality of reagent information 321A-321N can be searched and discovered including universal resource location addresses URL1-URLN, product names Prod1-ProdN, performance specifications Spec1-SpecN, and supplier names Supp1-SuppN. A plurality of buffer information 322A-322N can be searched and discovered including universal resource location addresses URL1-URLN, product names Prod1-ProdN, performance specifications Spec1-SpecN, and supplier names Supp1-SuppN. A plurality of fluorochrome information 323A-323N can be searched and discovered including universal resource location addresses URL1-URLN, product names Prod1-ProdN, performance specifications Spec1-SpecN, and supplier names Supp1-SuppN. In some cases, the cloned antibody reagents are conjugated or pre-attached to fluorochromes (referred to as “conjugated antibodies”) and sold by a single supplier or vender with a single URL. The conjugated antibodies with the pre-attached fluorochrome can associated together as both a fluorochrome and a reagent that are selectable by a user for a multicolor panel. The server 112 and downloading software can aggregate more data and other information in a similar manner (e.g., into a uniform specification) related to flow cytometry and multicolor panel design for running biology experiments.

With different suppliers, differing product names and differing specification names can be used referring to specifications and criteria in the supplier data sheets or technical briefs. These differing names makes performance comparisons difficult to discern between a plurality of suppliers. The differing names for products and specifications can be standardized or translated into a standard name. The differing names for products can be used as aliases into and associated with the standard name for the similar reagent, antibody, fluorochrome (fluorescent tag), marker, or buffer (reagent/chemical). The aliases and the standard name for the chemical/reagent products can be stored in the UADB so a user can type and find the alias name that they may be more familiar with which then links to the standard name used in the GUI windows. A user is likely to understand the standard name that is associated with the alias they are typing for the reagent/chemical.

A universal specification format can be defined, and the various performance specifications and criteria can be translated into the universal specification format so that comparisons can be readily made. Once a specification is translated into the universal specification format it can be associated with the standard name and the supplier name (and URL) then stored in the UADB. But for user selected restrictions, the focus of selection of the reagent/chemical is on its performance in a multicolor panel with other reagents/chemicals as modeled with plots and matrix calculations using the flow cytometer cloud software and not the supplier.

The flow cytometer server 112 has technical specification translation software (specification translator) 350 that can translate the different names into a universal name and associate the different performance values to the appropriate universal (standard) name in the universal specification. For example, the various performance specifications Spec1-SpecN in the plurality of reagent information 321A-321N can be translated into the universal reagent specification format and stored in the universal aggregated data base 113. Similarly, the various performance specifications Spec1-SpecN of the plurality of buffer information 322A-322N can be translated into the universal buffer specification format and stored in the universal aggregated data base 113. Similarly, the various performance specifications Spec1-SpecN of the plurality of fluorochrome information 323A-323N can be translated into the universal buffer specification format and stored in the universal aggregated data base 113. The uniform performance specifications in the data base 113 will be useful to generate a multicolor panel for a user that meets their requirements. The URL and supplier name are associated and stored with each specification in the database. Other data and information can be similarly formatted into a universal format so that it is readily available in the data base for searching and usage to form a multicolor panel for a user.

### Flow Cytometer (Cloud) Server Software

Referring now to FIG. 3C, the flow cytometer server 112 includes flow cytometer cloud server software applications that are web based applications to serve data and information from the unified aggregated data base 113. The flow cytometer cloud server software applications are in communication with a client device and the GUI window 232 of its web browser in order to generate and display the plurality of user interface window portions 240A-240F of each tab in the GUI window 232 on the display device 212. The flow cytometer cloud server software executed by the flow cytometer server 112 includes a flow cytometer multicolor panel builder 360, a flow cytometer full spectrum viewer 364, an experiment editor 364, and a library editor 366 that can be called by the web browser to receive the user interface windows for various one or more tabs T1-T6 associated with each. After the flow cytometer cloud server software downloads or acquires output event data, it can further analyze the data with data analysis software (e.g., dot plot generator) 368. The data analysis software can process the output event data from the flow cytometer and display dot plots associated with a given multicolor panel flow cytometer experiment.

The flow cytometer cloud server software provides user accounts 369 that points to user data in the server UADB 113 that receives new user inputs/changes, calculate output results (real data) in real time based on the new user input/change (real data), so that it can be displayed in real time in an interactive graphical user interface. The user inputs/changes and output results are saved to the UADB 113 so that each software application has access to the new user input/change and the calculated output results in real time.

The results 304 and user interface window portions UIW1-UIW6 240A-240F are generated in real time by the flow cytometer cloud server software applications. The flow cytometer cloud server software applications interact with each other in the background. While a foreground process may be generating graphical user interface portions that are visible to the user, background processes can run to make calculations with the plurality of software applications so that results are ready to be displayed in real time. For example, a user can use the experiment editor 364 to modify or change some input 302 and the input is populated to other software applications by the auto populator 369. A user can review the multicolor panel and its changes 304 with the panel builder 360. A user can also view how the spectrum of the multicolor panel changes from the changed input 302 and its changed results 340 displayed by using the spectrum viewer 362. The flow cytometer cloud server software applications interact and work together to quickly serve data and results to the user.

The flow cytometer cloud server software similarly provides instrument accounts that points to instrument data in the server UADB 113. A user can download some user data to selected instruments accounts associated with selected lab instruments/equipment in order to prepare and run biology experiments. The lab instruments/equipment can save data and information associated with the instrument/equipment into the UADB associated with its instrument account.

Referring now to FIG. 3D, a block diagram of web applications provided by the flow cytometer cloud server is shown. The web applications provided by the cloud server for a user account includes a panel builder, an experiment builder, a spectral unmixer, and a data analysis (analyzer). The web applications provided by the cloud server for an instrument account includes an instrument tracker, and a remote controller and monitor for an instrument. The instrument tracker generates daily quality control reports and cytometer logs for a flow cytometer instrument that is saved into the UADB. The remote controller and monitoring application provides remote control of the instrument, such as set up and execution, by a user account. The remote controller and monitoring application also provides a user account to remotely or locally view and monitor progress of an experiment run through the flow cytometer instrument. Other types of lab equipment/instruments may be remotely controlled and monitored.

FIG. 3D also illustrates some of the data in the unified aggregated data base (UADB) 113 that is stored and accessed in the generation of interactive graphical user interfaces in a web browser for a user account. FIG. 3D also shows the data in the unified aggregated data base (UADB) that is stored and accessed in the generation of interactive graphical user interfaces in a web browser for an instrument account. Provided permissions are set for allowance by user/instrument accounts, FIG. 3D also shows there is an overlap in data in the UADB that can be shared between instrument accounts and the user accounts. For example, daily quality control reports saved by the instrument account are shared with the spectral unmixer software used by a user account to unmix data of the event data for analysis after it has been acquired from a flow cytometer instrument.

### Flow Cytometer Interactive Graphical User Interface

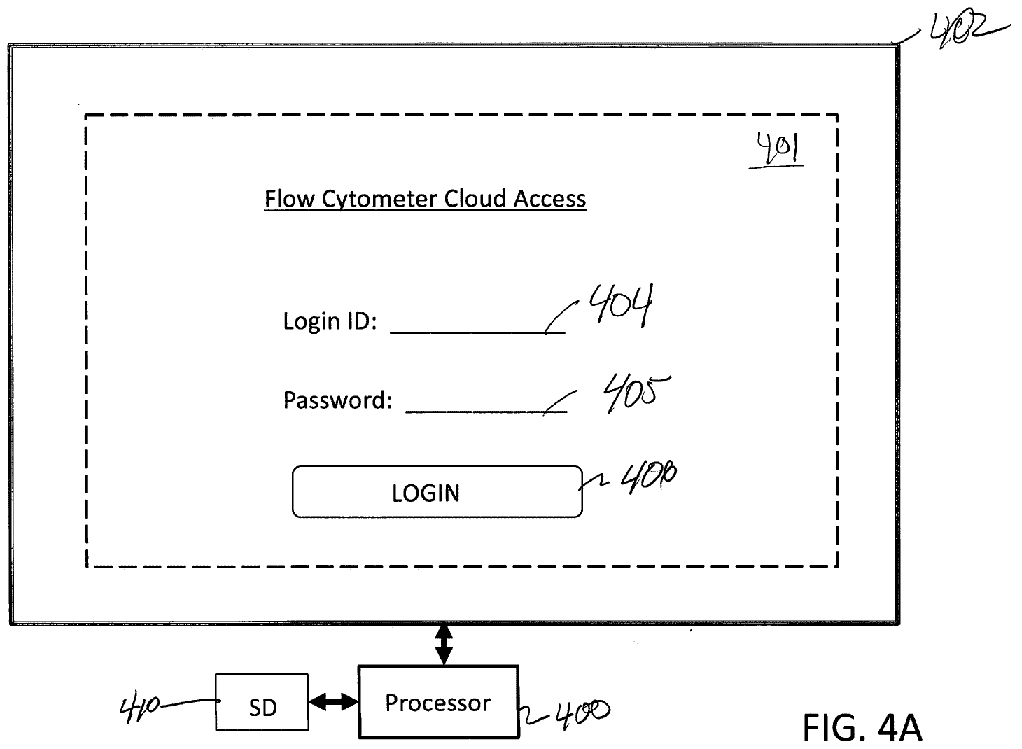

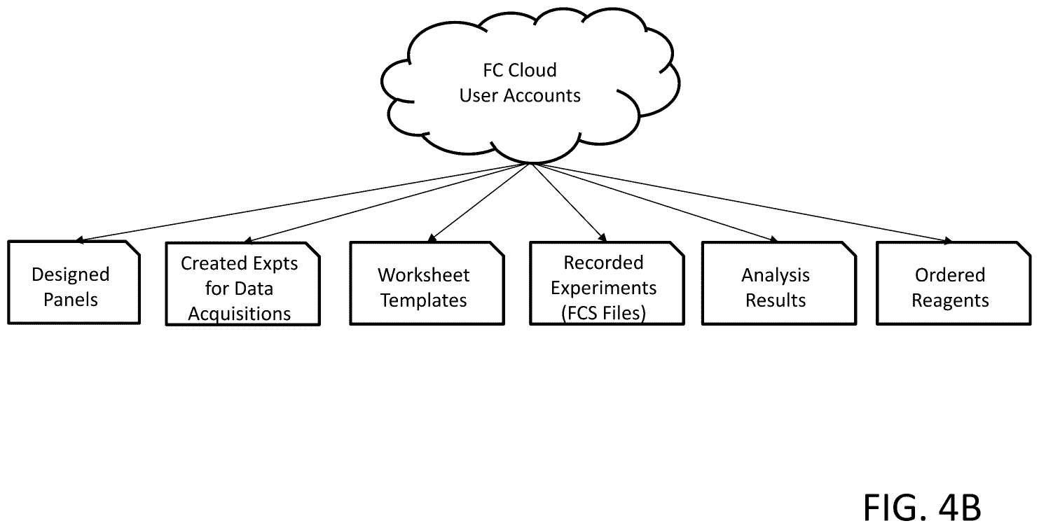

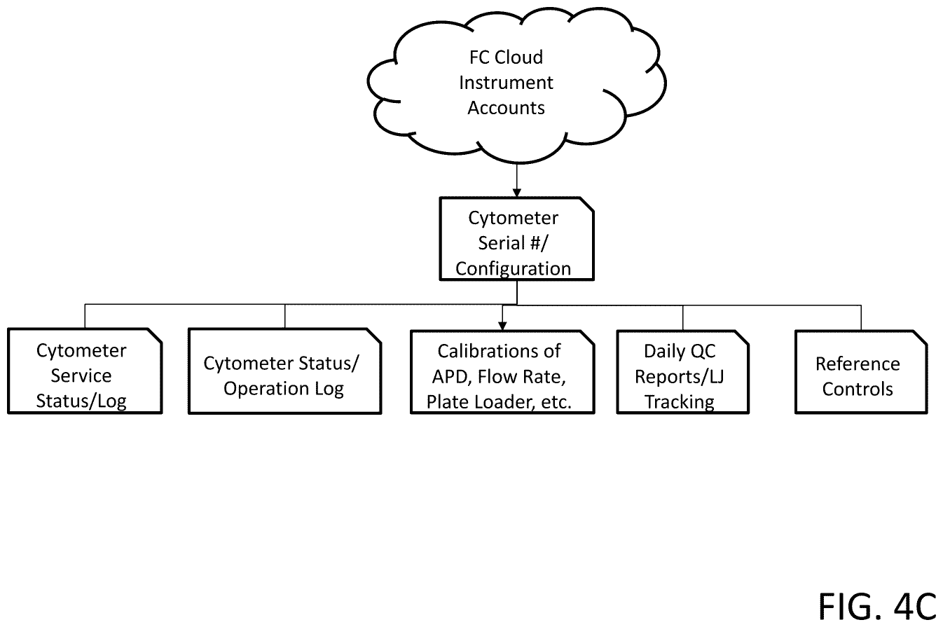

Referring now to FIG. 4A, a control processor 400, with or without a graphics processing unit (GPU), is coupled to a display device 402. The processor 400, in communication with a storage device (e.g., memory) 410 storing instructions, can execute the stored instructions of a software application to display pages or windows of a flow cytometer graphical user interface on the display device 402 for a web based platform of the flow cytometer cloud system 100.

In FIG. 4A, a login window 401 is displayed by the processor on the display device 402. For a user account, a user can input a user name in logID input field 404 and a password in the password field 405 of the login window and then select a sign in button 406 to log into the flow cytometer cloud system 100 to gain access to the user account. For convenience of communicating with users, the logID input field 404 can be required to be an email address. The software can interact with the uniform aggregated database (UADB) of stored aggregated information including flow cytometer color experiment panels, stored reagent cocktail recipes, stored buffer information, stored reagent information, and stored fluorochrome information. A reagent cocktail recipe can be associated with a reagent kit including a plurality of reagent tubes/containers and one or more buffer tubes/containers. For an instrument account, a user can input a flow cytometer serial number in logID input field 404 and a password in password field 405 of the login window and then select a sign in button 406 to log into the flow cytometer cloud system 100 to gain access to the instrument account.

FIG. 4B shows a block diagram of data saved in the unified aggregated data base (UADB) for user accounts. A user has access to data saved in the UADB for their user account in the flow cytometer cloud provided by the cloud server. The user account saves and has access to pre-designed multicolor panels that are shared, and user designed multicolor panels; created experiments for data acquisition, worksheet templates, recorded experiment event data (FCS files); analysis results; and ordered reagents and fluorochromes.

FIG. 4C shows a block diagram of data saved in the unified aggregated data base (UADB) for instrument accounts. Authorized users of an instrument have access to the saved data for an instrument account in the UADB of the flow cytometer cloud provided by the cloud server. The instrument account saves and has access to the instrument serial number and its configuration out of various configurations that may be available. The configuration of a flow cytometer instrument can include sample loading (e.g., test tubes or plate types and size), laser configuration, and detector configuration. The instrument account further saves and has access to customer service status/logs; cytometer instrument status/operational logs; avalanche photo diode calibrations, flow rate, plate loader; daily quality control reports/laser intensity tracking; and reference controls that are available and have been run through the flow cytometer.

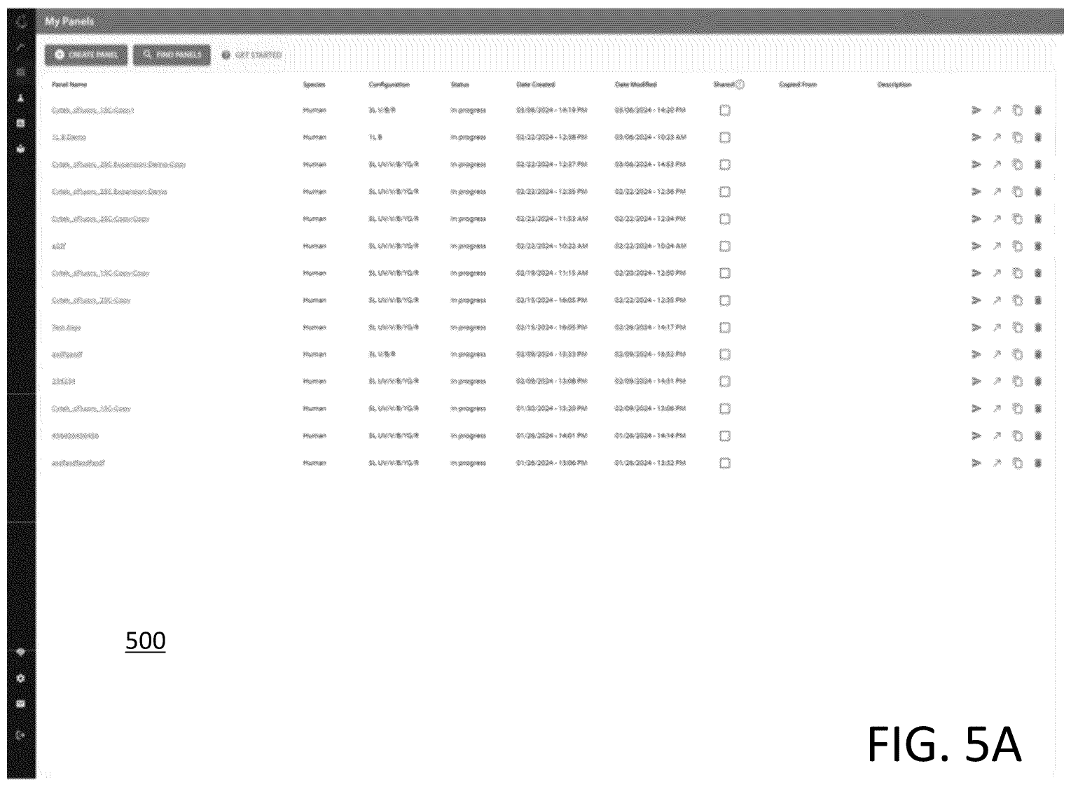

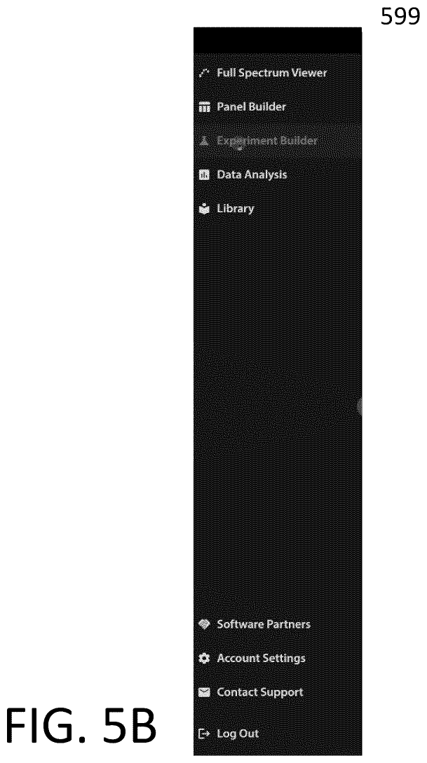

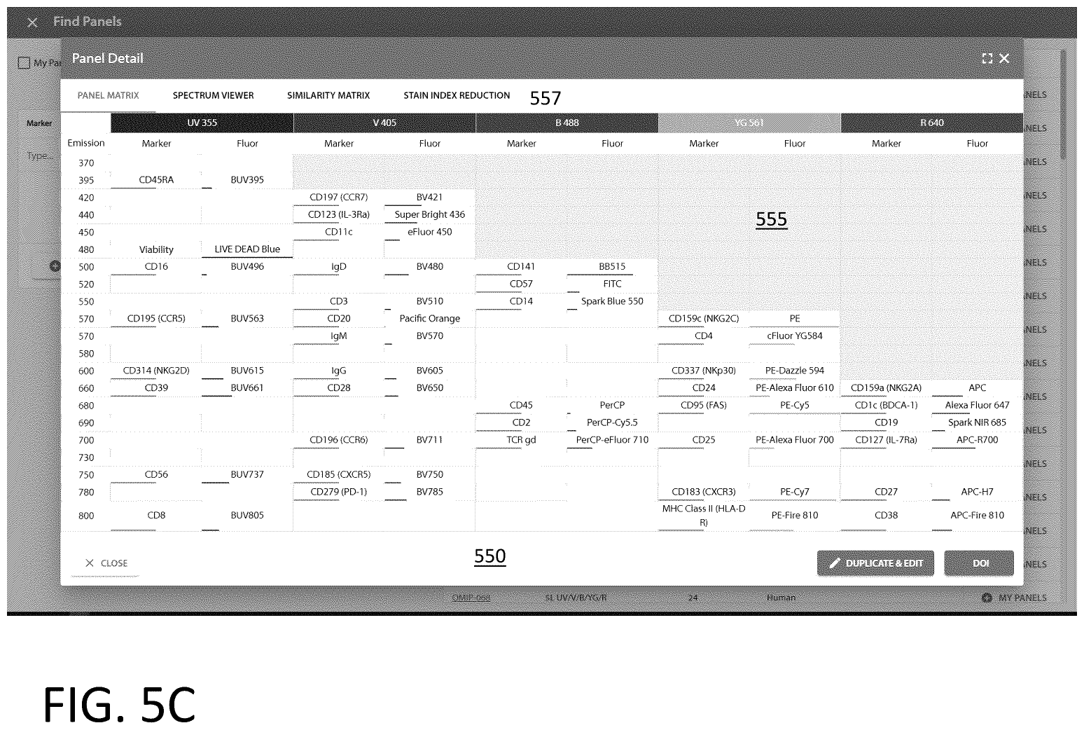

Referring now to FIG. 5A, after an authorized user logs into the flow cytometer cloud system 100, a stored panel GUI window 500 generated by the flow cytometer cloud system 100 through a web browser is displayed on a display device generated by a processor and/or graphics controller. A list of saved flow cytometer panels is displayed in a plurality of rows. Each row indicates the panel name, species type of cells (e.g., human, animal-mouse, rat, pig, primate, cattle, donkey, dog, cat, etc.); flow cytometer configuration, panel status, date created, date modified, a sharing checkbox, copied from, and a description. Each row includes a plurality of control icon buttons to view, upload, copy and trash a given panel. The flow cytometer configuration is related to the model of flow cytometer and its configuration-how manly lasers which can dictated the number of associated detectors. For example, 1 L B for the panel in row two indicates one laser that has a range of wavelengths associated with a blue laser light emission. A configuration of 3 L V/B/R indicates a three laser configuration of a flow cytometer with violet, blue and red laser light with associated ranges of wavelengths. The laser configuration can set the usable fluorochromes in that they are excited by the laser light in associated wavelengths.

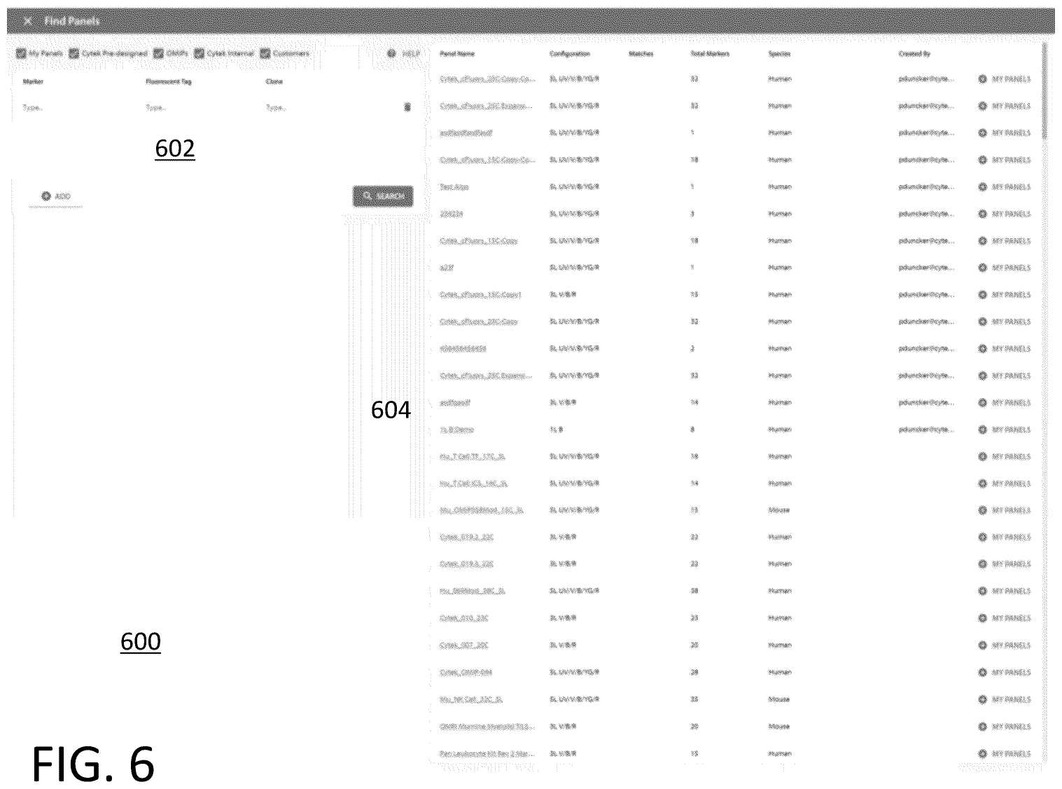

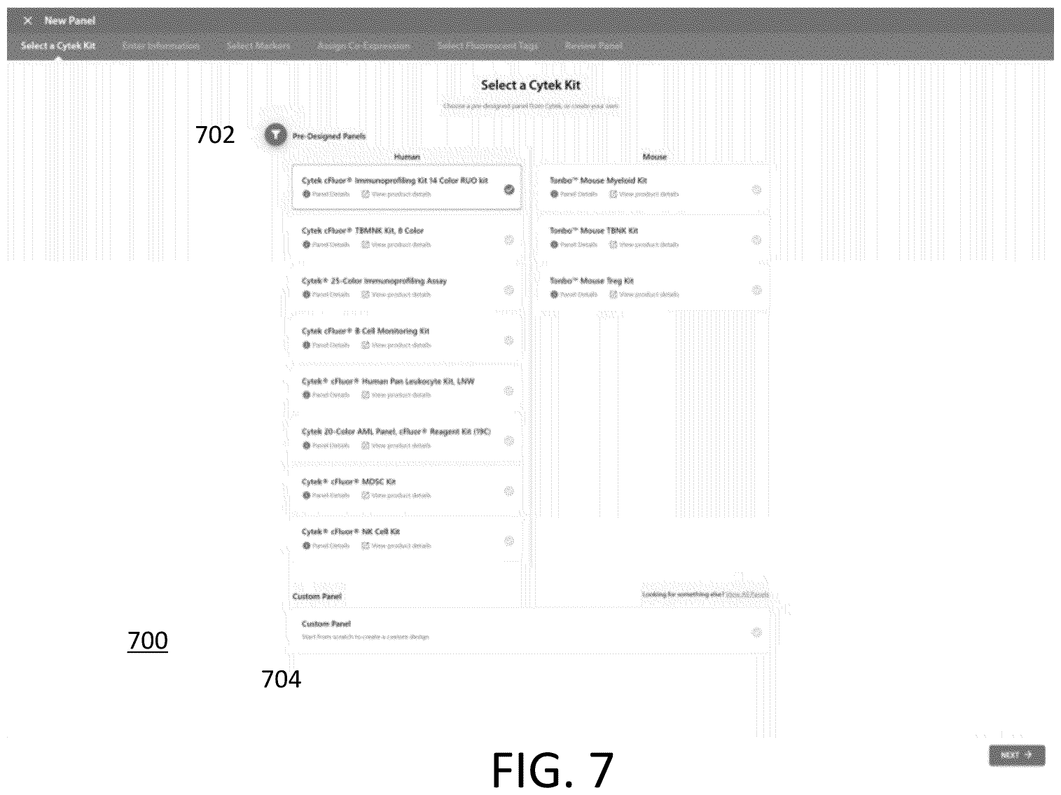

A user can select one of the save panels by double clicking on a name in a row, create a new panel with a create panel button, or search for panels with a find panels button. If a user is new, a get started button with a question icon can be selected to read a tutorial on how to use the panel building software of the flow cytometer cloud system 100. The shared box in each row can publish a panel for other users of the flow cytometer cloud system to use. A shared panel may be used to run the same experiment or copy it for modifications to run a somewhat different experiment with a flow cytometer. If the find panel button is selected in the My Panels GUI window 500, the user is presented with the Find Panels GUI window 600 shown in FIG. 6 to search for pre-designed panels. If the create panel button is selected, the user is presented with the New Panel GUI window 700 shown in FIG. 7 to start a panel building wizard that walks a user through the steps and tabs to easily generate a color flow cytometry experiment panel using interactive software.

Referring now to FIG. 5B, each GUI window has a side bar 599 that indicates icons and the software tools that are available from the flow cytometer cloud software. Each software tool is indicated by a differing icon and can include its name or not to minimize window area usage. The software tools in the side panel include panel builder, full spectrum viewer, experiment builder, library editor, and data analysis tools. As user can select an icon or name to jump to that tool. The currently active software tool can be indicated by changing colors of the icon and/or text of the tool name. The side panel can also include buttons indicated by icons and optionally names for viewing information regarding software partners, editing account settings of the user, viewing support contact information, and logging out of the web based flow cytometer cloud system.

FIG. 5C shows a panel detail pop up window 550 with details of a panel matrix 555 representing a multicolor panel that was selected by a user. In FIG. 5A, a user can select by clicking on a panel name of a multicolor panel in the window 500 that was previously saved in a portion of the UADB associated with the user's account. That brings up the panel detail pop up window 550 associated with the multicolor panel having that panel name. There are four buttons in the window 550 that can be selected by a user to provide other information about the selected multicolor panel. The buttons 557 include a panel matrix button (currently selected and shown), a spectrum viewer button, a similarity matrix button, and a stain index reduction button. The spectrum viewer button displays a spectrum viewer of the fluorochrome in the selected multicolor panel instead of the panel matrix. The similarity matrix button displays a similarity matrix for the fluorochromes in the selected multicolor panel instead of the panel matrix. The stain index reduction button displays a stain index reduction matrix for the fluorochromes in the selected multicolor panel instead of the panel matrix.

Referring now to FIG. 6, after the find panels button is selected in window 500, a find panels GUI window 600 is generated by the flow cytometer cloud system 100 and displayed by a web browser on a display device. The find panels GUI window 600 includes a search field window 602, and a display window 604. Without any search, the display window 604 displays the flow cytometer panels created by the given user that is logged in. Accordingly, the display window 604 lists the users own panels that were created or the list of panels that satisfy the search criteria after a search is performed.

Above the search field window 604 are a plurality of check boxes that controls the scope of the search that is to be performed. From left to right, the scop check boxes include my buttons check box, a Supplier Pre-designed check box, an OMIP check box, a Supplier Internal check box, and a Customer (User) check box. With the Customer check box selected, the search will look through the shared flow cytometer color experiment panels based on the search criteria. With the Supplier Pre-designed check box selected, the search will look through the Supplier flow cytometer color experiment panels that are associated with pre-defined kits of chemicals that can be readily ordered. With the OMIP check box selected, the search will look through a remote external database of multicolor panels that are in the cloud and available through the WILEY online libraries of Optimized Multicolor Immunofluorescence Panels (OMIP) for newly designed and optimized multicolor panels for flow cytometry, fluorescence microscopy, image cytometry, and other polychromatic fluorescence-based methods. With the Supplier Internal check box selected, the search will look through the Supplier flow cytometer color experiment panels that have been designed that are unrelated to any pre-defined kits of chemicals. One or more of these check boxes can be selected so that a user can choose the scope of the search of the flow cytometer experimental panels that are stored in the unified aggregated data base.

In the search field window 604, rows of search criteria can be added by the add button in the left hand corner and each row can be individually deleted by selecting a trash can icon on the right side of the row. The search criteria that can be added into each row, can include one or more of a marker, a fluorescent tag, and a clone name for the reagent. The add button may bring up suggested search criteria for the user to select. The search button in the lower right hand corner is selected when it is desirable to search on the criteria in each row. When selected, a search for each row criteria is made with the results being combined together and displayed in the display window 604.

The display window 604 lists the panels that satisfy the search criteria after a search is performed. Each row in the display window 604 can include a panel name, the flow cytometer configuration, the number of search matches for the given panel, the total number of markers in the panel, type of species of cells (human or animal (e.g., mouse, rat, dog, donkey, horsc)) and the user that created the panel (Created By). Because the display window 604 currently shows a lists of the users own panels, the Matches field is blank in each row. However, if search results were listed, a row may read panel name 234234, configuration of TL UV/V/B/YG/R, 2 matches, 3 total markers, human species type, and created by some username for example.

The panel names in each row of the display window 604 are selectable to call that specific panel up from the database and show the multicolor panel details. If selected, a popup window is displayed that shows information of the panel with an optional button to add it to the user's panel. Additionally, within the table of results in the Find Panels page, on the right side there is a button to add to “MY PANELS”. If no pre-existing panel is found to review and or edit, a new search can be performed with different criteria in the search field window. Otherwise, when searching is completed, the find panels window 600 can be dismissed by the X icon in the upper left corner of the top window bar.

### Panel Builder

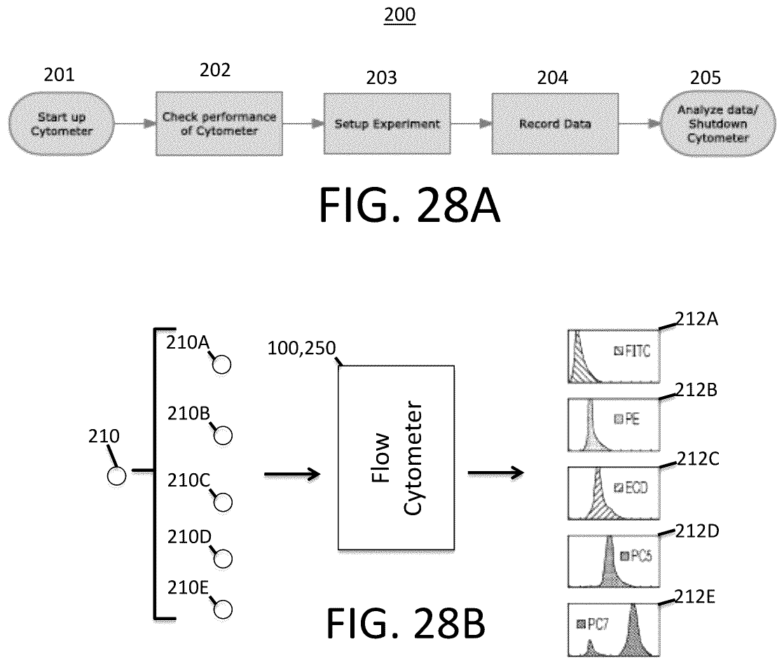

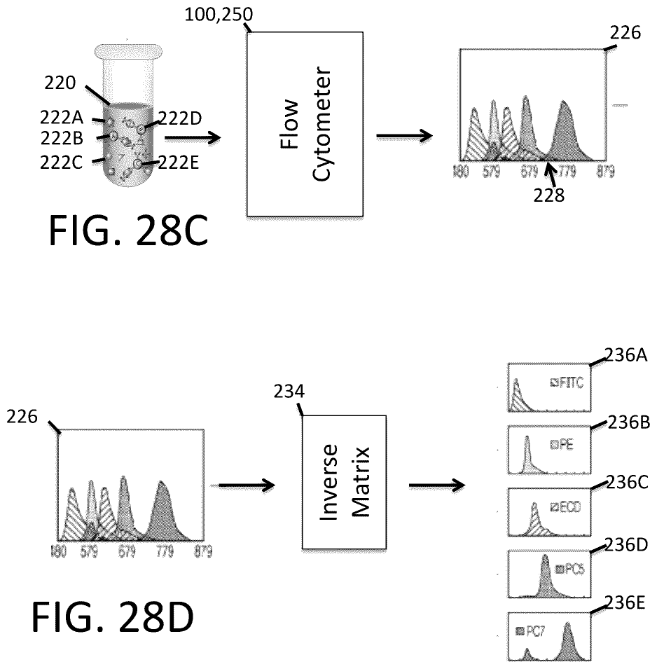

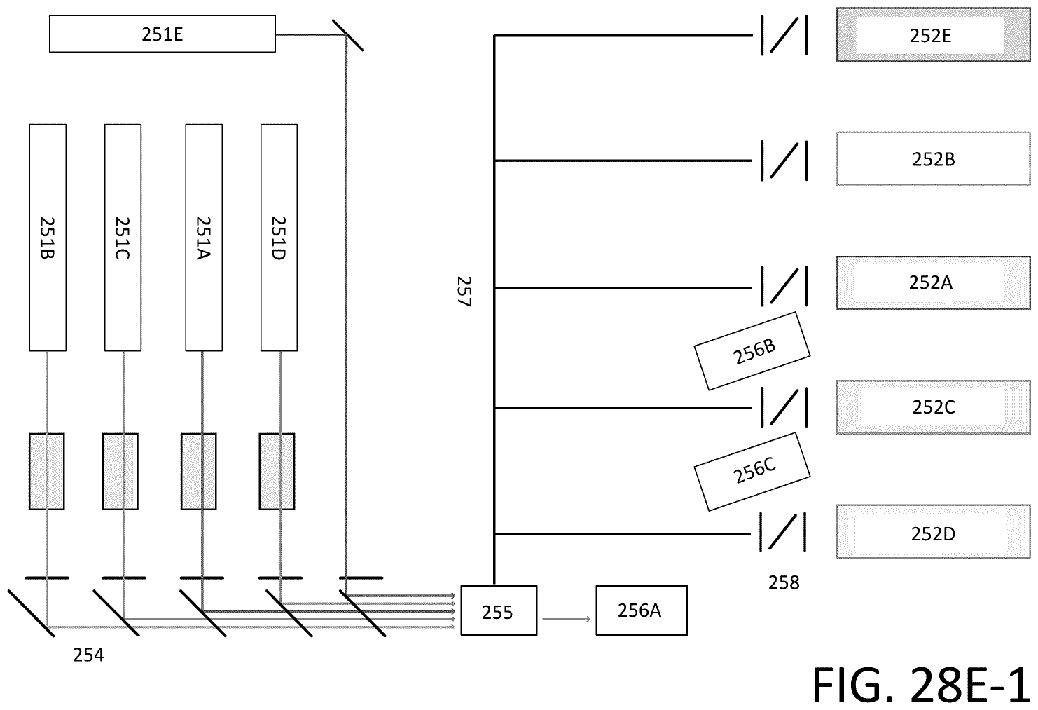

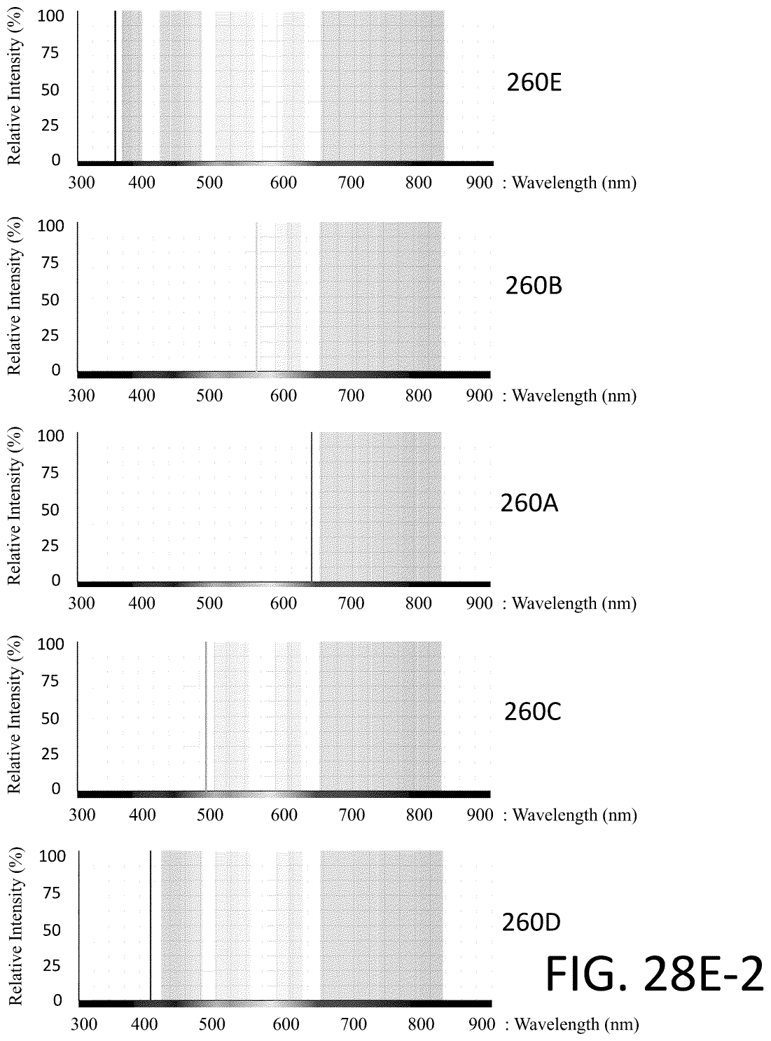

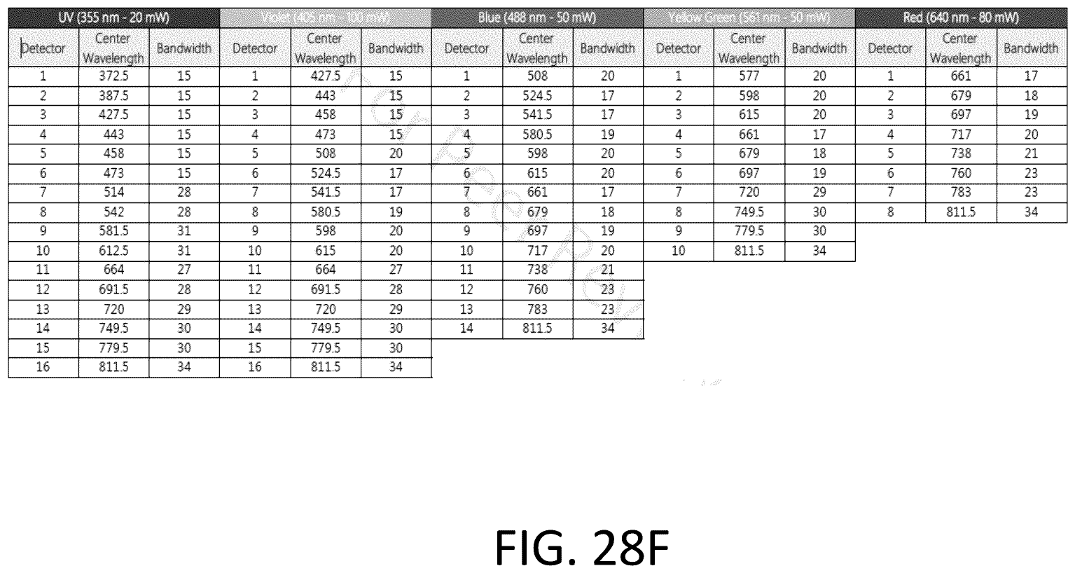

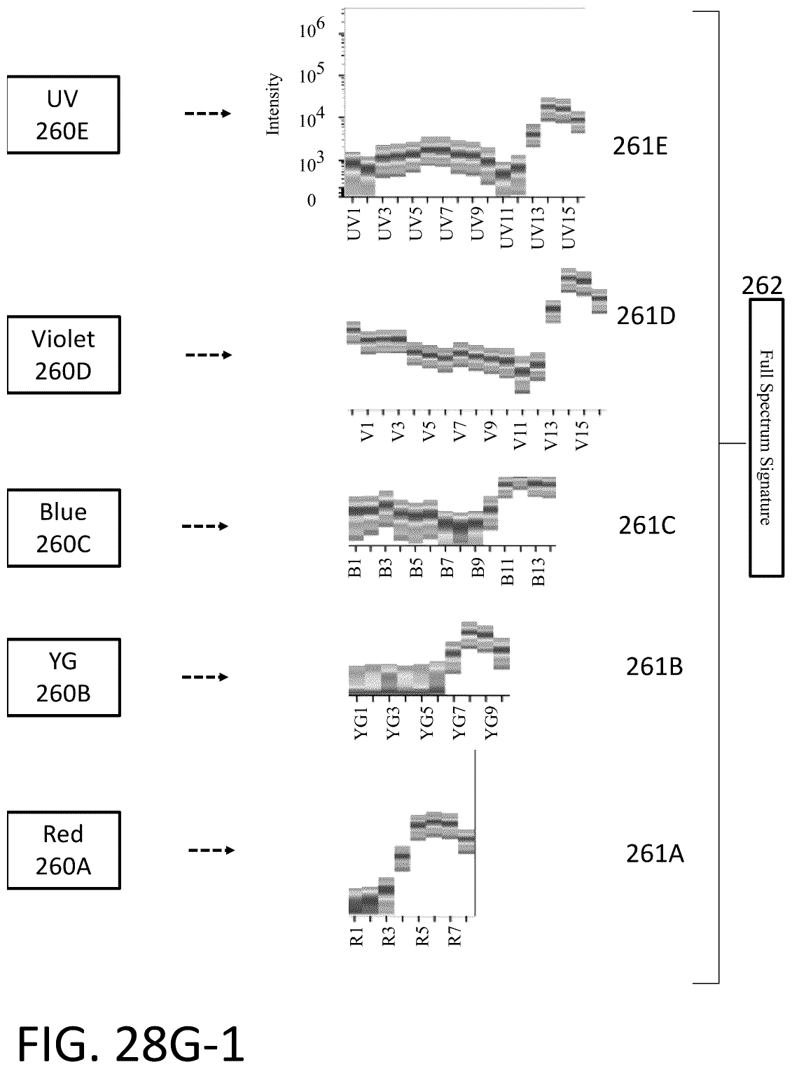

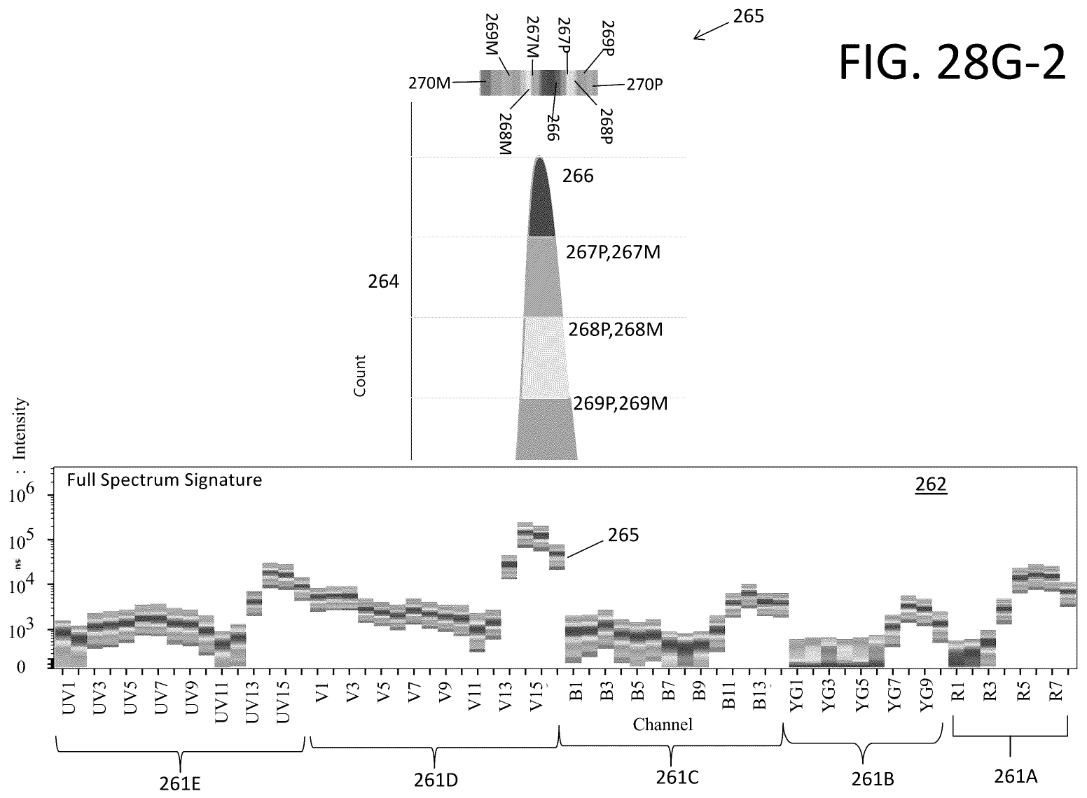

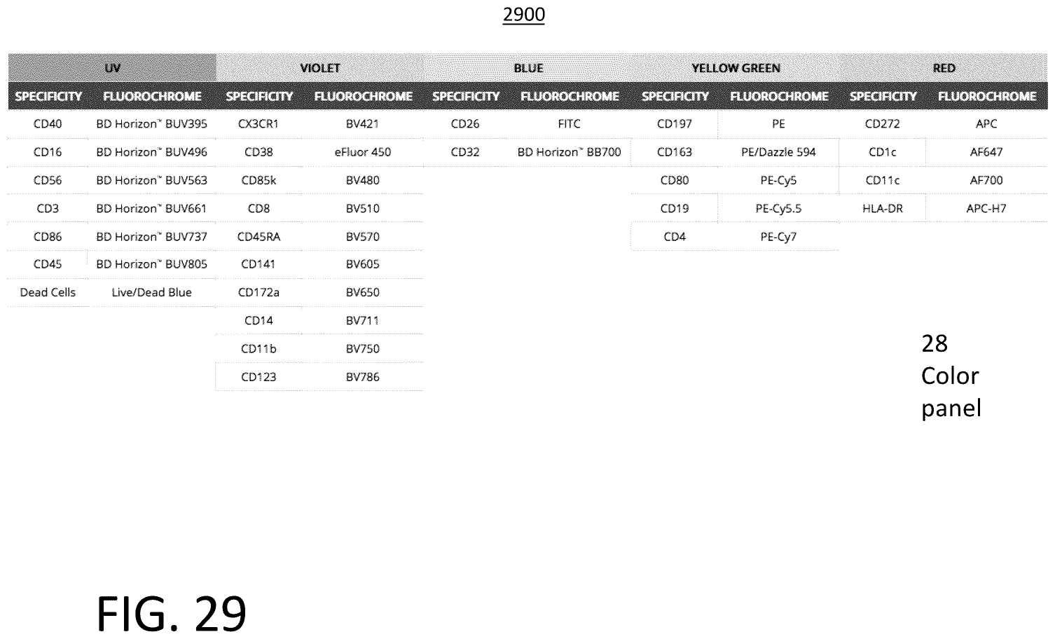

FIG. 29 illustrates an example flow cytometer multicolor panel chart (multicolor panel) 2900 for performing an experiment on a biological sample of a plurality of biological cells using a full spectrum flow cytometer with five lasers and at least 32 detectors, if not double, 64 detectors. FIG. 28F illustrates available detectors in a full spectrum flow cytometer for receiving fluorescent light. The example multicolor panel 2900 in FIG. 29 is a 28 color panel with a top row indicating five laser columns UV, VIOLET, BLUE, YELLOW GREEN, and RED that excite the fluorochromes listed underneath each. Adjacent most fluorochromes are the cell markers of biological cells assigned to the respective fluorochrome. A cell marker (specificity), also referred to as a cell surface marker or simply marker, is typically indicated by a cluster of differentiation (CD) number, such as CD40 for example. The cell marker typically indicates an antibody clone that can attach to the cell of interest at the cell surface marker that is conjugated with the assigned fluorochrome. Generally, the multicolor panel is used to order and assemble the chemicals/reagents to run an experiment on the flow cytometer against a biological sample to obtain information about the cells therein.

In order to build or form a new multicolor panel, a series of steps can be taken that can be aided by a patent builder software application. The patent builder software application can also work with pre-existing multicolor panels and edit it into a custom multicolor panel. For a new color panel, tabs of the patent builder software walk a user from left to right in its generation. A user generally has knowledge about the desired experiment that is to be run on the differing biological cells in a biological sample.

FIGS. 7-16 illustrate various user interface windows generated by the panel builder software when the tabs associated with the software routines of the flow cytometer cloud server software are selected and executed. A tab bar at the top of each user interface window is shown with the current tab that is selected being highlighted in bold with an adjacent arrowhead. Unselected tabs are in the background with a lower intensity and no arrowhead to indicate they are not selected. Often there is a next button at the bottom corner of the window to take the user to the next step in the process. The various tabs in the tab bar that can be selected by the user input device as well when sufficient information has been provided. The tabs are grayed out when there is insufficient information and cannot be selected by the user. When the words in a tab are white there is sufficient information to select that tab. A white arrow beneath the words in the tab indicate which tab is currently selected.

In FIG. 7, a first tab (Select a Cytek Kit) in the tab bar is selected to display a user interface window 700 of a display device. Above the tab bar is a New Panel bar that can be closed by the close X icon. If a pre-existing panel is subsequently selected, the bar above the tab bar is an Edit Panel bar. Regardless of New Panel bar or Edit Panel bar, the tabs of the tab bar can be progressed to review a pre-existing multicolor panel or generate a new multicolor panel.

In the user interface window 700, a plurality of pre-designed panels 702 are illustrated and can be selected for review and editing by selection of a check circle with a user input device, such as a mouse by a mouse click. These pre-designed panels are associated with reagent kits with the chemicals (fluorochromes, buffers, and reagents) to run the experiment through the flow cytometer. In a left column, multicolor panels and kits are listed for a human sample. In a right column, multicolor panels and kits are listed for a mouse sample. At the bottom of the window 700 is a custom panel selection box 704 by a check circle. After a pre-designed panel or a new custom panel is checked, the next button in the lower right hand corner can be selected to take the user to the next step and next tab in the panel building process with the panel builder software. As this is the first tab in a series of tabs of the panel builder software, there is not a back button in the window 700. Assume that custom panel is selected and then the next button is selected.

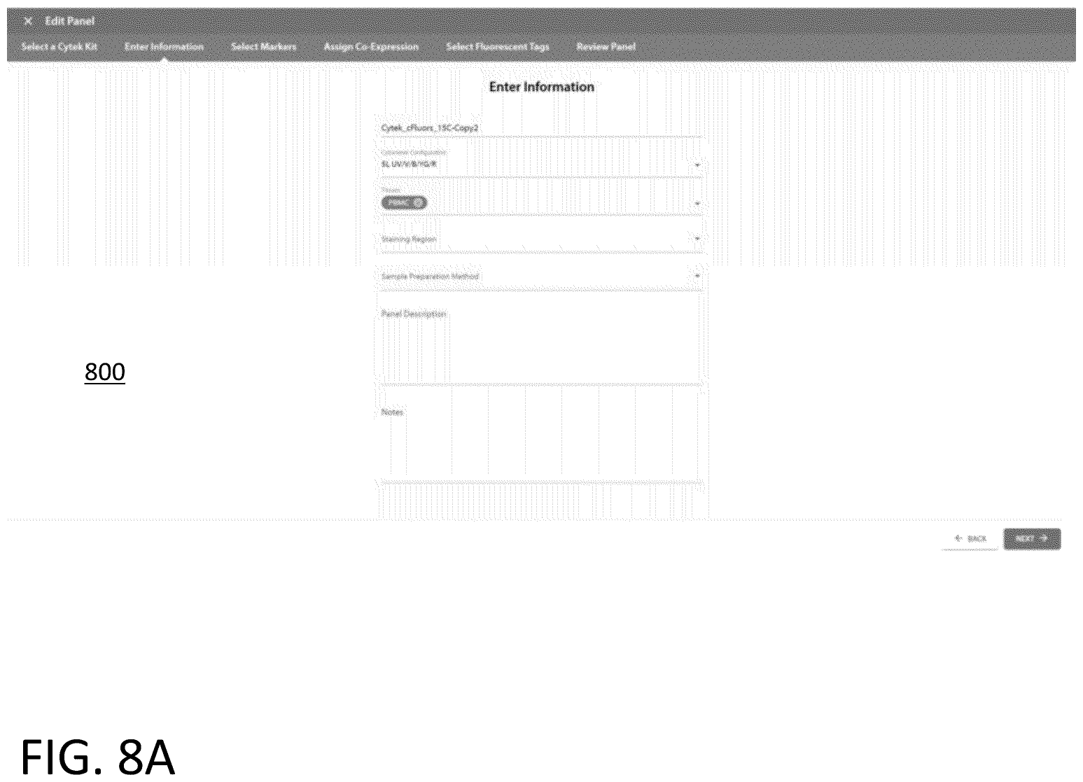

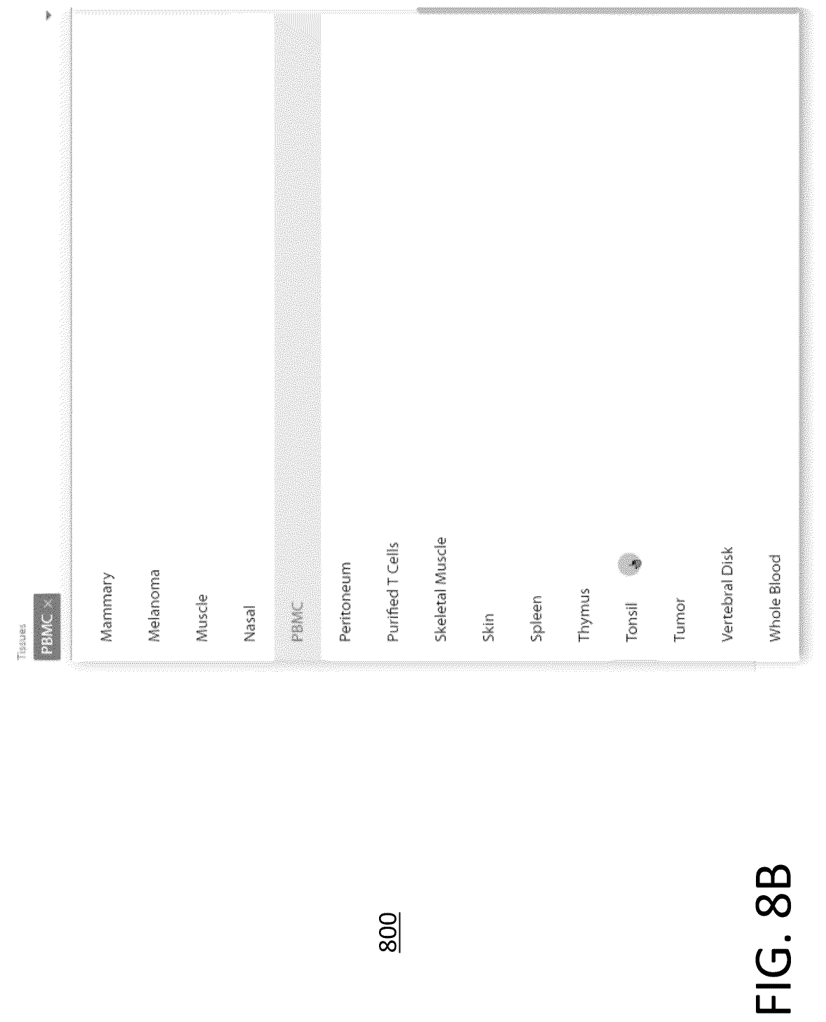

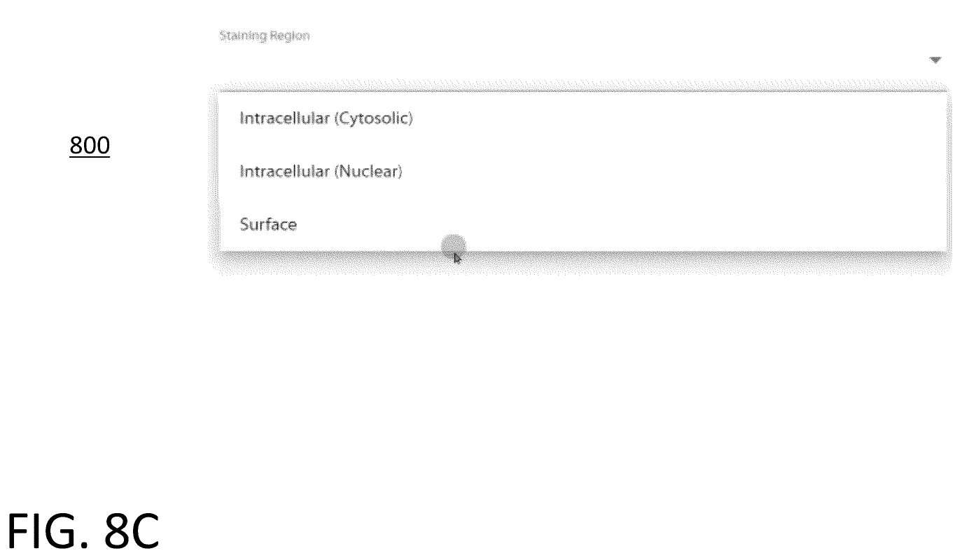

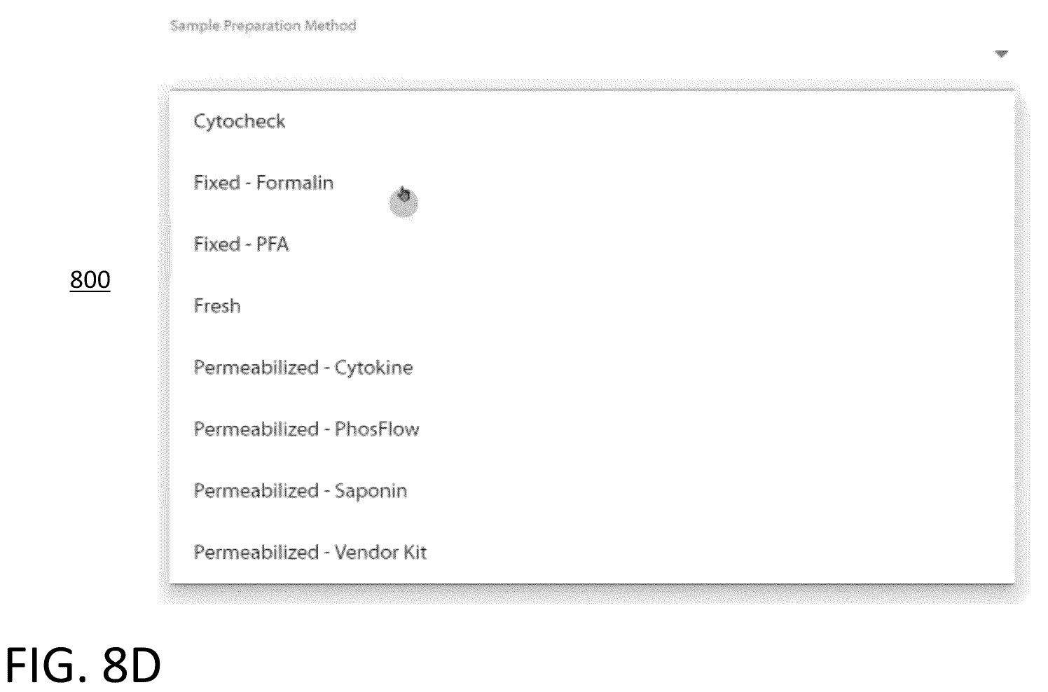

In FIG. 8, the next tab in order is now highlighted (enter information) and an information user interface window 800 is shown with a plurality of input fields. A pair of mandatory fields is to assign a name identifier to the multicolor panel in a top input field and the flow cytometer configuration in another input field that is available to the user. Other input fields include biological sample type (Biological Tissue/Fluid/Cells), staining region, sample preparation method, panel description, and notes about the multicolor panel that can be used. The input field for the biological sample type (Biological Tissue/Fluid/Cells) has a pull down menu designated by an arrowhead icon button from which to select the biological sample type such as PBMC, tonsil, skin, purified T cells, muscle, mammary, melanoma, nasal, Peritoneum, skeletal muscle, spleen, Thymus, Tumor, vertebral disk, and whole blood, for example. The input field for the staining region of a cell is also a pull down menu designated by an arrowhead icon button for selecting intracellular (Nuclear), Intracellular (Cytosolic), or Surface from the popup menu. The sample preparation method is also a pull down menu designated by an arrowhead icon button for selecting Cytocheck, fixed formula, Fixed-PFA, Fresh, Permeabilized Cytokine, Permeabilized PhosFlow, Permeabilized Saporin, or Permeabilized-Vendor Kit.

The information user interface window 800 includes a back button and a next button at the bottom of the window. The back button with a back arrow and the word back has a background color (white) and the next button has a forward arrow and the word next with a different background color (blue). These buttons are located in the lower right corner of the window 800. Assuming the name identifier and the flow cytometer configuration are entered, the next button is selected to go to the next tab and user interface window of the panel builder software.

### Select Markers

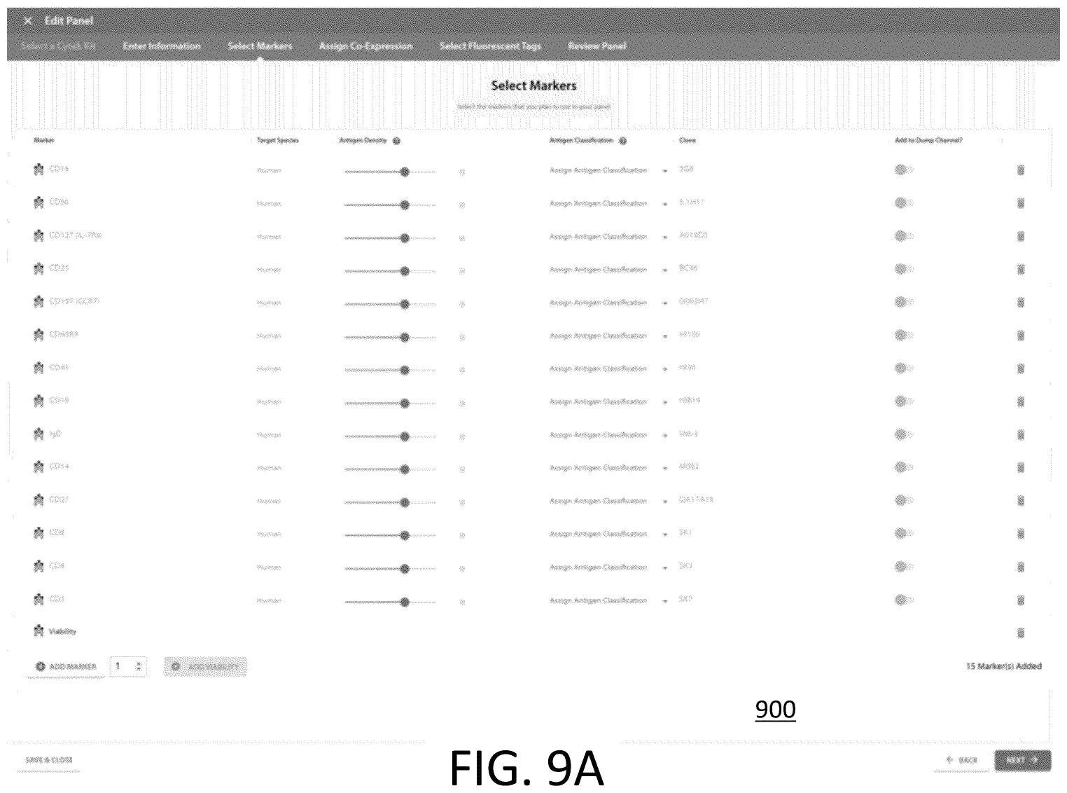

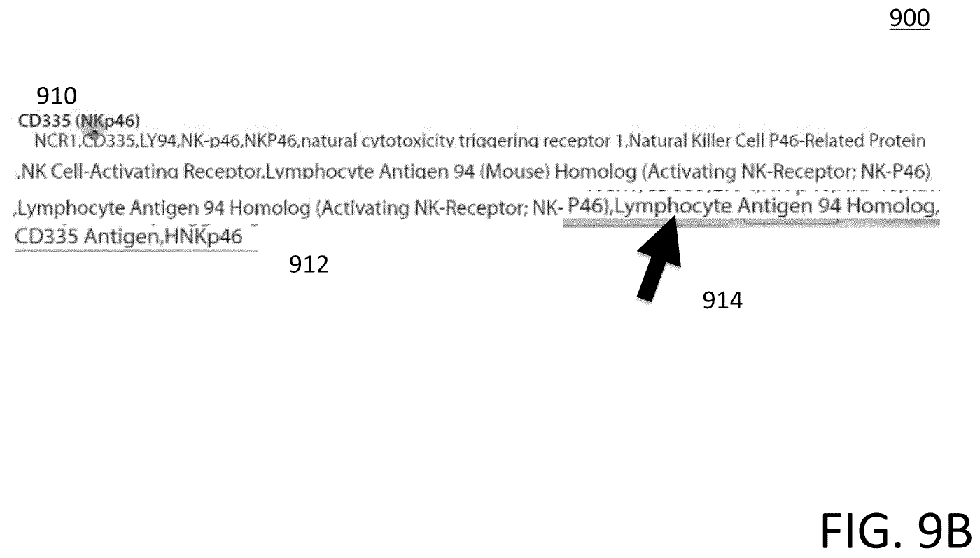

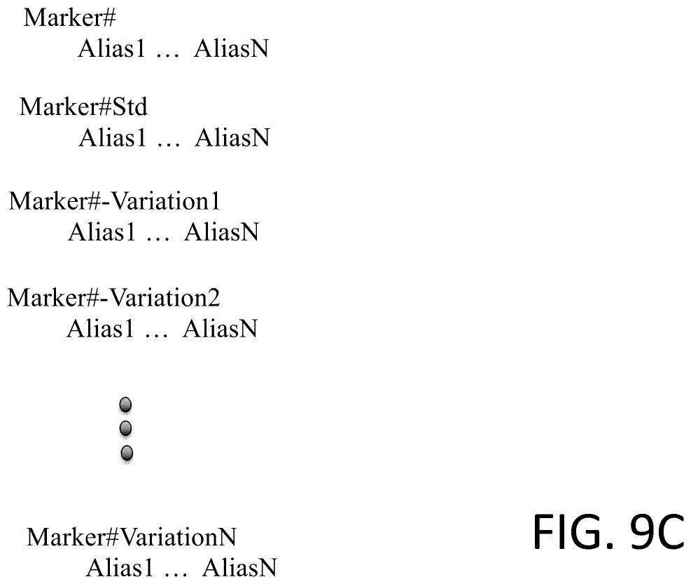

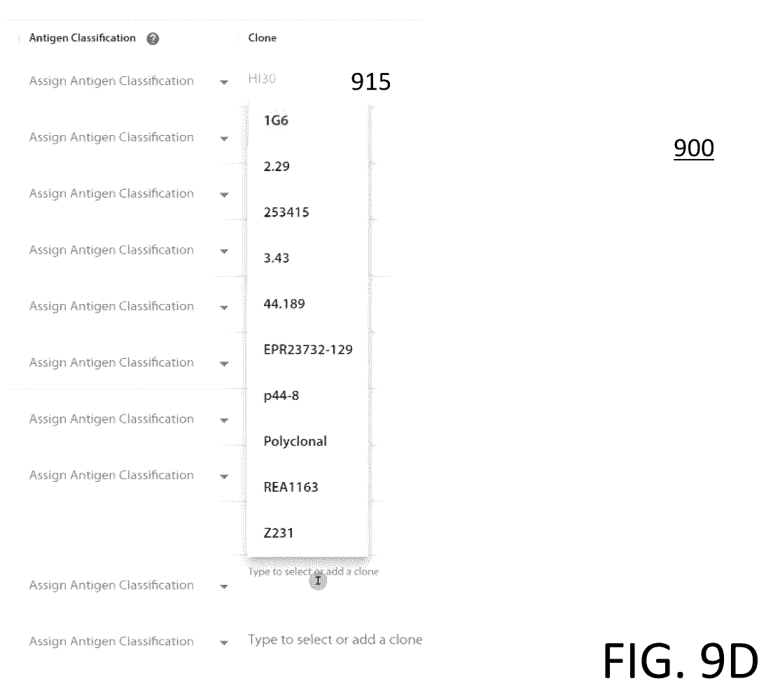

In FIG. 9A, the next tab in order is now highlighted (Select Markers) and a Select Markers user interface window 900 is shown. If a pre-designed panel was selected, the list of selected markers is pre-populated with the markers from the pre-designed panel. If a new custom panel was selected, the list of selected marker would initially be empty, and new markers can be added. The list of selected markers in the pre-designed panel can be edited by adding new markers or subtracting pre-selected markers to customize it. In a lower left hand corner, the user interface window 900 includes an add marker button (plus sign icon and ADD MARKER word), a selectable number input field (selectable up arrow to increase and selectable down arrow to decrease), and an add viability button (plus sign icon and ADD VIABILITY word). Below these buttons is a save & close button that can be selected to save work in progress and close the Edit Panel workflow. Next and back buttons are located in the lower right corner of the window 900. The Next button takes the user to the next tab and next user interface window. The Back button takes the user back to the prior tab and prior user interface window.

The add marker button is selected to add a cell marker into a row of the list of selected markers to use with the multicolor panel under construction. Each row identifies the cell marker (e.g., CDxxx or its name), Target Species (Human, Mouse, cell type, etc.), Marker (Antigen) Density, and the Assigned Marker (Antigen) Classification indicated by Antibody Clone Name that can attach to the given cell surface marker of a biological cell. The row can include an Add to Dump Channel selection switch button and a trash can icon button that can be used to delete the marker in the row. At the base of the list of markers, the lower right corner can provide a numeric indicator of the total number of rows indicting the number of Marker(s) Added. The UADB holds data of a plurality of available marker numbers that can be associated with clone antibodies, and a plurality of clone names that can be assigned to the selected marker (antigen).

In FIG. 9B, a new marker can be added by typing its name/number in the marker field of a new row. As a user types a marker name or an alias name for the marker, the user interface searches the list of alias names and the standardize name and generates/displays a pop up window to show the user. If the user types an alias name, the popup window displays a list of one or more possible marker names/numbers 910 and their respective associated list of alias names and numbers 912 over which a search is done so the user can select the right one. The alias names represent the plurality of names that may be used for an antibody associated with a marker or the marker name. For example, if a user begins typing the first few letters of an alias name such as NK, the standard name 910 and the list of aliases 912 is searched and narrowed down to those shown to the user so he can select the proper name and add the proper marker to the first column in the given new row. If a user continues to type, the list of aliases can become shorter, and a plurality of standard names can become shorter. If the user keeps typing p46 after NK, the list of aliases may be reduced down to a handful to pick from that are associated with one standardized name/number. A user can use a cursor 914 associated with the input device and select an alias with it that confirms the standard name and can bring in the supplier information (name, URL), and the performance information for the associated chemical/reagent.

Referring now to FIG. 9C, if a user begins typing a more standard name, such as CD44, a search of a marker database in the UADB is performed over standard names and aliases and a search pop up window is displayed. The GUI window displays a search pop-up window with a plurality of CD44 marker variations with their associated alias names set by suppliers from which a user can choose. A plurality of standard marker names/numbers Marker #, Marker #Std, Marker #-Variation1 through Marker #VariationN, such as CD44, CD44H, CD44std, CD44-Variant 9, CD44-Variant 4, CD44-Variant 5, . . . , CD445-Pan Specific, and their respective one or more alias names (aliases) Alias1-AliasN are shown to the user from which they can pick to add to the set of selected markers. Obviously if marker CD44 is desired, marker CD445 should not be picked by the user.

In FIG. 9A, question mark icons are provided adjacent terms that can be selected to provide information to a user to help understand the terminology and values that are indicated. For example, there is a question mark icon adjacent Antigen Density in a column at the top of the table listing the Selected Markers. When a user selects the question mark adjacent a window opens to the foreground with the user interface in the background to explain the term. The explanation can be closed by a close box to return to the user interface window of the associated tab.

Markers can have different levels of expression on a cell. Markers expressed at high levels are densely populated (have many copies of the indicated marker) on a cell. A marker with a high level of expression is more readily available for antibody detection. Conversely, a low level of expression indicates that it is less available for antibody detection. The number of markers on a biological cell correlates to the final fluorescent intensity of the positive population after antibody staining. As a general rule, bright fluorochromes (fluorophores, fluorescent tags) are assigned to low expressing markers (low antigen density) and dimmer fluorochromes (fluorophores, fluorescent tags) are assigned to highly expressed markers (high antigen density). However, Antigen Density (the concentration of antibodies) can also be used to influence brightness or light intensity. A higher level of Antigen density, a greater number of antibodies that are conjugated with fluorochromes are likely to attach to a cell. With a lower level of Antigen density, a fewer number of antibodies are likely to attach to a cell. Generally, if markers are selected with a middle level of antigen density, then there is more flexibility in assigning fluorochromes (fluorophores, fluorescent tags) to cell markers to which antibodies attach.

Antigen density (low, intermediate, and high) refers to number of antigens on your population of interest. Antigen density can be impacted by a number of factors, including cell type, activation state, sample preparation, drug treatments, and a number of other factors. It is helpful to know the expected antigen density in your experimental conditions before designing your panel. In panel design, antigen density is used in combination with fluorescent tag stain index to ensure appropriate resolution of your marker of interest, while minimizing spread introduced into your panel. Antigen density information can be obtained from a variety of sources, including peer reviewed literature, antibody vendor data, and your own prior experience in your experimental paradigm. A good indication of antigen density can often be obtained by looking at vendor data of your antigen of interest on PE. If the positive population is several decades away from the negative, this is a high density antigen. If the positive population is very close to the negative, this is a low density antigen. If the positive falls somewhere in between, this is an intermediate (Int) density antigen.

In FIG. 9, the antigen density can be selected by a color button slider 920 that moves from left to right with a bright color line on the left side line of a circular button and a gray color on the right side line that differs from the bright color. In FIG. 9, the color button slider is near a midpoint of the slider in a number of rows to select intermediate density antigen for those markers. If the slider is moved to the right showing a long bright color line, a high antigen density is selected by the user for the marker in the row. If the slider is moved to the left showing a short bright color line, a low antigen density is selected by the user for the marker in the row. As explained herein, the antigen density can affect the signal separation in detecting between a positive population of cells and a negative population of cells. The antigen density slider for a marker can alter how a multicolor panel is generated and the selection of fluorochromes.

Each row also has an Assign Antigen Classification pull down menu from which a user can select either primary, secondary, tertiary, or unknown for the Antigen Classification. The antigen classification generally describes what the expression pattern of the number of plotted events will look like along a fluorescent light intensity axis of a dot plot or histogram. A primary antigen classification has a distinct concentrated signal population in a cluster over a narrow range of intensity between minimum and maximum on a dot plot. A secondary antigen classification has multiple clusters of signal populations. A tertiary antigen classification has no clear clusters of signal populations. A tertiary antigen classification may have a wide range of intensity between a maximum and a minimum that can cause events plotted on a dot plot to be spread out into a smearing of dots instead of being concentrated into a cluster. The Assigned Antigen Classification to a marker can limit (narrow down) the antibodies in the UADB that are presented to a user for selection based on their performance. The Antigen density and Antigen Classification are used by the panel builder software to pair up the selected marker with a fluorochrome in the generated multicolor panel.

After the marker is selected and general desired performance requirements of the antibody are entered, a user can type to select or add an antibody clone to the row that is to be used for the selected marker from those in the UADB. Alternatively, the panel builder can select the antibodies for each marker along with the fluorochrome.

In FIG. 9D, a new clone antibody name can be added to the new row by starting to type its name or by optionally selecting the text in the input field to bring up a pop up menu that lists selectable clone antibody names that are associated with the selected surface marker and performance requirements. By starting to type a name for a desired clone, the system generates a similar popup window with alias names. In either case, the software is prompted to display a pop up window with a clone menu 915 that lists possible clone names in the database from which a user can select to be associated with the given new marker name/number.

Each row in the select markers GUI window includes an Add to Dump Channel switch button and a trash icon button. The trash icon button when selected by a user deletes the given row. The Add to Dump Channel switch button is used to for marking cells that we want to eliminate or dump from analyzing in the biological sample. With the Add to Dump Channel switched on by a user, the selected marker and antibody in that row will be used to avoid those events (associated with cells) to analyze other cells of interest. It avoids these cells from interfering from the experiment of interest.

After all the desired markers and associated antibodies have been selected and added to the table shown in the user interface window 900, the next button or the back button can be selected to respectively go back to the prior tab or move forward to the next tab in the panel building process. Assuming the next button has been selected, we move to the next tab and its respective user interface windows, the Assign-Co-Expression tab and user interface windows 1000A, 1000B1, and 1000B2.

### Marker Co-Expression Assigned by Marker or Cell Type

It is important that cell markers that are co-expressed are assigned to fluorochromes that have a fluorescent light intensity with minimal spread over a narrow wavelength of range and detectors. This is because, after the biological sample is run through the flow cytometer to obtain event data, gating of the event data with gate lines or polygons can readily be used in dual dot plots to gate the cell populations of interest from others cells in the biological sample. The panel builder application uses the assigned marker co-expression, along with other information such as antigen density and antigen classification, in assigning fluorochromes (fluorescent tags, fluorophores) to the selected antibody reagents/markers to generate a multicolor panel.

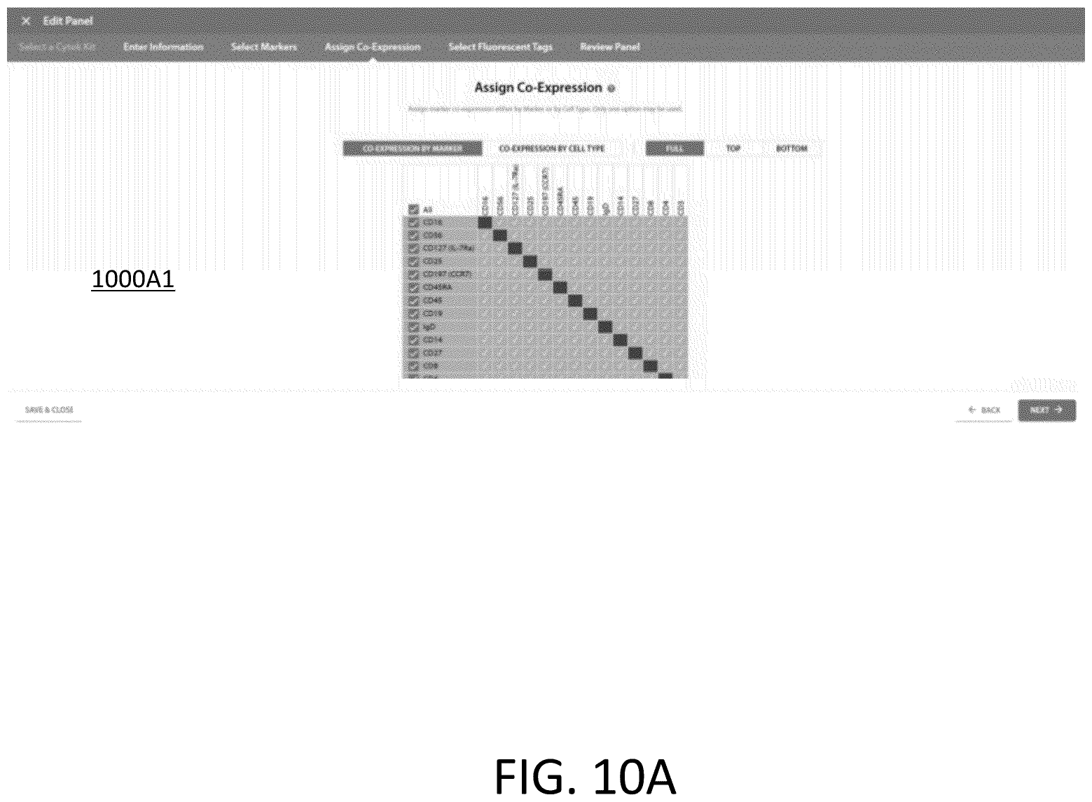

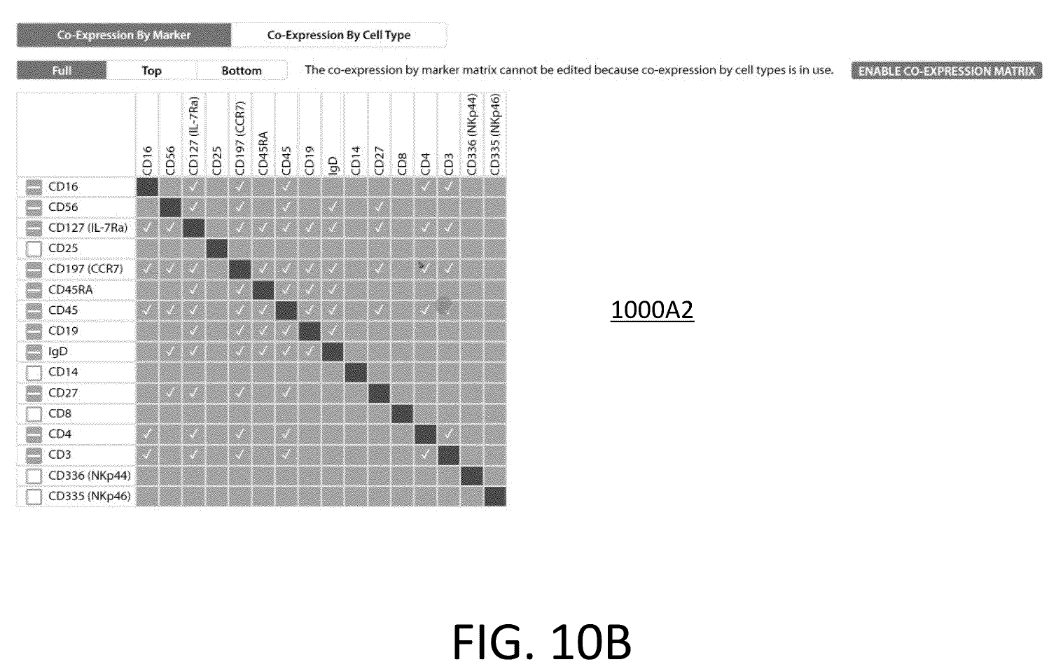

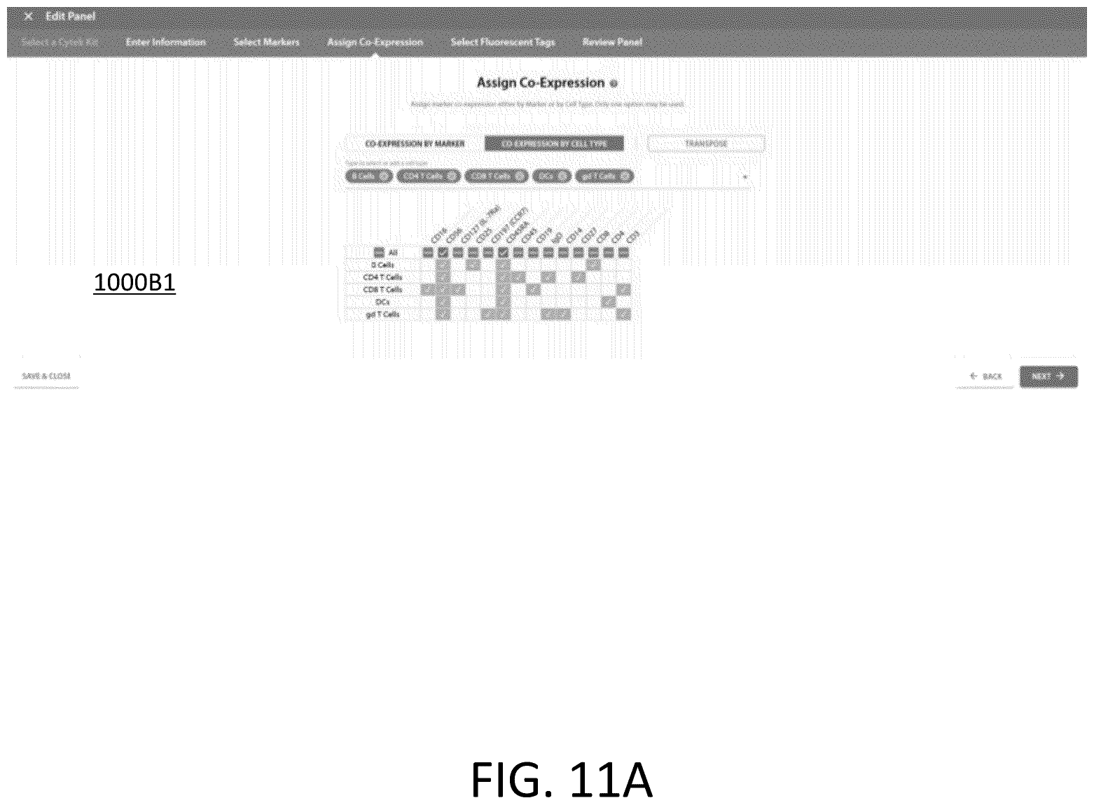

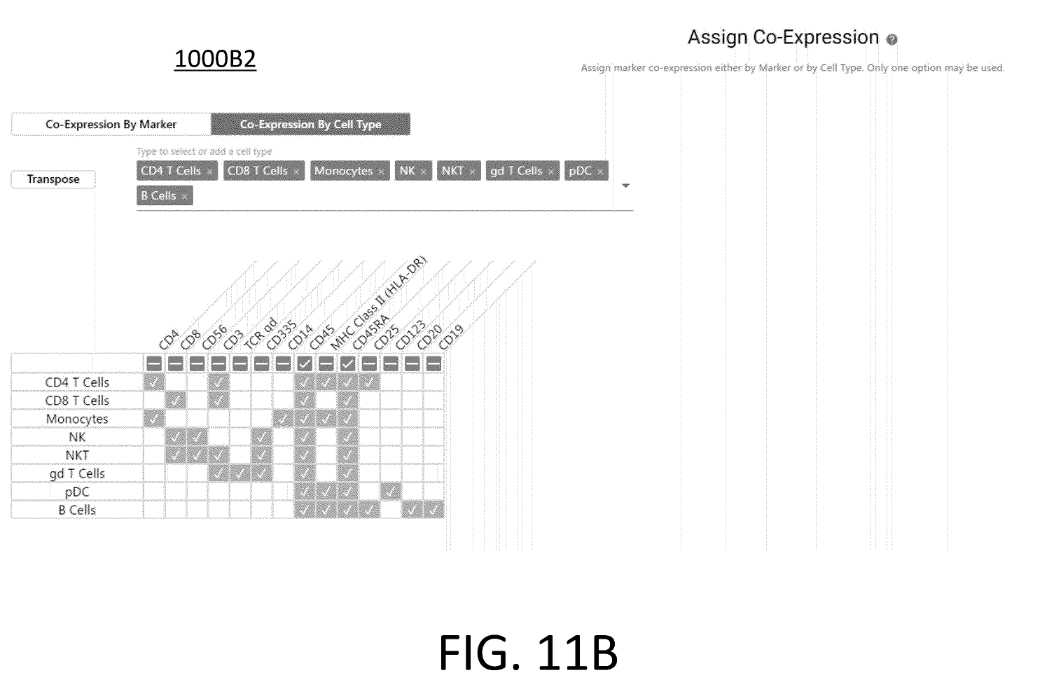

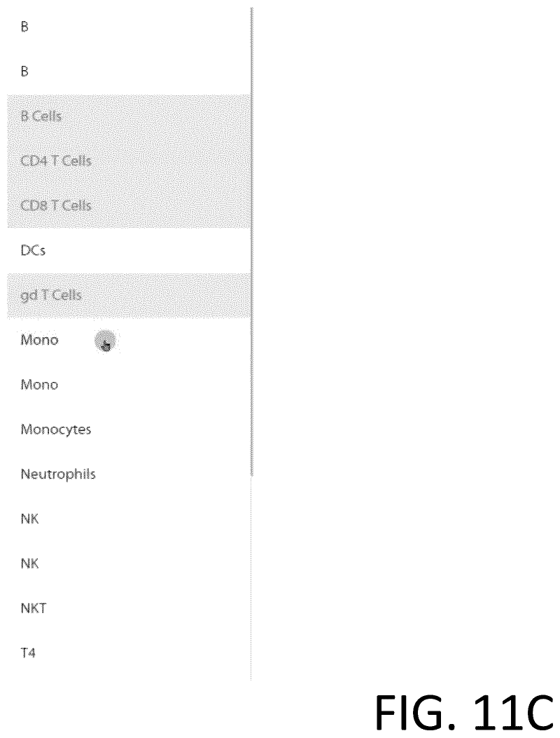

Referring now FIGS. 10A-10B and 11A-11B, when a population of interest is identified in a population of cells and painted with dyes or fluorochromes, a more specific review of the marker expression of the selected population of cells can be done with the event data output from the flow cytometer. When two different markers are paired and assessed together, dual parameter dot plots can be formed on a gated population to gain information about cells in a biological sample. Exemplary cell markers and exemplary cell types are shown in the figures. Exemplary cell markers displayed include CD4, CD8, CD56, CD3, TCR ad, CD335, CD14, CD45, MHC Class II (HLA-DR), CD45RA, CD25, CD123, and CD19 shown in the column index of the matrix shown in FIG. 11B. Exemplary cell types displayed for selection includes CD4 T cells, CD8 T cells, monocytes, NK cells NKT cells, gd T cells, pDC, and B cells shown in the row index of the matrix shown in FIG. 11B.

When it is desirable to generate dot plots with gated dual parameters (fluorochromes attached to cell markers) on different two dimensional axis, it is desirable to understand whether cell markers are mutually exclusive (one expresses the other does not), whether cell markers are co-expressive (whether they both express), and whether or not both markers are not expressive (non-expression) when the fluorochromes are excited by lasers. Traditionally, mutually exclusive marking is where a population only expresses one marker and not the other. In a four quadrant dot plot formed by gating lines, this would be in the upper left quad and the lower right quad. Traditionally, co-expression is where a population expresses both markers. In a four quadrant dot plot formed by gating lines, this would be in the upper right quad. Traditionally, non-expression is when the population of interest does not express either population. In a four quadrant dot plot formed by gating lines, this would be on the lower left quad. The same cell marker can exist on multiple cell types. In some cases, different markers can attach to the same cell.

Cell markers can also provide co-expression on various cell types. For example, marker CD3 is available on CD8 T cells and gd T cells, as is shown in a CD3 column in FIG. 11A. As another example, marker CD3 is further available on CD4 T cells and NKT cells as show in the CD3 column in FIG. 11B. It can be useful to understand this when trying to identify different cells in the event data with a flow cytometer multicolor panel.

Knowing the markers and their level of co-expression is important for successful panel design. The panel builder application in the flow cytometer software cloud allows one to selectively examine co-expression by cell marker or co-expression by cell type. Selecting one button, a chart of co-expression by cell marker can be shown, such as shown by FIGS. 10A-10B. Selecting a second button, a chart of co-expression by cells can be displayed by the graphical user interface, such as shown in FIGS. 11A-11B. With the cell markers pre-selected by the Select Marker tab, the cell types that are to be examined can be selected or added to an input field and displayed on the Y axis versus cell markers along the X axis. The graphical user interface further provides a transpose button to transpose axes and display markers along the Y axis and cell types along the X axis.

The data and information about available cells with their respective cell markers are stored in the universal aggregated database and can called up by the panel builder software application when the Assign-Co Expression tab is selected. The available cells can be associated with mammalian cells such as found in human blood, mice/rat blood, pig blood, etc.

In FIGS. 10A and 11A, the Assign Co-Expression tab is shown be selected in the Tab bar at the top of user interface windows 1000A, 1000B1. Each window has a save & close button in the lower left corner and back and next buttons in the lower right corner. Under the heading Assign Co-Expression, each user interface window includes a co-expression by marker button and a co-expression by cell type button that alternates the chart to be displayed in the window. That is, the user interface windows 1000A1-1000A2 differ somewhat from user interface windows 1000B1-1000B2 when one or the other of the two buttons are selected to assign co-expression.

In FIGS. 10A-10B, the user interface windows 1000A1,1000A2 include additional buttons including a Full button, a Top button, and a Bottom button. The Full button is selected in the user interface window 1000A1,1000A2 to show the full matrix. The full matrix may not be desired by the user because values in the matrix are mirrored along the diagonal. A top button can be pressed for displaying just the top-right portion of the matrix. The bottom button can be selected for just displaying the bottom-left portion of the matrix. The co-expression matrix chart shown in the user interface window 1001A1,1000A2 includes an All check box (interactive selectable pixel area) in an upper left corner of the matrix If the All check box is selected, such as shown in FIG. 10A for example, then the co-expression matrix is fully checked. FIG. 10B shows the case where the All check box is not selected. The matrix chart in the user interface window 1000A1,1000A2 shows an order of marker names along the Y axis (row index) and the same order of marker names as a header or heading along the X axis (column index). The co-expression matrix chart shown in the user interface window 1001A1,1000A2 also includes and a row check box (interactive selectable pixel area) in a sub-index adjacent the row index of each marker name along the Y axis. If the row check box is selected with a check, all of the markers along the row are selected for co-expression with the marker in the row index. If the row check box is empty, none of the other markers along the row (but for itself) are selected for co-expression with the marker in the row index. Marker CD25 in FIG. 10B is an example of this case. The row check box may indicate a center line (negative or dash line) within it to indicate that some other markers, but not all, are selected for co-expression with the marker in the row index. Marker CD16 in the first row is example of this case. For the diagonal along the matrix, an identity diagonal where the same marker is identified in the X and Y axes, the box is blocked out from being checked because it is the same. However, in each other box identified in the matrix, a check mark can be made and in the case of All, a check mark is in all check boxes off diagonal such as shown in FIG. 10A. Depending upon the background, a white colored check mark may be used in the co-expression matrix.

Instead of viewing co-expression in the traditional way of co-expression by marker, a user can elect to view co-expression by cell type by selecting the button co-expression by cell type in the user interface window 1000A1,1000A2. If co-expression of markers by cell type is selected, the co-expression of markers by marker is shown in lighter intensity or grayed-out to indicate that it is non-interactive.

In FIGS. 11A-11B, the button co-expression by cell type is selected so that co-expression matrix by Cell Type is displayed in GUI windows 1000B1,1000B2. With the cell markers pre-selected by the Select Marker tab, the cell markers are displayed as a header of heading along the X axis of the co-expression matrix chart. The cell types that are to be examined can be selected or added to a cell type input field and displayed along the Y axis of the matrix chart. In this manner cell types versus cell markers can be displayed in the chart of co-expression matrix by Cell Type. The cell types are associated with the biological cells that are of interest that the multicolor panel experiment is to analyze. Each cell type has a delete x icon adjacent the name of the cell type so it can be removed from consideration. A pull down arrow in the cell type input field can list a menu of cell types that can be considered such as shown by FIG. 11C.

In FIGS. 11A and 11B, a co-expression matrix by Cell Type is displayed. Each co-expression matrix has empty check mark boxes as well as checked check mark boxes within the matrix. The checked check mark boxes with a first background color indicate the cells upon which the given marker in a column is expressed. For example, in FIG. 11A in the column for marker CD16, there is a checked box in the row associated with cell type CD8 T Cells. This indicates the marker CD16 is expressed on CD8 T Cells. In the column for marker CD16, no other row is checked indicating that marker CD16 does not express on any of the other selected cell types in the set but for CD8 T Cells. The charted matrix can alert the user to the case where a marker can express itself on all the selected cell types.

In an exterior row of the matrix chart Under the header or heading of marker names along the X axis of the matrix chart, a sub-header under the header is displayed as an exterior row of check mark boxes (interactive selectable pixel area) in each column under and adjacent the marker name. Each check mark box is shown with either a center line (negative or dash line) in a second differing background color (e.g., grey), a check mark in a third differing background color (e.g., blue), or empty (no selection). An “All” check mark box can be provided in the corner of the matrix as is shown in user interface window 1000B1, which allows the user to fill or empty the entire matrix with a single click. When checked, the check mark box in a column of the sub-header indicates that the marker associated with that column is expressed on all of the cell types. When unchecked, but with the negative line (center line), the negative line in the check mark box indicates that the given marker is not expressed on all the cell types, but a subset of cell types. In FIG. 11A, for example, the marker CD56 has a check mark in the check mark box indicating that it is expressed in all of the cell types listed along the Y axis of the matrix. Conversely, the marker CD25 has a negative line it its check mark box under its name to indicate that it is expressed with less than all of the cell types. In FIG. 11A, for example, the marker CD25 is only expressed on the B Cells in the selected set of cell types (B Cells, CD4 T Cells, CD8 T Cells, DCs, gd T Cells). Each check box under the marker names is there to alert the user to a case where a marker can express itself on all the selected cell types shown in the Y axis. In the sub-header, the check mark box (interactive selectable pixel area) under a marker can also be empty, without a check mark or a negative line. The empty check box (interactive selectable pixel area) in the sub-header (sub-index) below the header (column index) indicates that none of the cell types (row index) listed along the Y axis is co-expressed with the marker associated with that column.

As co-expression by cell type matrix has selections made, the co-expression by marker matrix is updated based on the co-expression by cell type matrix. For example, FIG. 10B illustrates an update to the co-expression by marker matrix shown in FIG. 10A with fewer than all selected based on the co-expression by cell type matrix selections. By using the co-expression by cell type matrix for entry, the editing of the co-expression by marker matrix is disabled when the co-expression by cell type matrix is in use. However, an enable co-expression matrix button can be selected by the user to save prior work and start editing the co-expression by marker matrix instead.

Each of the user interface windows associated with the Assign Co-Expression Tab, has the back and next buttons in the lower right corner. A user can select the back button to alter the selected markers shown in the co-expression matrix. A user may want to add more markers or subtract certain markers from the flow cytometer experiment they are generating with the panel builder software. They can go back and make those selections, and the updates will be propagate through to the other tabs, associated user interfaces and software of the panel builder. If the user is satisfied with the assignments in the co-expression matrix, a user can select the next button and go to the select fluorescent tags tab and the user interfaces associated therewith.

In some embodiment, the panel builder software application can enter the check marks in the Co-expression by Cell matrix and the co-expression by marker matrix knowing the markers that are available on the cells of interest to analyze in the flow cytometry experiment with the multicolor panel. The panel builder software application can further select the antigen density and the antigen classification values knowing the cells of interest to analyze in the flow cytometry experiment with the multicolor panel. In other cases, the panel builder software application can select average values or nominal values for performance parameter requirements in order to further assist the user in reducing the number of decisions in generating a multicolor panel. In which case, the panel builder software can pre-fill information up front so that a user doesn't have to enter their own information. In one embodiment, given the flow cytometer configuration and the cells of interest to analyze in the flow cytometry experiment, the panel builder software application can automatically generate a multicolor panel with minimal input from the user.

### Select Fluorescent Tags Tab and Interactive Panel Builder Graphical User Interface

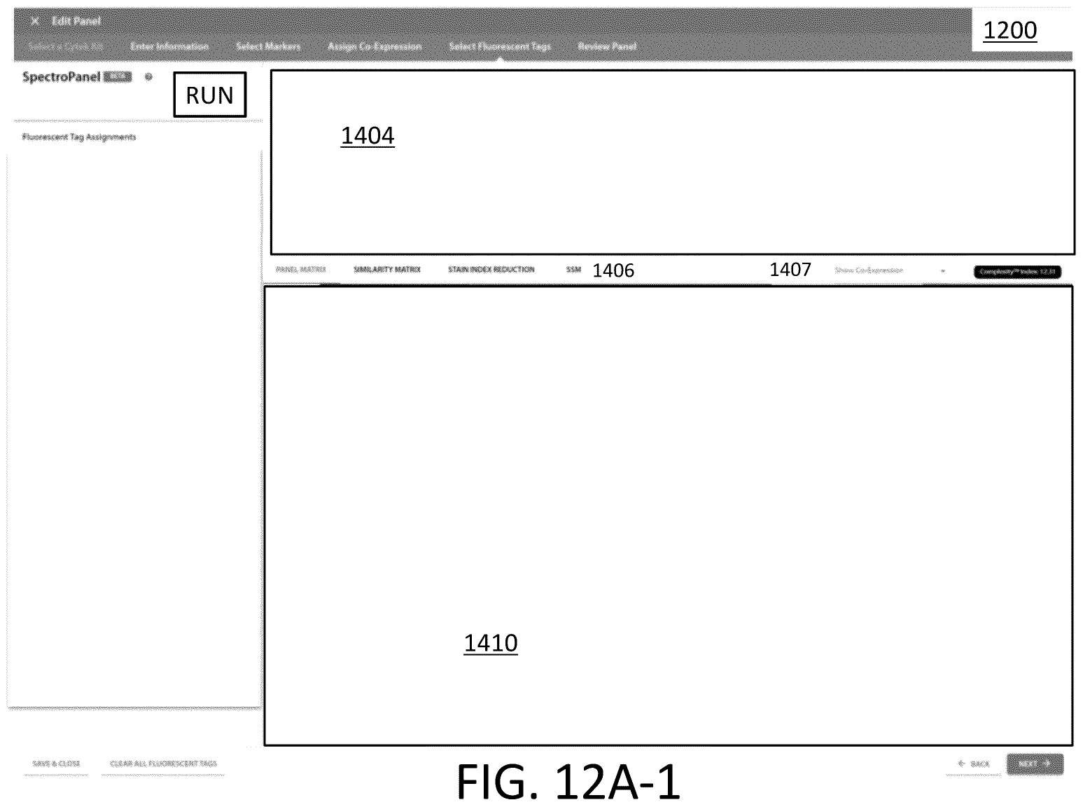

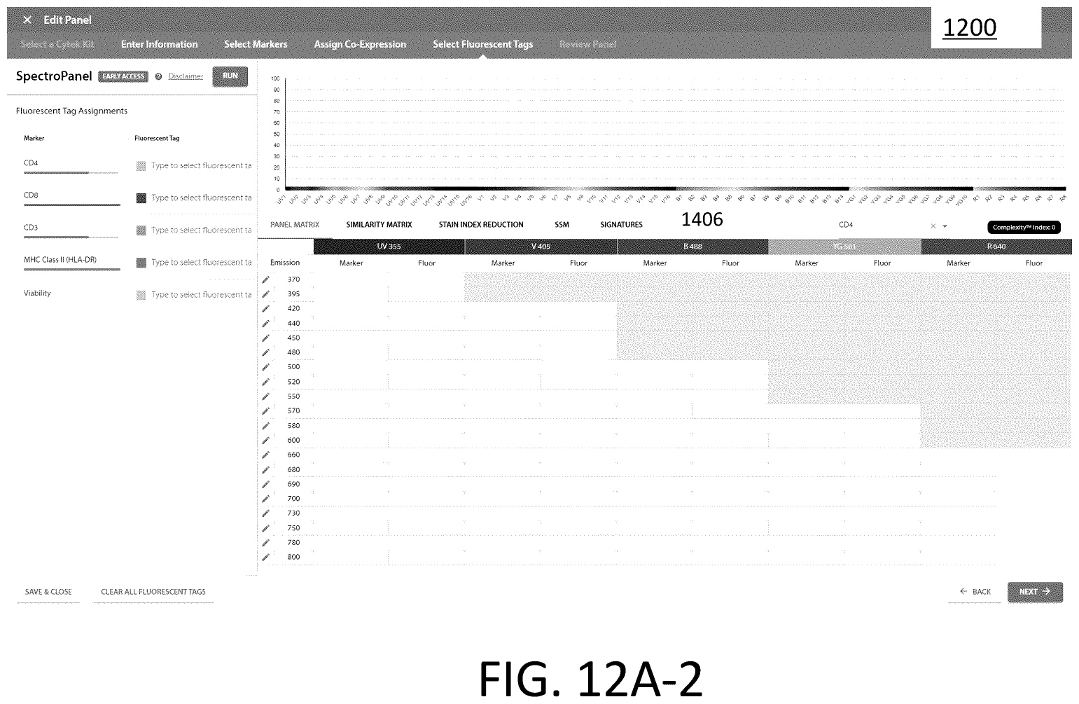

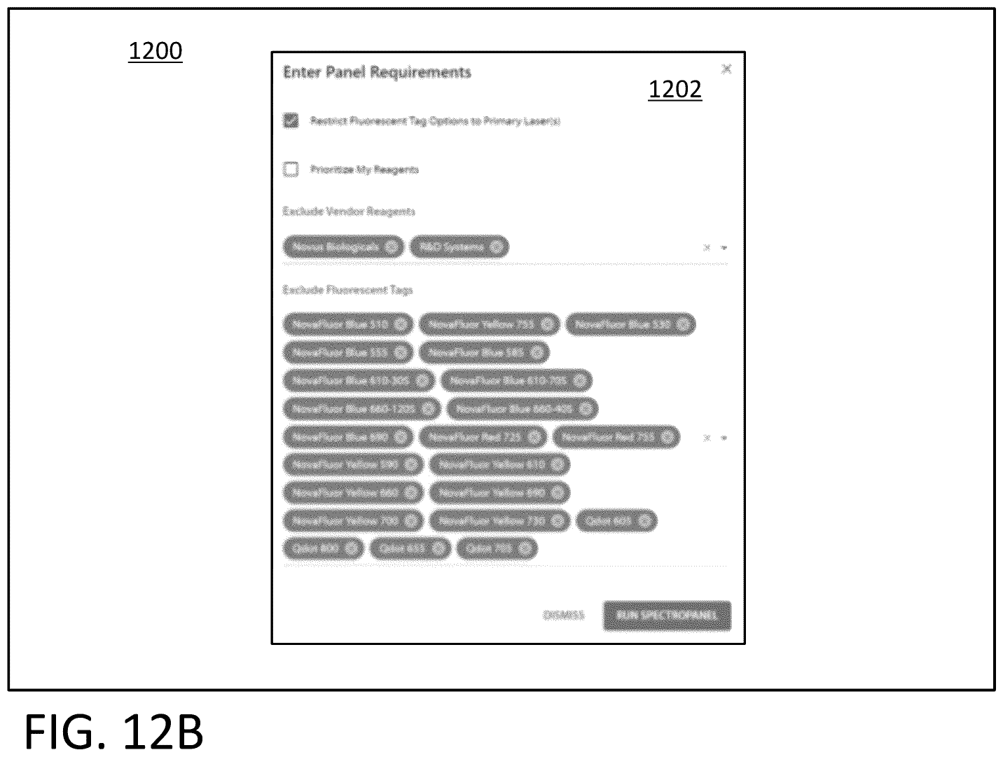

Referring now to FIGS. 12A-14K, a select fluorescent tags tab is selected and additionally interactive GUI windows for the interactive panel builder graphical user interface are shown. With the markers and monoclonal antibodies (reagent) selected for the biological cells to be analyzed, one or more of the fluorochromes (fluorescent tags) to be assigned to the markers can now be manually selected by a user or automatically selected for the available configuration of a full spectrum flow cytometer using the interactive panel builder graphical user interface to fully generate a panel matrix of a multicolor panel for flow cytometer experiments. The interactive panel builder graphical user interface is an interactive automated panel designer. The interactive panel builder graphical user interface is flexible in that a user may select one or more of their preferred fluorochromes for use with selected markers while other fluorochromes are automatically selected for use with other markers in the multicolor panel by the panel builder software. The interactive panel builder graphical user interface uses information that was previously provided to it in order to automatically design a multicolor panel for the user. The automated panel designer uses a user selected marker list, clone restrictions, antigen density, antigen classification, co-expression, and user selected fluorescent tag choices in combination with panel design best practices to optimize the panel design. A user can limit the vendors and fluorescent tag options before selecting the run button and initiating the algorithm to generate the panel design. The generation of the panel matrix for a generated multicolor panel is an iterative process that includes comparing performances of fluorochromes to meet requirements, selecting fluorochromes for a plurality of multicolor panels, evaluating similarity matrices for the plurality of multicolor panels, evaluating the complexity index score for the plurality of multicolor panels, and selecting an optimized multicolor panel out of the plurality of multicolor panels. A user need not manually select any fluorescent tag for any marker in the panel matrix. A user can manually select all the fluorescent tags for all the markers of a panel matrix if so desired. A user can also manually select some, but not all, of the fluorescent tags for the markers in a panel matrix. A user can lock certain markers assigned to user selected fluorescent tags before selecting a run button to generate the multicolor panel. With some user selected fluorescent tags assigned to markers, the panel builder generates a plurality of panel matrices, one panel matrix (requested panel) generated with the user selected fluorescent tags and another panel matrix (suggested panel) generated without using any of the user selected fluorescent tags. In the case there are user selected fluorescent tags but not for all markers, the generation of the panel matrix performs the iterative process to select missing fluorescent tags for the remaining markers. In this way, the software is flexible in designing a multicolor panel in that a user can manually select none, some, or all of the fluorochromes for the markers in the panel matrix of the multicolor panel.

In FIG. 12A (FIGS. 12A-1 and 12A-2), an interactive panel builder graphical user interface window 1200 is displayed with sub window portions. The interactive panel builder graphical user interface window 1200 points to the select fluorescent tags tab, the next tab in line of forming a multicolor panel after the Assign Co-expression tab. The interactive panel builder graphical user interface window 1200 includes a number of user selectable interface buttons including a save & close button, a clear all fluorescent tags button, a back button, and a next button. The interactive panel builder graphical user interface window 1200 also includes a series of buttons 1406 that are user selectable one at a time to show different information to a user in a selectable sub window portion 1410. The panel matrix button is selected as shown so that a panel matrix can be displayed in the sub window portion 1410. However, the panel matrix is currently blank as the multicolor panel has not yet been generated. The interactive panel builder graphical user interface window 1200 further includes a fluorescent tag assignment window portion 1402 and a spectral chart view window portion 1404.

Before a multicolor panel is generated, a run button is further provided in the user interface window 1200 for the user to select. When the user selects the run button, an enter panel requirement user interface popup window 1202 is displayed in the foreground over the interactive panel builder graphical user interface window 1200 such as shown by FIG. 12B.

Referring to FIG. 12B, generally before a multicolor panel is generated with the prior selected performance requirements and selected markers/antibodies, an enter panel requirement user interface pop up window 1202 is displayed over the interactive panel builder graphical user interface window 1200. The enter panel requirement user interface pop up window 1202 has a number of user entry fields that are used to assist in the selection of the fluorochromes (fluorophores or fluorescent tags) that are used with the antibodies (antibody clones) that attach to the cell surface markers of biological cells in a biological sample. The enter panel requirement user interface pop up window 1202 restricts and prioritizes the available fluorochromes and reagents that are read from the UADB. The fluorochromes (fluorophores) or fluorescent tags are excited by specific wavelength ranges of laser light, so they are usually associated with one of the color lasers in the flow cytometer configuration and when excited they emit fluorescence (fluorescent light) in generally known wavelength ranges to be detected by known detector channels and respective semiconductor photodiodes. It can be helpful when a plurality of fluorochromes are used to view the expected fluorescence of each to gain an understanding whether or not what is selected can be determined from the detectors. If there is substantial overlap of emission by fluorochromes at the similar intensities, it may be more difficult to discern between fluorochromes in the event data generated by a flow cytometer.

The enter panel requirement user interface window 1202 is displayed to enter requirements to associate fluorescent tags (fluorochromes, fluorophores, dyes, or stains) with the selected markers from the co-expression matrix. The requirements include an option to restrict the fluorescent tags the primary lasers, listing one or more of fluorescent tags to exclude from considering, listing one or more suppliers of reagents (conjugated antibodies) to exclude, and prioritizing user selected suppliers and/or user owned reagents (conjugated antibodies). Suppliers of fluorochromes can also be selected to exclude in an alternate embodiment. In yet another alternate embodiment, instead of excluding suppliers, specific suppliers can be specified for consideration.

Some fluorochromes can be excited by different lasers. For example, a blue laser may excite a fluorochrome designed to be excited by a UV laser. The restrict the fluorescent tag to the primary lasers option would not use a fluorochrome specifically designed for being excited by the UV laser under a violet laser or any other laser but UV in the multicolor panel. A user may not like the performance of some known fluorochromes based on experience and specifically have it restricted from usage by the interactive panel builder software in generating a multicolor panel. The input field Exclude Fluorescent Tags allows a user to restrict those fluorochromes from being selected in generating a multicolor panel. In some cases, a user can prefer to restrict the usage of a vendor's reagents in the multicolor panel. The input field Exclude Vendor Reagents allows for that case. Alternatively, a user may prefer to use their own reagents because they have previously purchased them, the user wants to use them before they expire and avoid added costs. The Prioritize my Reagents input field in the Enter Requirements popup window can allow a user to enter the user pre-owned reagents and the user pre-owned fluorescent tags (fluorochromes) to prioritize them for use in a multicolor panel if performance requirements can be met.

After being entered on the list in the enter panel requirement user interface window 1202, adjacent each vendor or supplier name is a circle X icon button (cancel icon button) that can be selected by the user. The circle X icon button can be selected to remove that vendor or supplier name, so they are instead selected for inclusion. Similarly, adjacent each listed fluorescent tag to be excluded is a circle X icon button (cancel icon button) that can be selected to remove that fluorescent tag from being excluded. If not excluded, the fluorescent tag stored in the data base and sold by a supplier can be selected by the software for inclusion in the multicolor panel if the performance requirements are met.

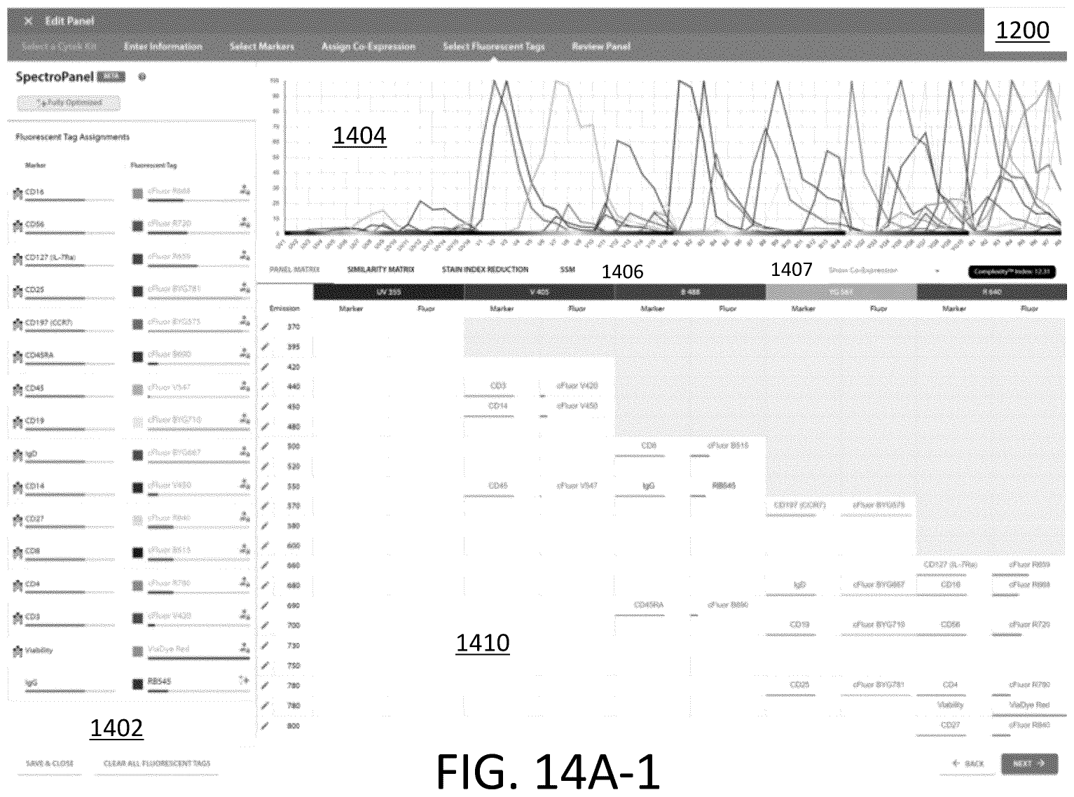

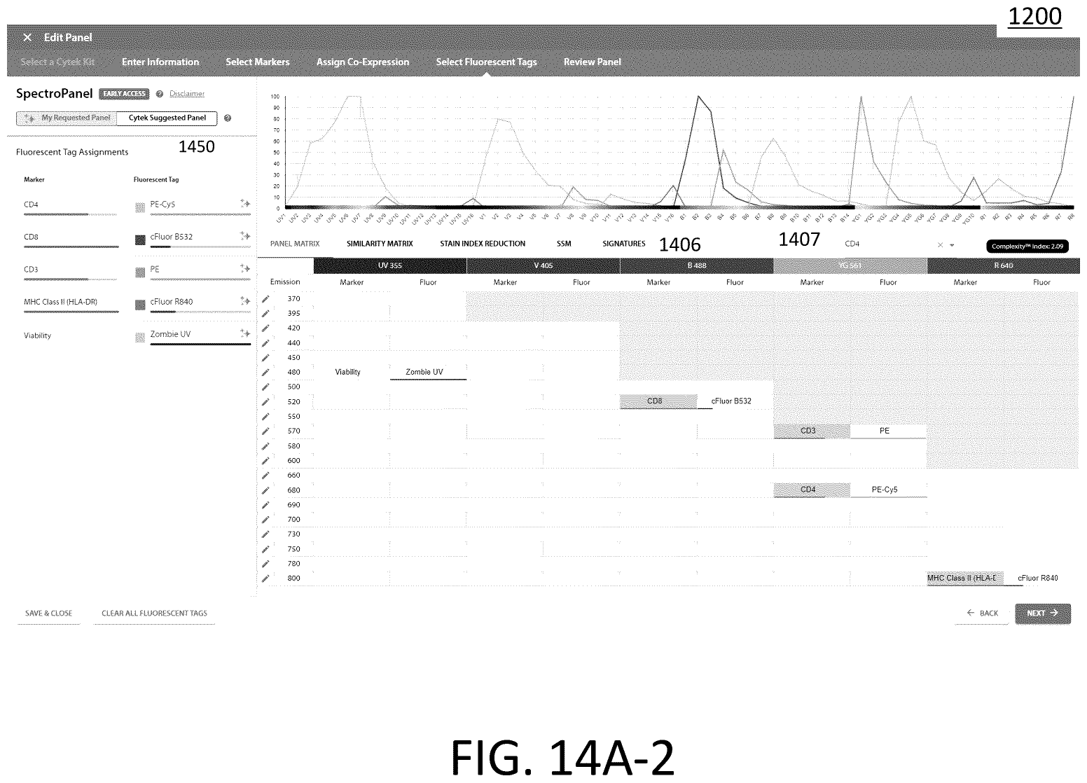

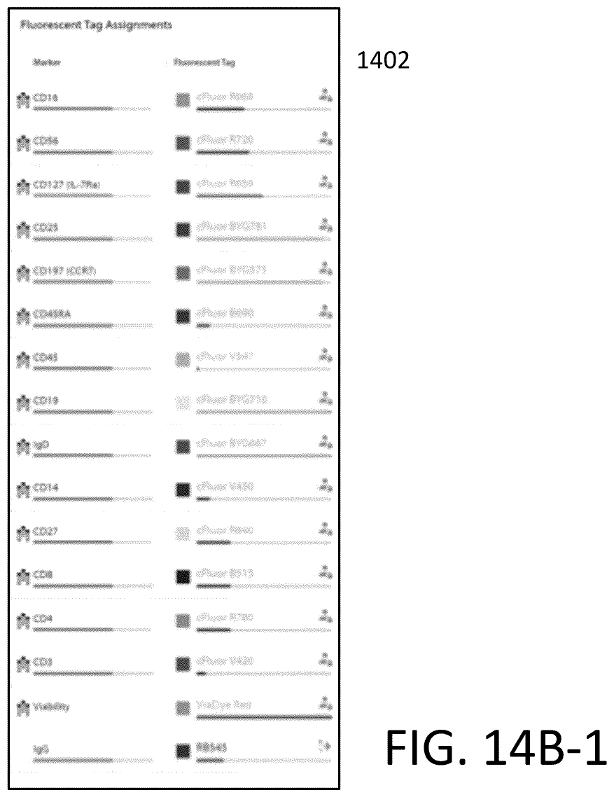

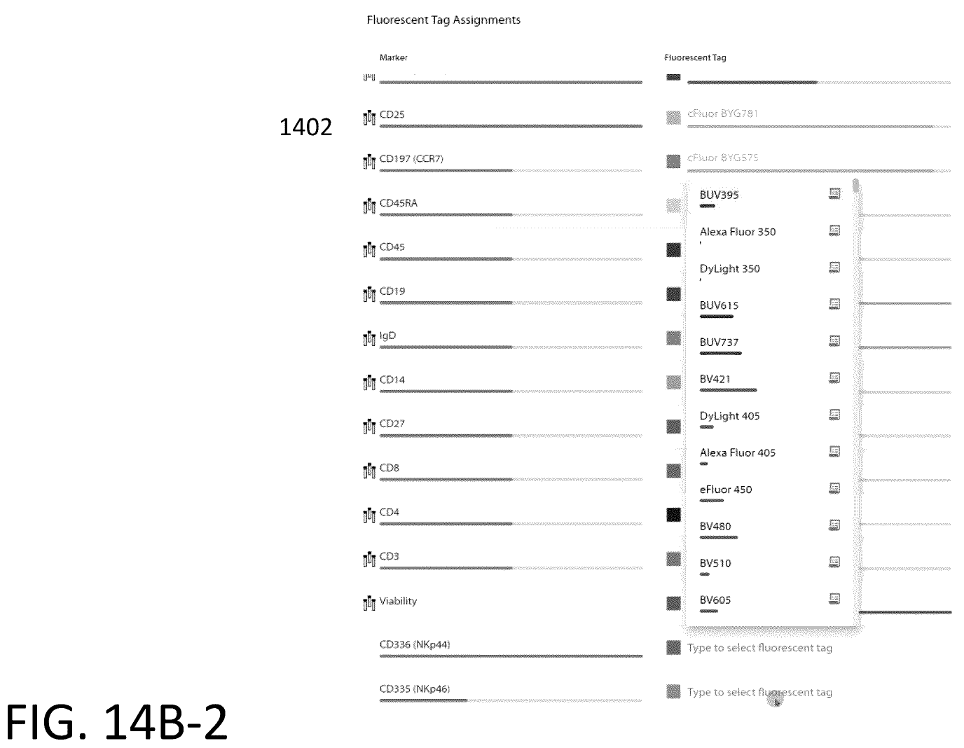

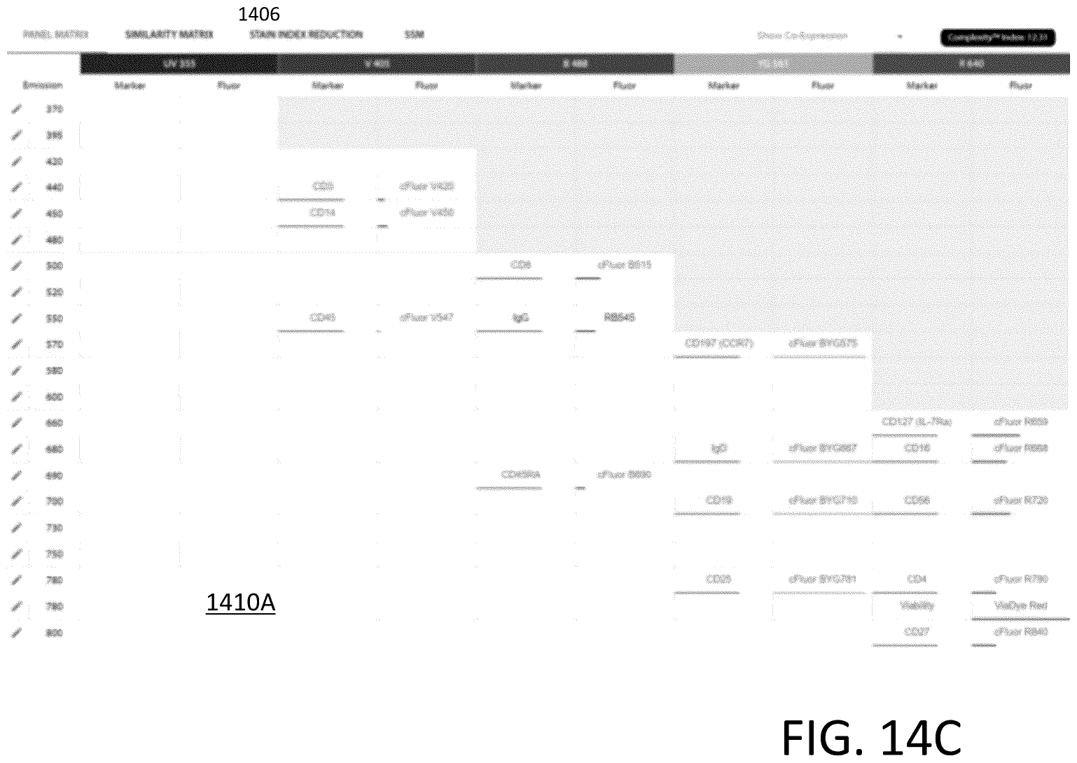

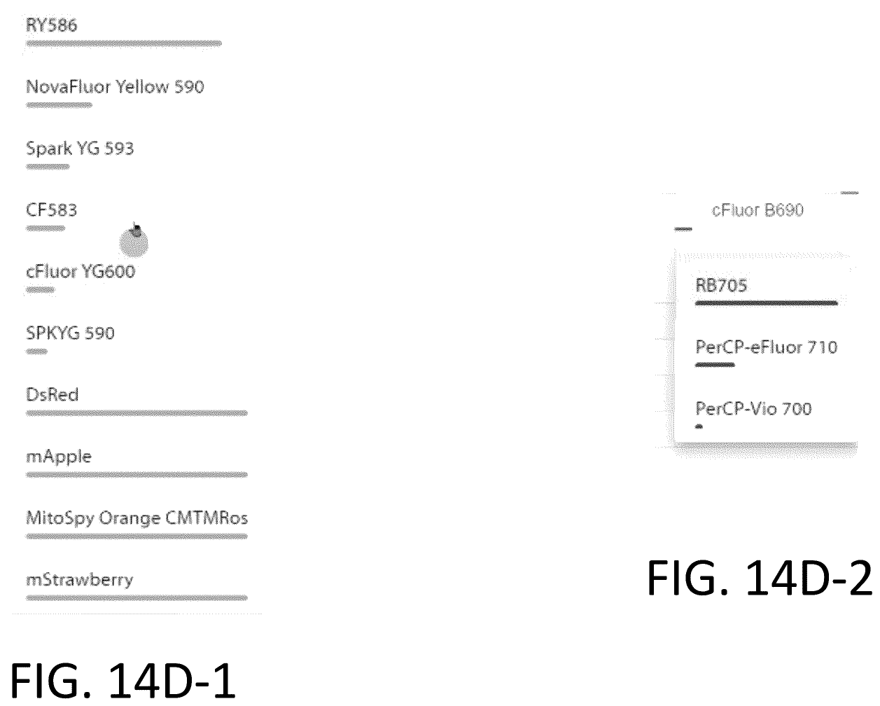

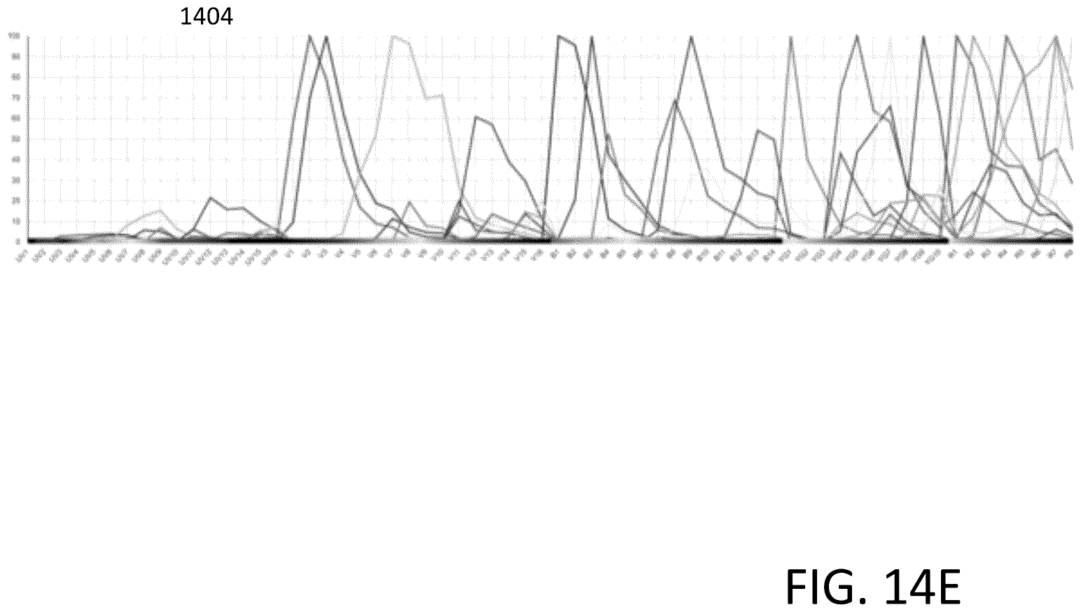

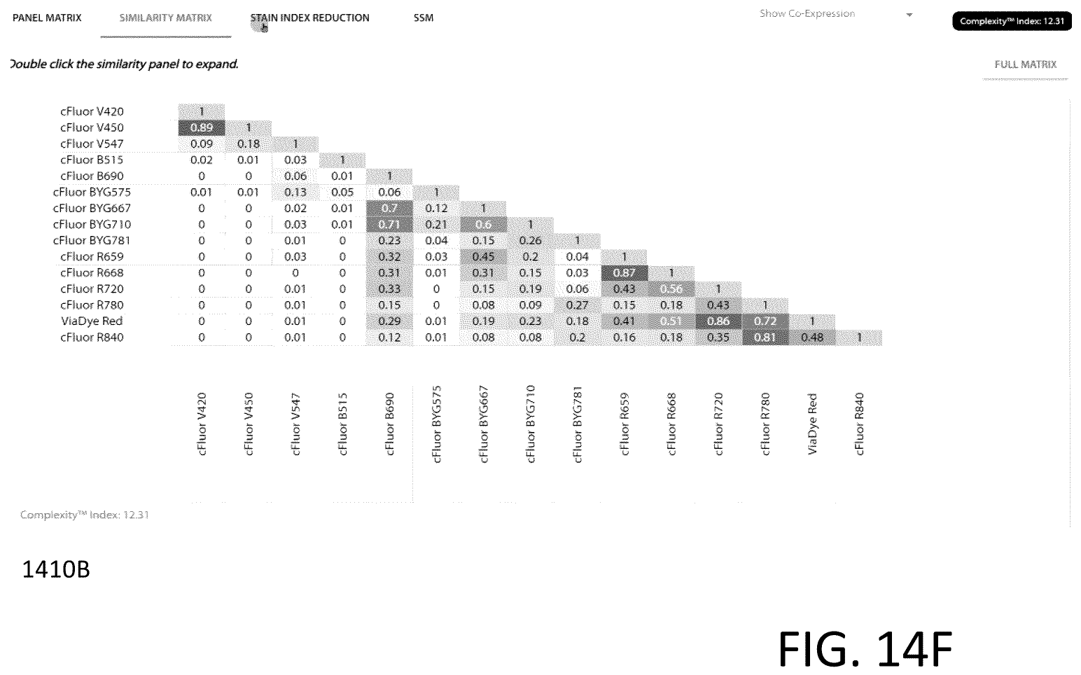

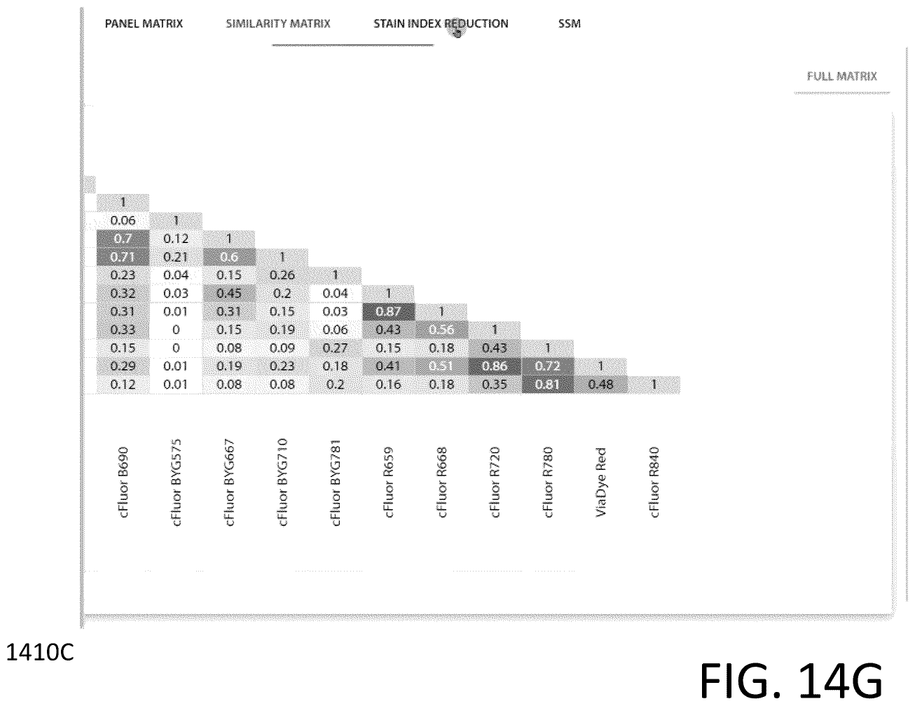

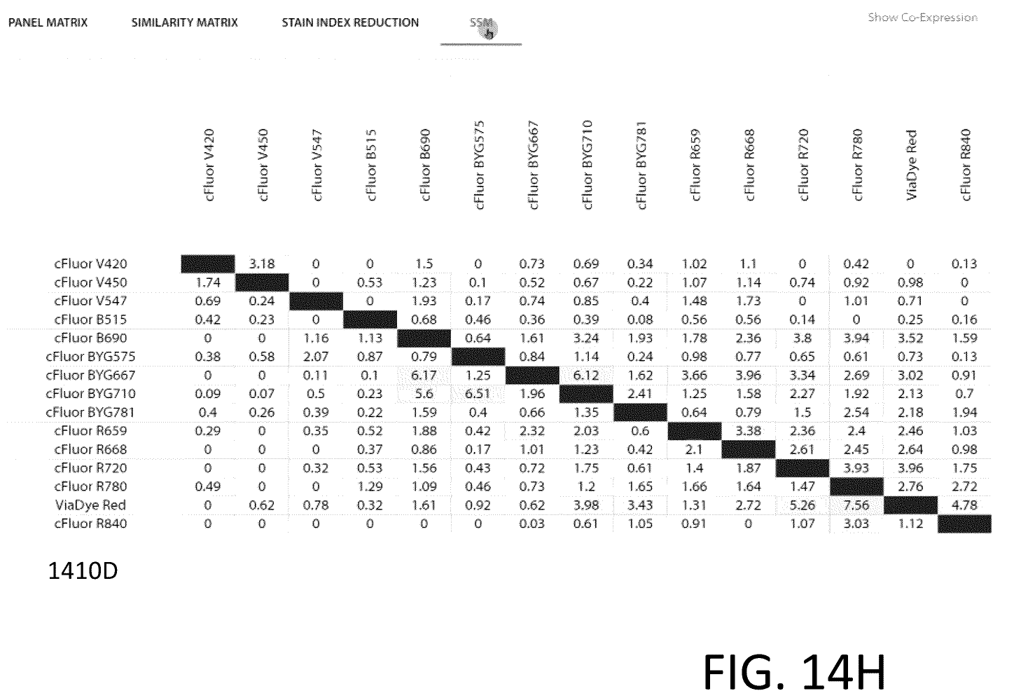

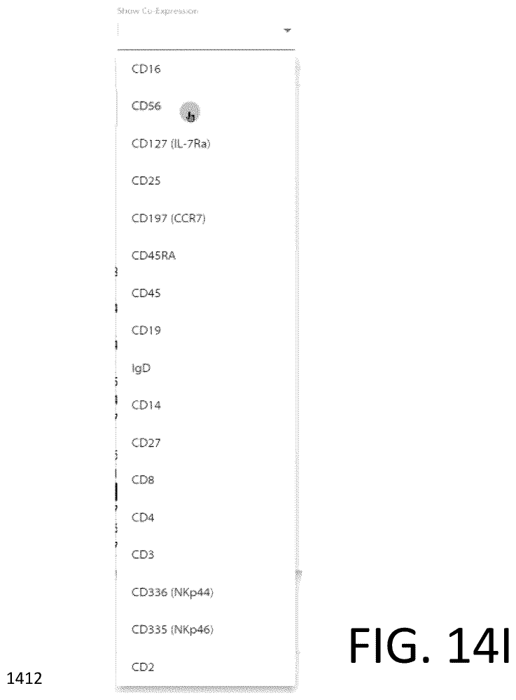

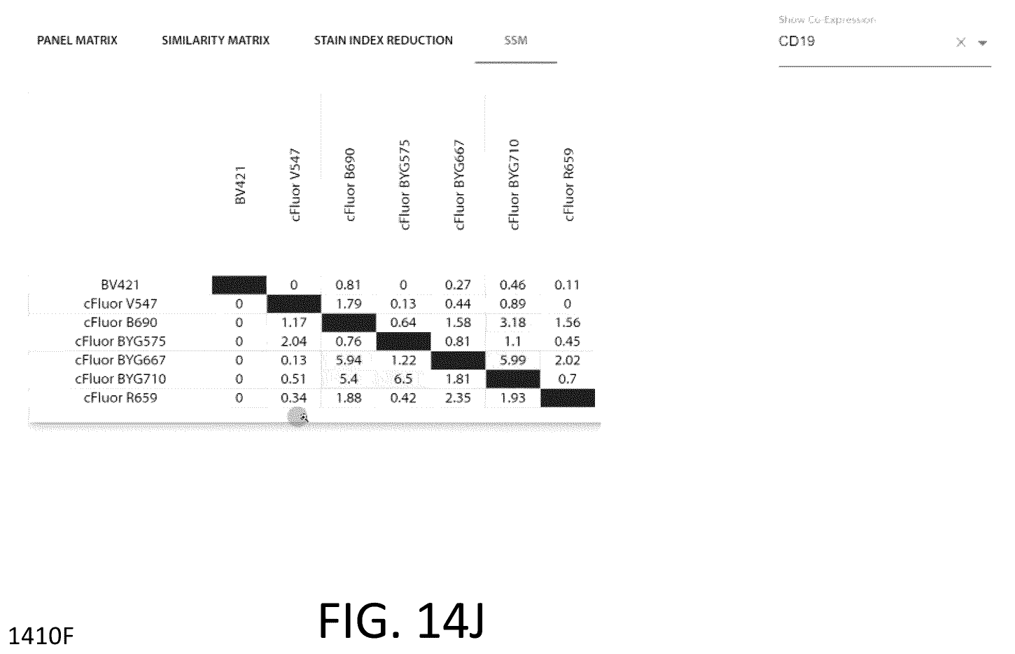

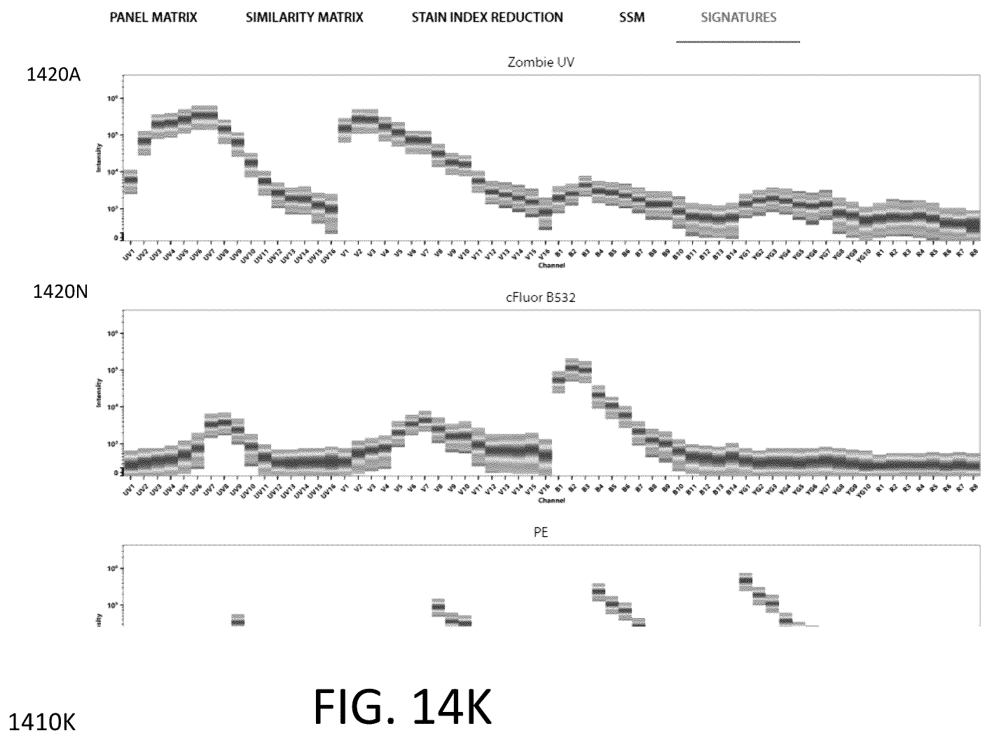

After the panel requirements are entered, if any, the enter panel requirement user interface window 1202 includes a run button with the word RUN. The run button is selected to generate the multicolor panel and review it in the interactive panel builder user interface window 1200. The multicolor panel is an online multicolor panel as is shown in the panel matrix 1410A show in FIG. 14C. The enter panel requirement user interface window 1202 also includes a dismiss button with a different background color and the word DISMISS so the current interactive panel builder graphical user interface window 1200 can be viewed in the foreground. Assuming the run button is selected, it can take some processing time to show a new or revised interactive panel builder graphical user interface window 1200 in response to the requirements.

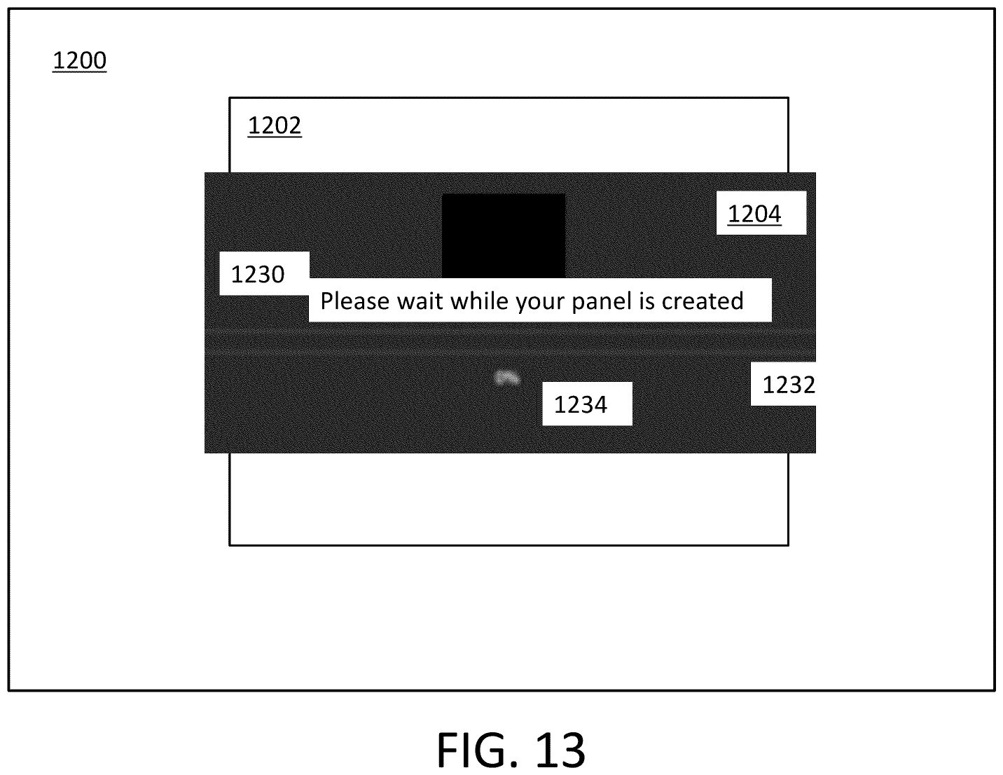

In FIG. 13, the interactive panel builder graphical user interface window 1200 and the enter panel requirement user interface window 1202 are displayed in the background, while a progress pop up window 1204 is displayed in the foreground. The interactive panel builder graphical user interface window 1200 continues to point to the select fluorescent tags tab while the pop-up windows or picture in picture windows are displayed overlaid onto the interactive panel builder graphical user interface window 1200. During the display of the progress pop up window 1204, the panel builder software is reading the available fluorochromes (fluorescent tags) from the UADB data base and their performance specifications with the available flow cytometer configuration (available laser colors and detector number) to suggest a plurality of fluorochromes (fluorescent tags) that is optimized for usage with the user selected markers and antibodies. In some cases, a user may select the fluorochrome to match to a marker and lock the pairing together before the software generates a multicolor panel. The panel builder software performs calculations and fluorochrome selections considering the values of the spread, the co-expression, the complexity index, the similarity matrix, the antigen density, the antigen classification, and the stain index reduction matrix to generate a multicolor panel for a selected configuration of an available full spectrum flow cytometer. The panel builder optimizes the values by minimizing some and maximizing others in the generation of the multicolor panel.

The progress pop up window 1204 includes a notice 1230 to the user that the panel is being created given the input parameter change. The window 1204 further provides a progress bar 1232 to show the real time progress being made in regenerating the spectrum viewer window before it is displayed. The window 1204 further provides a percentage number 1234 to further illustrate progress in regenerating the interactive panel builder graphical user interface window 1200. Once the regeneration of the interactive panel builder graphical user interface window 1200 is completed, the flow cytometer cloud system displays the regenerated interactive panel builder graphical through the client web browser, such as shown by FIG. 14.

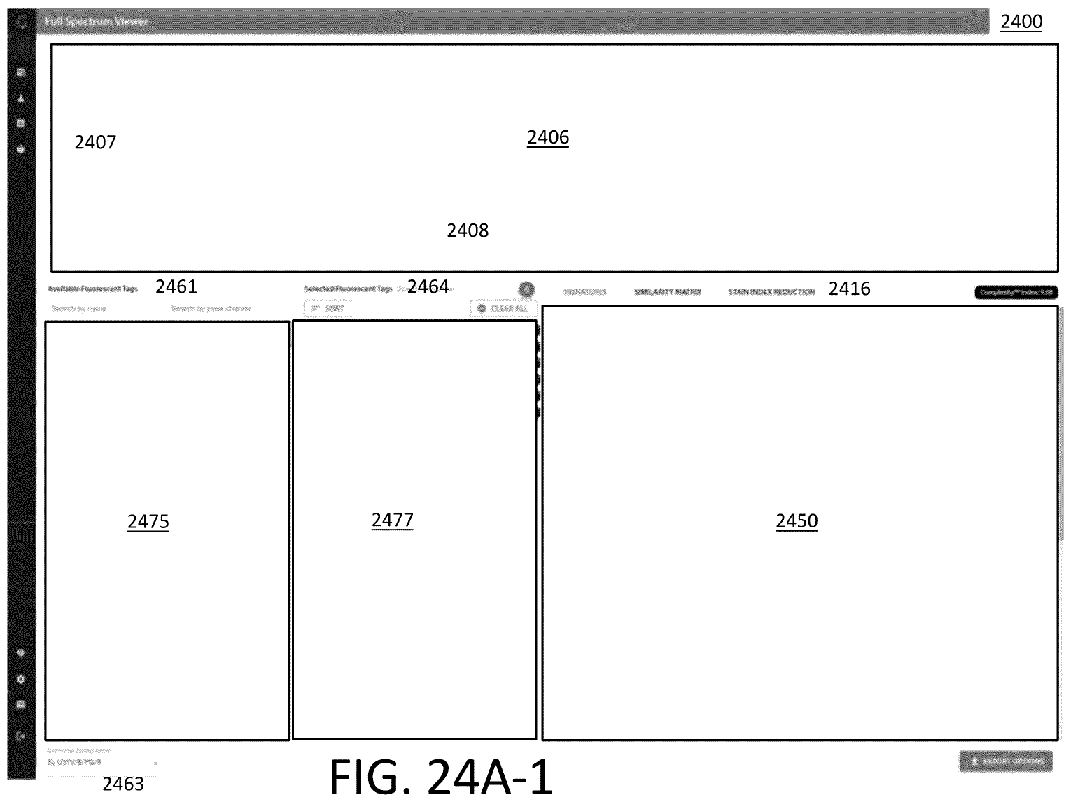

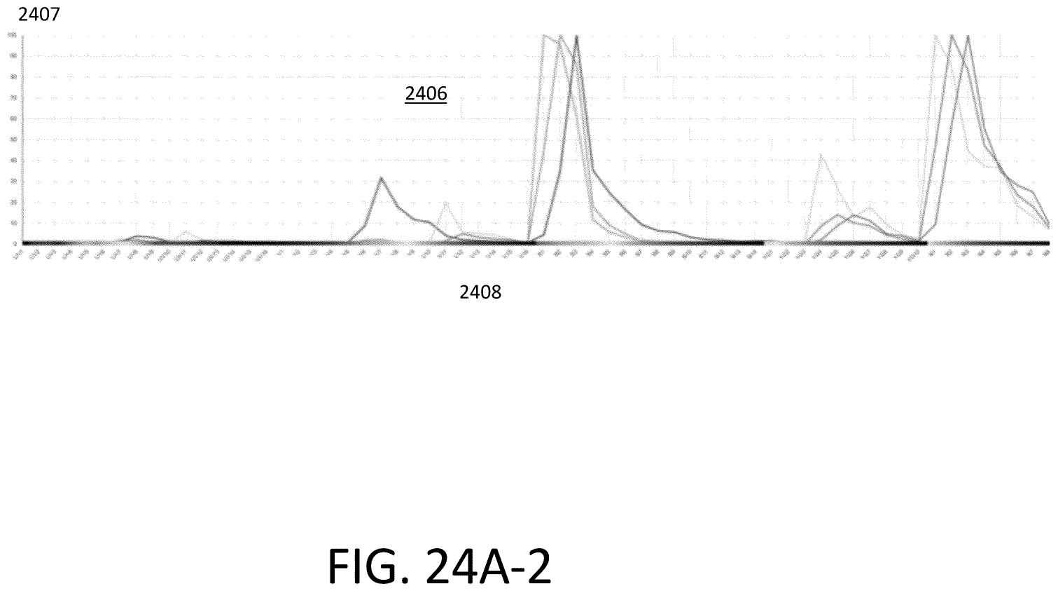

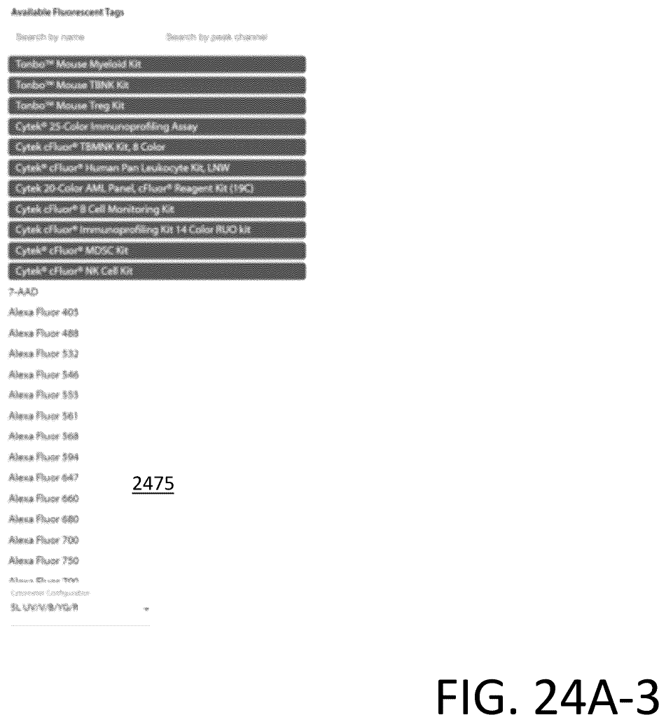

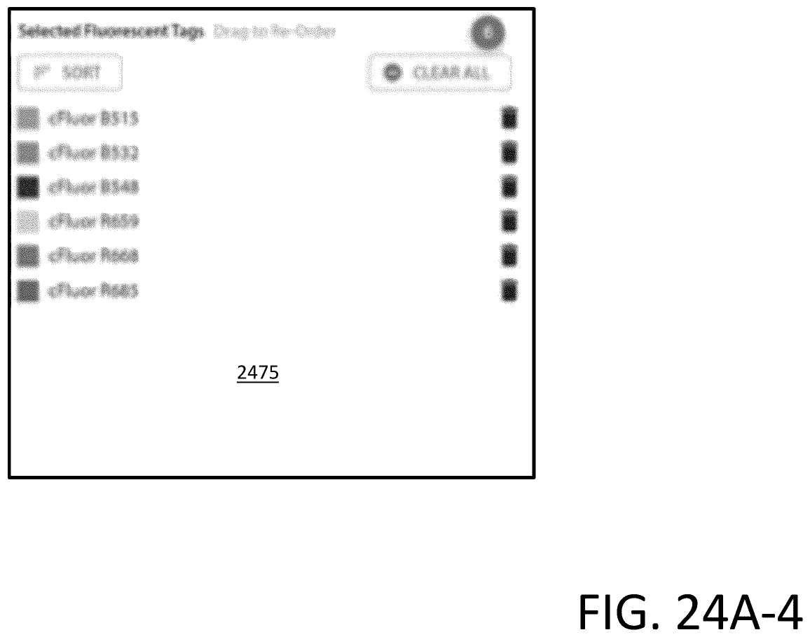

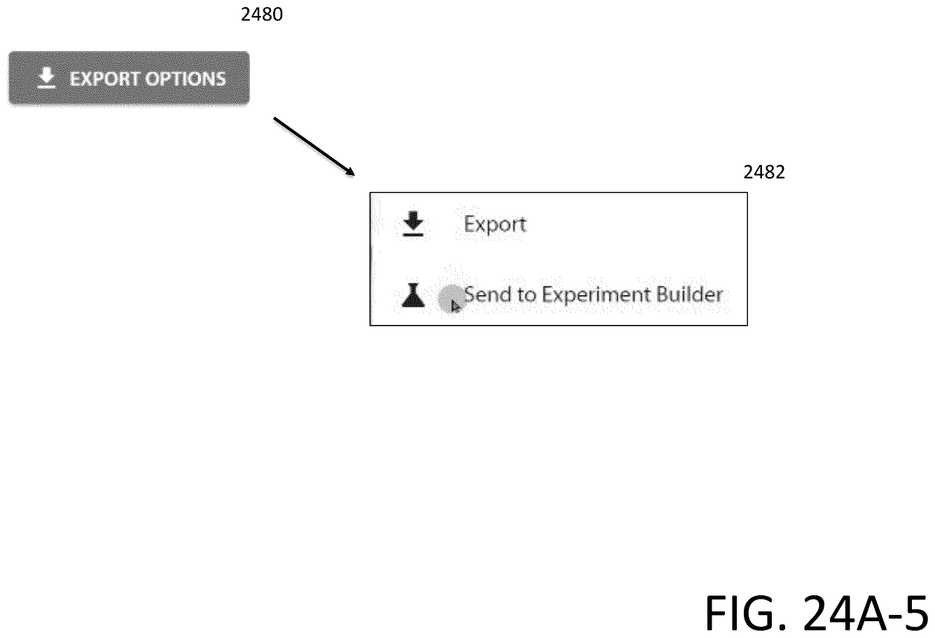

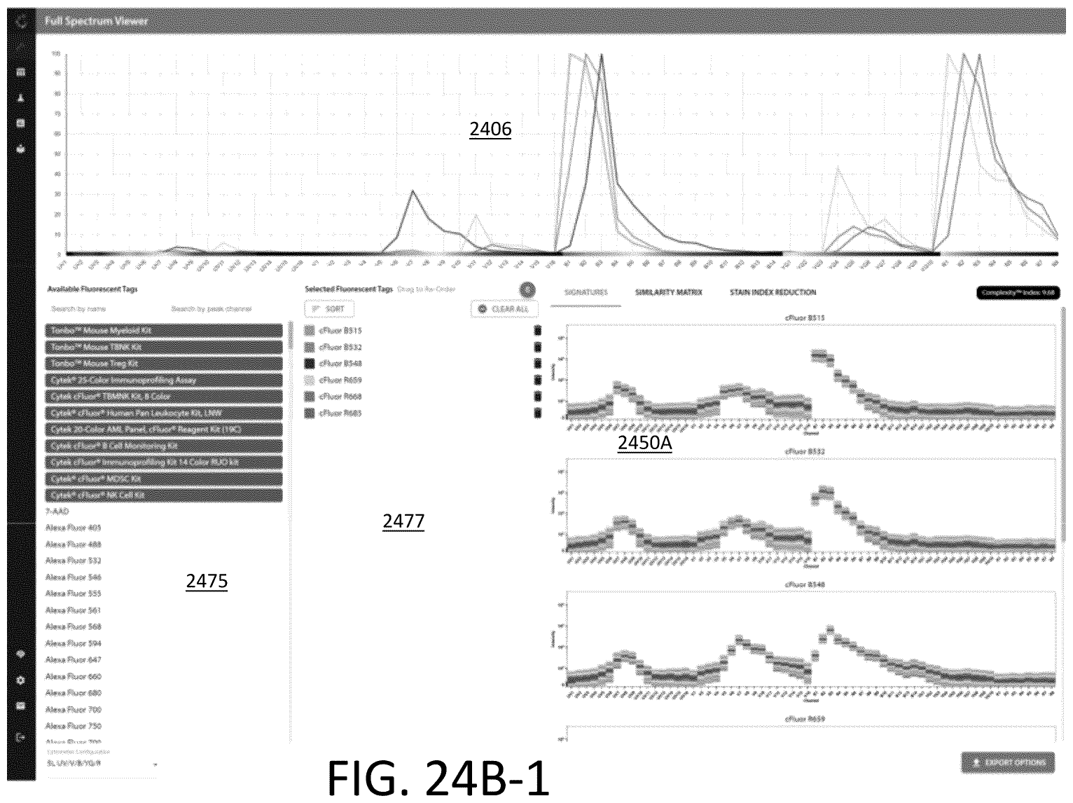

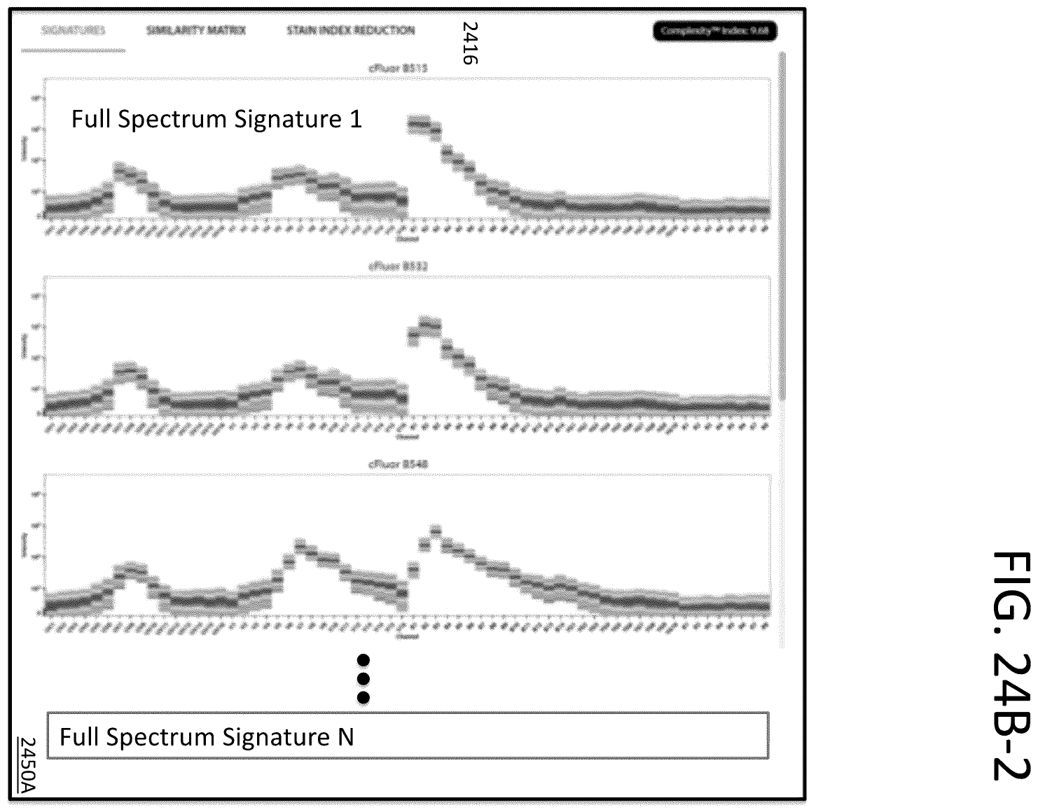

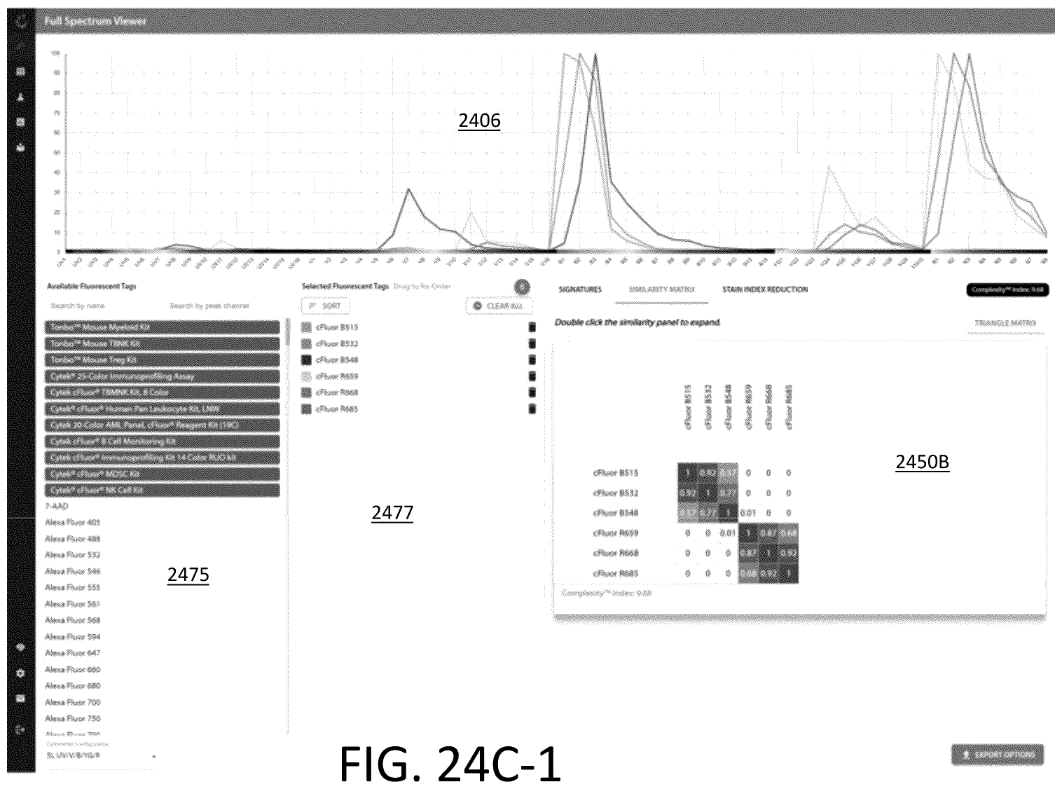

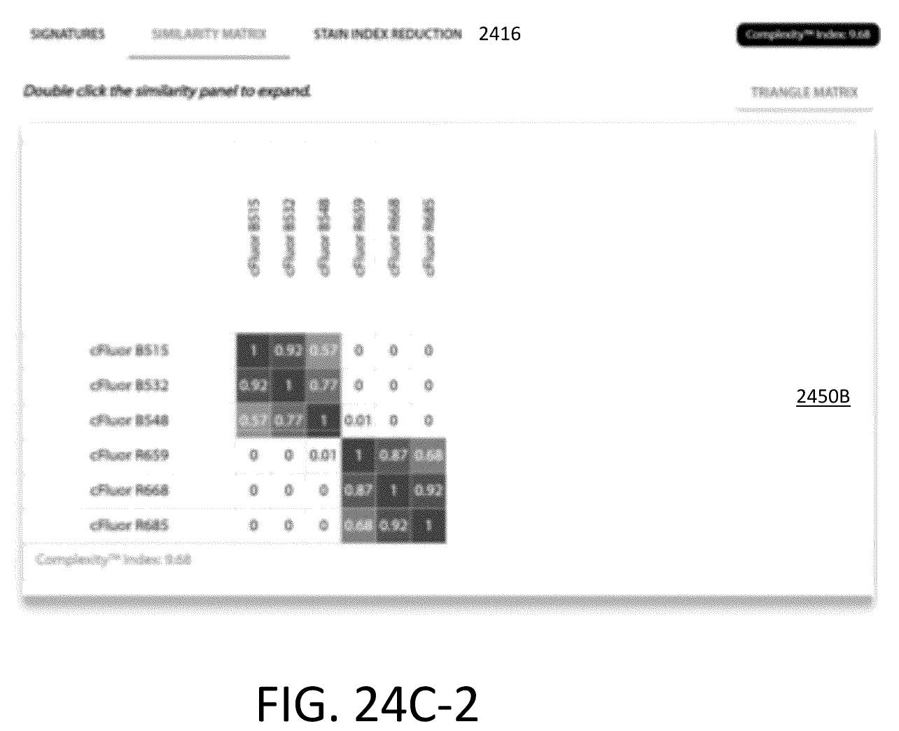

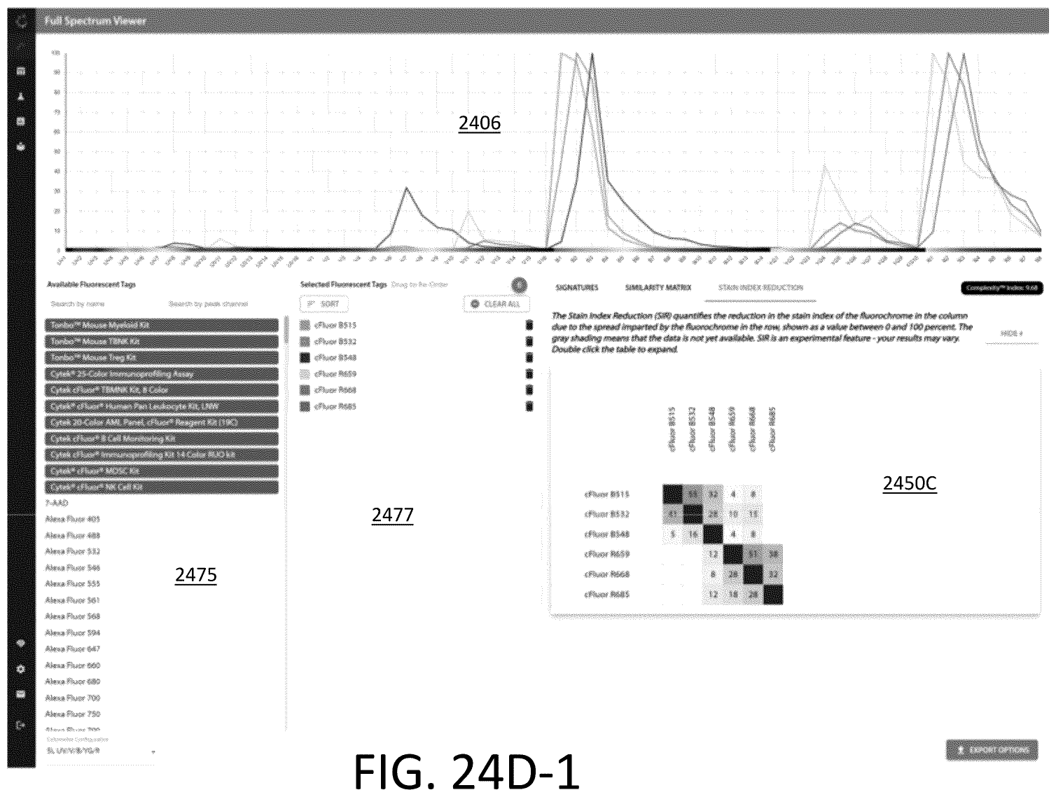

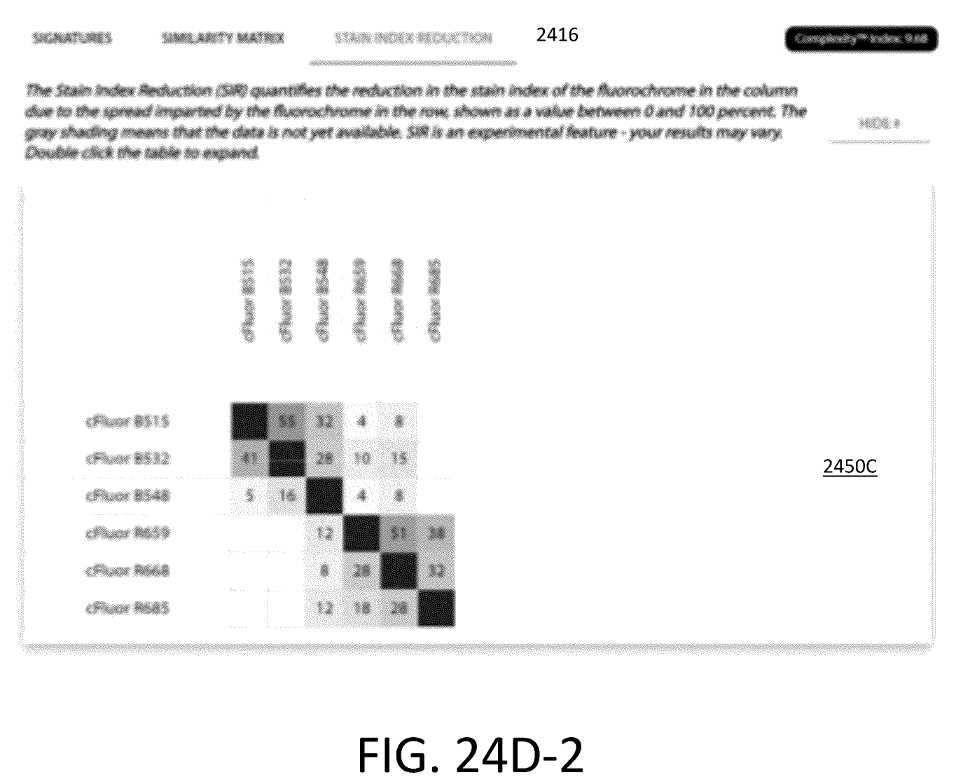

In FIG. 14A (FIGS. 14A-1 and 14A-2), the interactive panel builder graphical user interface window 1200 is displayed on a display device with a newly automated generated panel with an automatic selection of fluorochromes after the run or execute button has been selected by a user. The interactive panel builder graphical user interface window 1200 also includes the series of buttons 1406 in a row that are user selectable one at a time to see a selectable sub window portion 1410 where a panel matrix 1410A is displayed when a panel matrix button is selected, a similarity matrix (see FIG. 24C-2) is displayed when its button is selected, a stain index reduction (SIR) matrix (see FIG. 24D-2) is displayed when its button is selected, or a spillover spreading matrix (SSM) is displayed when its button is selected. The values in the spillover spreading matrix provides a performance measure of the selected configuration of the flow cytometer for the generated multicolor panel. More information about the SSM can be found in Nguyen, Perfetto et al. Quantifying Spillover Spreading for Comparing Instrument Performance and Aiding in Multicolor Panel Design”, Cytometry A., 2013, and in FlowJo v10 documentation at https://docs.flowjo.com/flowjo/experiment-based-platforms/plat-comp-overview/spillover-spreading-matrix, incorporated herein by reference. The values in the similarity matrix and the value of the complexity index score provide a predicted measure of the performance of the multicolor panel for the flow cytometer configuration based on the fluorochromes selected. The SIR matrix quantifies the reduction in stain index of one fluorochrome when plotted against another. This reduction is presented as a percentage between 0 and 100.

In FIG. 14A-2, the interactive panel builder graphical user interface window 1200 is displayed on a display device, a plurality of multicolor panels were generated with a plurality of panel matrices because a user manually select some, but not all, of the fluorescent tags for the markers in a panel matrix. The interactive panel builder graphical user interface window 1200 includes a plurality of buttons (requested panel button, suggested panel button) 1450 that toggle to select one of the plurality of generated multicolor panels to display to a user. In FIG. 14A-2, the suggested panel button is selected and shows a fully automated selection of fluorochromes to markers for the panel matrix of the generated multicolor panel. The requested panel button can be selected to display the requested panel matrix that is generated with some user selected fluorochromes assigned to markers.

In FIG. 14A-1, the requested panel button is selected and showing a requested panel with automated selection limited to an assignment of less than all fluorochromes to all markers. In FIG. 14A-1, a plurality of user selected fluorochromes are selected and assigned to some markers but not all. One fluorochrome at the bottom of the list is automatically selected by the panel builder software and assigned to one marker.

The selectable sub window portion 1410 can also display co-expression when a Show Co-Expression button 1407 is selected. In FIG. 14A-2, the show co-expression button is selected with a marker CD4 being selected in a pull down menu so that those markers that co-express are highlighted by boxes around respective markers. Above the selectable sub window portion 1410 the results of a computation of Complexity Index score is shown for the given selected multicolor panel.

In FIG. 14A-1, the panel matrix button is selected so that a panel matrix 1410A is shown in the selectable sub window portion 1410. In FIG. 14C, the panel matrix 1410A is the multicolor flow cytometer panel that is generated for a user's biological experiment by the software. The panel matrix 1410A charts the markers and associated assigned fluorescent tags for each excitation laser of the flow cytometer. The possible excitation lasers are listed along the X axis at the top of the panel matrix while emission wavelengths of the fluorochrome are listed along the Y axis on the left side of the panel matrix.

Each excitation laser at the top of the panel matrix defines a column and excites the associated fluorescent tags (Fluor) listed in the column. The fluorescent tags (Fluor) listed in the column are placed in a row at the center emission wavelength. In each excitation laser column, a marker is listed adjacent the assigned fluorescent tag. A variable length color bar under each marker illustrates a level of antigen density (low, intermediate, high) assigned to the respective marker. A variable length color bar under each fluorochrome indicates a brightness (peak level of fluorescent light intensity) generated by the fluorochrome (fluorescent tag) when excited by the laser. The variable length color bar of each fluorochrome has a color similar to the color of the laser which excites it. Accordingly, the online multicolor panel with the variable length color bars provides pairing information (inversely matching antigen density to brightness level) to the user between the markers and the fluorochromes. A marker with a high antigen density is usually matched to a fluorochrome with a low brightness level. A marker with a low antigen density is usually matched to a fluorochrome with a high brightness level.

In FIG. 14D-1, if a user interface device such as a mouse selects the variable length color bar under the fluorochrome in the multicolor panel matrix, a pop up window listing other fluorochromes is shown with their respective variable length color bars indicating their brightness levels. A user can select one of these to substitute for the current selected fluorochrome to customize the multicolor panel as desired. The substitute is suggested based on using the same laser for excitement and the same detector. In FIG. 14D-2, if the user uses a user input device such as a mouse to select the marker or the variable length color bar under the marker in the multicolor panel matrix, a pop up window listing other markers is shown with their respective variable length color bars indicating their antigen density level. A user can select one of these to substitute for the current selected marker to further customize the multicolor panel as desired. The substitute is again suggested based on using the same laser for excitement and the same detector channel.

In FIG. 14B-1, the fluorescent tag assignment window portion 1402 illustrates a plurality of fluorescent tags in one column adjacent to a plurality of biological cell markers to which they are assigned in the adjacent column. The column of cell markers is indicated by the heading Markers. The column of fluorescent tags is indicated by the heading Fluorescent Tag. Similar to the panel matrix, a variable length color bar is under each marker and each fluorescent tag. The color of the variable length color bar under each marker is the same color (e.g., blue). The color of the variable length color bar under each fluorescent tag is associated with the color of the excitation laser listed in the panel matrix. The variable length of the variable length color bar under each marker illustrates a level of antigen density associated with the respective marker. The variable length of the variable length color bar under each fluorescent tag indicates a brightness (peak level of fluorescent light intensity) generated by the fluorochrome (fluorescent tag) when excited by a laser.

The user can edit the multicolor panel by using the fluorescent tag assignment window portion 1402 particularly if fluorochromes have yet to be assigned to markers. In FIG. 14B-2, a pair of markers have not been paired with fluorochromes. The user with an input device can select the fluorescent tag input field of a row in order to bring up a pop up window with a plurality of suggested fluorescent tags for the associated marker in that row. The user can move his input device into the list and select one of the suggested fluorescent tags. Thus, the selected markers and selected fluorochromes can be modified in either the fluorescent tag assignment window 1402 or the panel matrix window 1410A. Furthermore, a user can go back to earlier tags and graphical user interface windows to also alter the selected markers and associated antibodies and then review the panel matrix for the online multicolor panel. The system is flexible in that there are many ways for a user to input their user requirements for a multicolor panel and manually edit a generated multicolor panel to customize it as they see fit.

The availability of purchasing chemicals/reagents can be an issue in panel design. Suppliers of the chemicals/reagents can sometimes do business for a short period of time. The panel builder software can provide an indication of current availability of suppliers for some of the suggested chemicals/reagents by the system periodically checking the vendors URL for ordering. In FIG. 14B-2, the pop-up windows includes one or more supplier icons indicated adjacent some of the suggested fluorochromes. The one or more supplier icons provide an indication that the associated fluorochrome is currently available for purchase. Because of the need for fluorochrome assignment, one or more supplier icons to the right of the named fluorochrome can be selected to obtain vendor information regarding the fluorochrome, including an associated URL from where it can be purchased. If there is no supplier icon, it is not clear to the flow cytometer cloud system that there is an available supplier. However, a user may somehow have access to one of the desired fluorochromes regardless. Note that one of the one or more supplier icons can be associated with the manufacturer of the flow cytometer system that is to be used to run the multicolor panel experiment on biological cells.

The fluorescent tag assignment window portion 1402 can act as a legend for the colors of plotted waveforms in the spectral chart view window portion 1404. Referring to FIG. 14B-1, adjacent the name and the beginning of the variable length color bar of each fluorescent tag is a colored square. The color of the colored square is the color of the waveform plotted in the spectral chart view window portion 1404 shown in FIG. 14E. For example, the colored square for the fluorochrome cFluor V547 is lime green in color to match the color plot that peaks in the range of violet detectors V7 to V9 and is excited by the violet laser V405.

In FIG. 14B-1, near the end of the variable length color bar for the fluorochrome is one or more icons. The icon can be a user lock icon in the shape of head resting on shoulders and a lock in an orange color. In which case, a user has locked the pairing and specifically want to use the given fluorochrome with that particular marker. The panel builder software works around the locked pairings made by the user in generating the multicolor panel and the other pairs to selected markers. Alternatively, the icon can be one or more different colored star shapes indicating the given fluorochrome was automatically assigned by the panel builder software to the selected marker. When changes are made, previously generated assignment pairs can be maintained while new pairing assignments are made to generate an updated multicolor panel. A user can also lock the automatically assigned pairings by the panel builder. In which case, both the lock icon and the color stars icon will be shown near the end of the end of the variable length color bar for the fluorochrome. When a user uses a user lock on the pairings, the panel builder software may be handicapped in optimizing the assignments between pairs of markers and fluorochromes. The generated multicolor panel may only be partially optimized when user locks are used. The panel builder software will also generate a fully optimized multicolor panel with no user locks being used. A user can toggle between these two multicolor panels by selecting a partially optimized button to see one generated multicolor panel with user locked pairings in the interactive panel builder graphical user interface window 1200 and selecting a fully optimized button to view another generated color without user locked pairings in the interactive panel builder graphical user interface window 1200. The panel builder runs and generates multicolor panels both ways with and without the user lock restrictions. In a larger multicolor panel, the user lock pairings may be overly restrictive and harm the performance of the multicolor panel if it were used to perform experiments.

In FIG. 14E, the spectral chart view window portion 1404 plots the fluorescent light intensity for each of the plurality of assigned fluorescent tags the over detector channels in the selected configuration of flow cytometer. The fluorescent light intensity is indicated along the Y axis. The detector channels (associated with wavelengths of fluorescent emission) representing light spectrum are indicated along the X axis. FIG. 28F illustrates details of the detectors and detector channels. As mentioned herein, the colored squares in the fluorescent tag assignment window portion 1402, such as shown in FIG. 14B-1, act as a legend for the colors of plotted waveforms.

Generally, in FIG. 14E, there are low levels of fluorescent light intensity plotted in the ultra-violet detector channels in the left side of the plots because the multicolor panel was designed without markers being assigned to the ultra-violet laser. The plots with peaks of fluorescent light intensity over different ranges of detectors should be easy to discriminate with the flow cytometer. For example, fluorochrome cFluor V547 that is plotted in lime green color peaking in the range of violet detectors V7 to V9, should be easy to discriminate from the fluorochrome cFluor VB690 that is plotted in black color peaking in the range of violet detectors V12 to V14 even though there is some spectral overlap as can be seen from the plots at lower intensity levels. However, cFluor V450 that is plotted in a violet color peaking in the range of violet detectors V2 to V4, may be difficult to discriminate from the fluorochrome cFluor V420 that is plotted in a red color peaking in a close range of violet detectors V1 to V3.

As shown in FIGS. 14A1-14A2, the interactive panel builder graphical user interface window 1200 includes a series of buttons (PANEL MATRIX, SIMILARITY MATRIX, STAIN INDEX REDUCTION, SSM, SIGNATURES) 1406 that are user selectable one at a time to see a selectable sub window portion 1410 that can display a panel matrix 1410A, a similarity matrix 1410B, a stain index reduction (SIR) matrix 1410C, a spillover spreading matrix (SSM) 1410D, or spectral signatures 1410K of the fluorochromes. FIG. 14C illustrates an example panel matrix 1410A depicting an online multicolor panel to form a flow cytometry experiment for a flow cytometer configuration.

FIG. 14F illustrates an example of a similarly matrix 1410B. Only half the matrix is shown. The other half is a mirror to the half that is shown. The window includes a toggling button based on context of the window being shown. In the case the triangle matrix is shown, a full matrix button can be selected so that the mirror half is also shown. When the full matrix is shown in the window, a triangle button is shown instead of the full matrix button that can be selected to show the triangle matrix. At the base of the similarity matrix is the value of computed complexity index for the selected fluorochromes.

FIG. 14G illustrates an example of a stain index reduction (SIR) matrix 1410C. Only half of the matrix is shown as a triangle matrix. The other half is a mirror to the half that is shown. The window includes a toggling button based on context of the window being shown. In the case the triangle matrix is shown, a full matrix button can be selected so that the mirror half is also shown. When the full matrix is shown in the window, a triangle button is shown instead of the full matrix button that can be selected to show the triangle matrix.

FIG. 14H illustrates an example of a spillover spreading matrix (SSM) 1410D. The SSM is somewhat similar to the SIR matrix. Because the SSM is a performance matrix of the flow cytometer configuration, it is a full matrix. The values in the matrices are computed using real event data acquired from flow cytometers for the fluorochromes, markers and antibodies that has been collected and stored together in the UADB. If there is a change in a performance requirement, a change in selected marker, or a change in selected fluorochrome, the matrices, the waveform plots, and the panel matrix shown in the graphical user interfaces can all be updated in real time with values calculated in the background using the underlying real data in the UADB.

FIG. 14I illustrate the show co-expression pull down menu being selected by the user and a pop up window 1412 illustrated in the foreground over the interactive panel builder graphical user interface window 1200. The popup window 1412 illustrates a plurality of markers one of which can be chosen by a user to analyze co-expression of the marker using the SSM matrix.

FIG. 14J illustrates the SMM matrix 1410F for a selected marker to show co-expression, such as CD19 for example. The matrices for Similarity and Stain Index Reduction can be similarly computed in real time for the selected marker to show co-expression. Furthermore, the panel matrix 1410A can have the markers in the multicolor panel highlighted that co express with the selected marker to show co-expression. When designing a multicolor panel, it is desirable to keep co-expressed markers away from each other along the emission bandwidth, so they express into different detectors. With the highlighted markers in the panel matrix, a user can readily see marker co-expression and see how to modify the panel to move co-expressed markers away along the emission bandwidth (Y axis) if the co-expressed markers are too close along the emission bandwidth. Thus, the user interface can compute and globally show co-expression between all selected markers in the multicolor panel with the regular SSM matrix or show co-expression of a single marker (using the Show Co-Expression pull down menu) against all others for the single marker that is on an important cell of interest so it can readily be distinguished and detected with little emission overlap.

FIG. 14K illustrates a signatures window 1410K that can be displayed in the selectable sub window portion 1410. A signatures button is shown being selected that illustrates the spectrum signature 1420A-1420N for each of the selected fluorochromes in the generated multicolor panel.

After visualizing the possible spectrum that would be generated by the fluorochromes spectral chart view window portion 1404, and the matrices provided by the interactive panel builder graphical user interface window 1200, a user may select the back button or the next button. If the back button is selected, the Selection of Fluorescent tags can be reconsidered. Assuming the next button is selected the panel builder software moves to the next tab in order, the Review Panel tab.

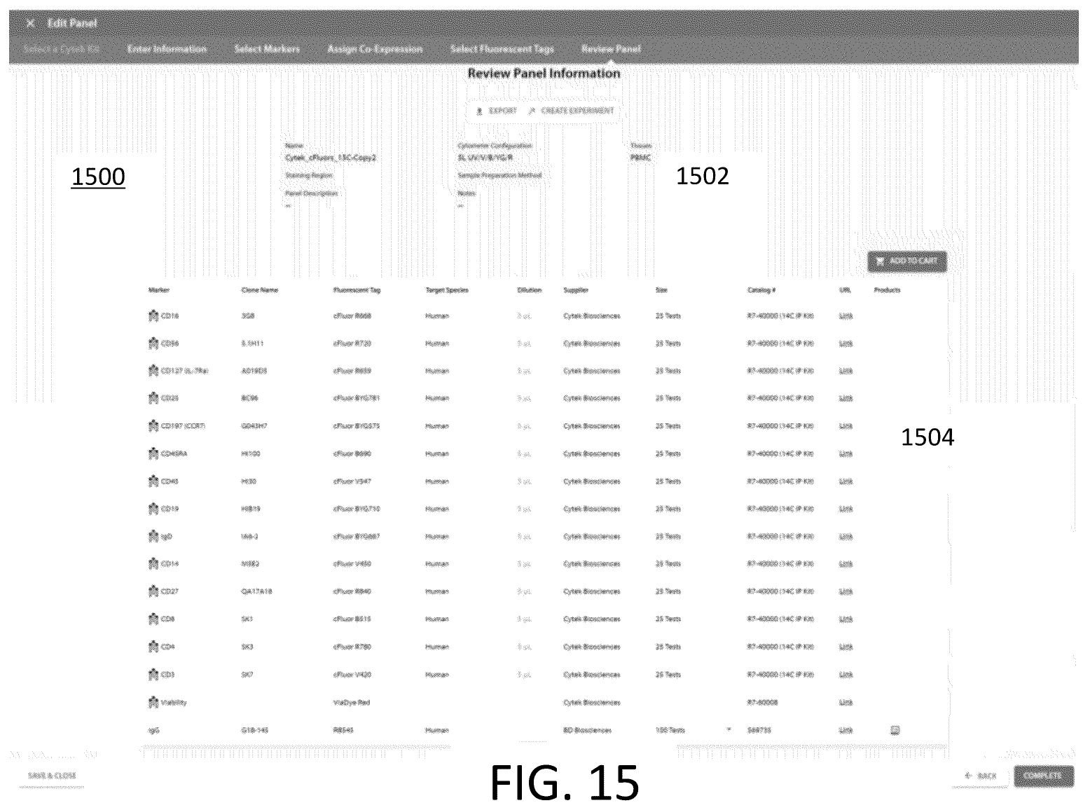

In FIG. 15, the Review Panel tab is shown associated with a review panel information user interface window 1500. The review panel information user interface window 1500 includes a save & close button, a back button, and a complete button towards the bottom of the window. If everything has been done, the complete button can be selected by the user. The save and close buttons saves the work and closes out of the panel builder. The back button takes the user back to the Select Fluorescent Tab and the interactive panel builder graphical user interface window 1200.

The panel information user interface window 1500 further includes an information portion 1502 associated with the information user interface window 800 and a chemical/reagent table 1504 listing rows of the marker, antibody clone, and assigned fluorochrome (fluorescent tag) from the multicolor panel that is generated. Each row can further include the target species of biological cells, the volume of liquid dilution by a buffer, the supplier of vendor of the chemicals in the row, the size or number of tests provided by the bottle/container, a catalog number for the chemicals in the row, and a link designating a uniform resource locator (web address or internet protocol (IP) address) (URL) from which the chemicals in the row can be ordered.

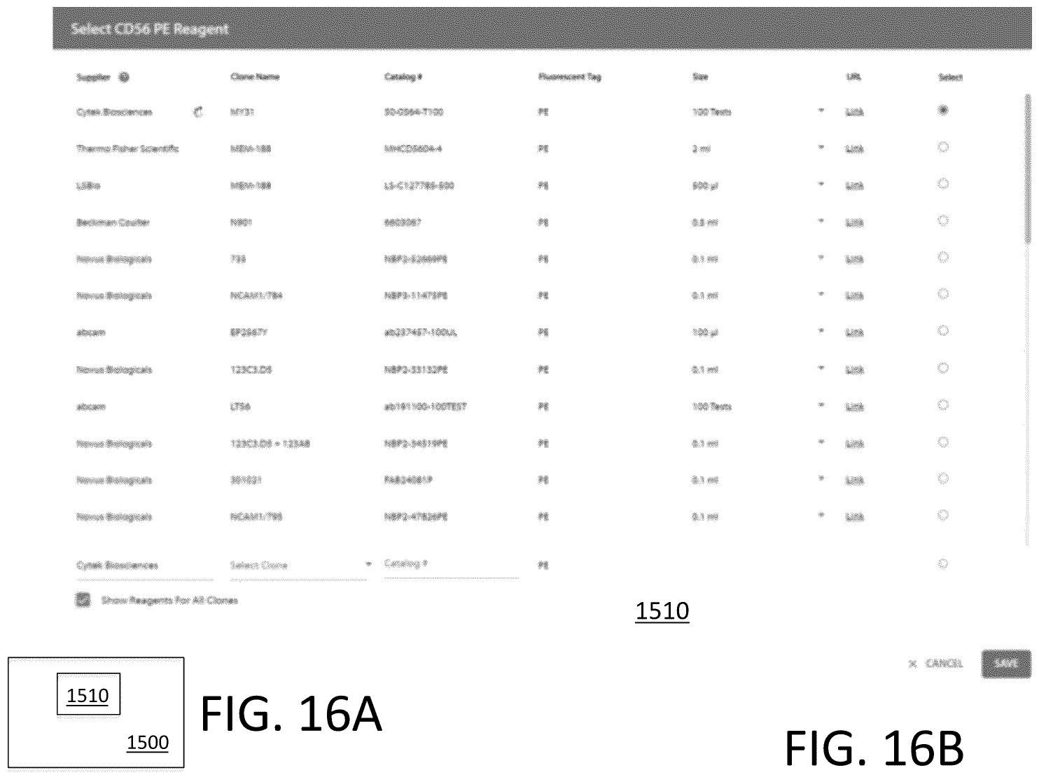

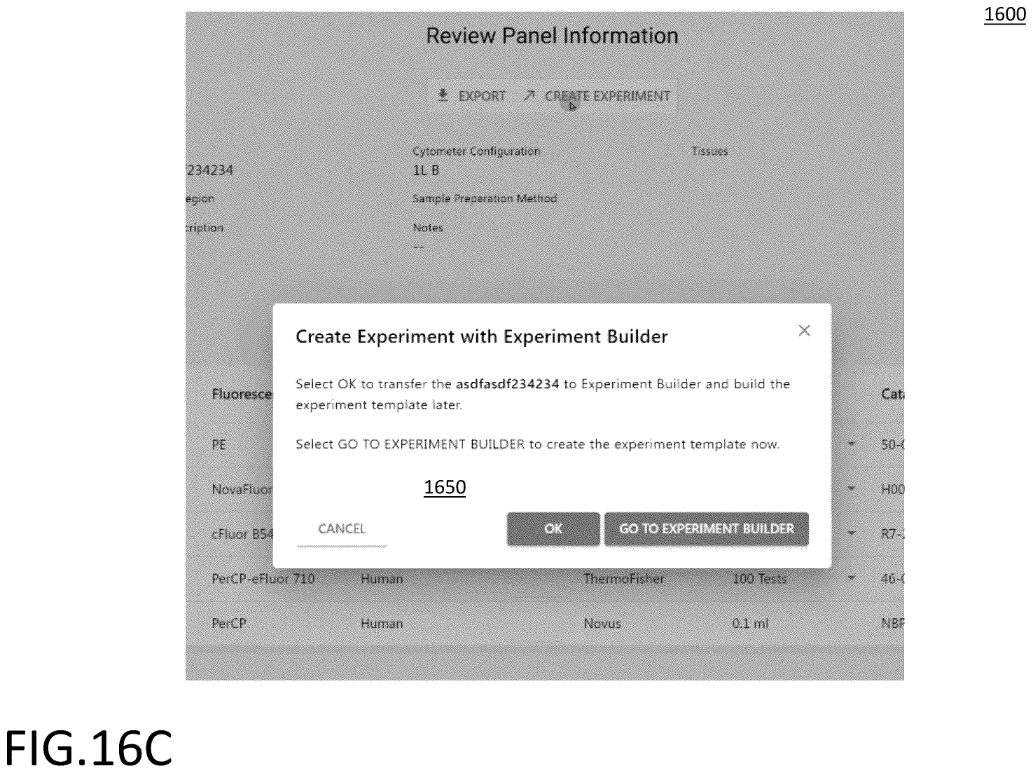

A user can select a marker or a products icon in a row to list available suppliers of the reagent. For example, in FIGS. 16A-16B, a user may select the marker CD56 which brings up a pop up window 1510 into the foreground while the rest of the panel information user interface window 1500 is slightly grayed out in the background. Besides the list of currently available suppliers in a table, the pop up window 1510 includes a cancel button and a save button near the bottom of the window. The top heading of each column in the table is Supplier, Clone Name, Catalog #, Fluorescent Tag, Size, URL, and a select button. Only one row in the table can have the select button filled in to indicate the chosen supplier for the given reagent. A user can readily swap suppliers if that is desired.

Instead of having to look up contact information for the vendors, suppliers or distributors, a user can directly order the needed chemicals/reagents from the one or more URL links in the chemical/reagent table 1504 of the panel information user interface window 1500. The UADB database includes the vendors/suppliers/distributors of the reagents/chemicals and the associated URL links where they can be ordered online. If an antibody clone is conjugated with a fluorochrome, a single URL link can be provided for the same supplier of each in the row. If the antibody clone and the fluorochrome are ordered from two different suppliers, a pair of URL links can be provided for the row. With all the links being provided to the suppliers with periodic updates, it makes it easy for the user to order the chemicals/reagents for carrying out the flow cytometer experiment associated with the generated multicolor panel. The review panel information user interface window 1500 further includes an Add to Cart button to add chemical/reagents to a cart for ordering and payment.

After the generation of the multicolor panel and selection of suppliers/vendors from which to purchase the chemicals/reagents that are needed, a user can transfer a selected one of the plurality of generated multicolor panels to an experiment builder (editor). The currently selected generated panel that is under review is the one that is transferred.

In FIG. 16C, a user can select the Create Experiment button from a review panel information window in order to bring to the foreground a create experiment builder popup window 1650 with a plurality of control buttons. The plurality of control buttons provide options for a user to select. A user can transfer the data regarding the multicolor panel information to the experiment builder software and presently build an experiment template or click an OK button to transfer the data regarding the multicolor panel information to the experiment builder software but wait to build it later. A cancel button is also provided in order to go back to the review panel information window and continue review of the generated multicolor panel. Assuming the go to experiment builder button is selected, the user is transferred from panel builder software to the experiment builder software and its experiment editor to prepare plans for an experiment with the selected flow cytometer and its selected configuration.

### Experiment Builder and Library Editor

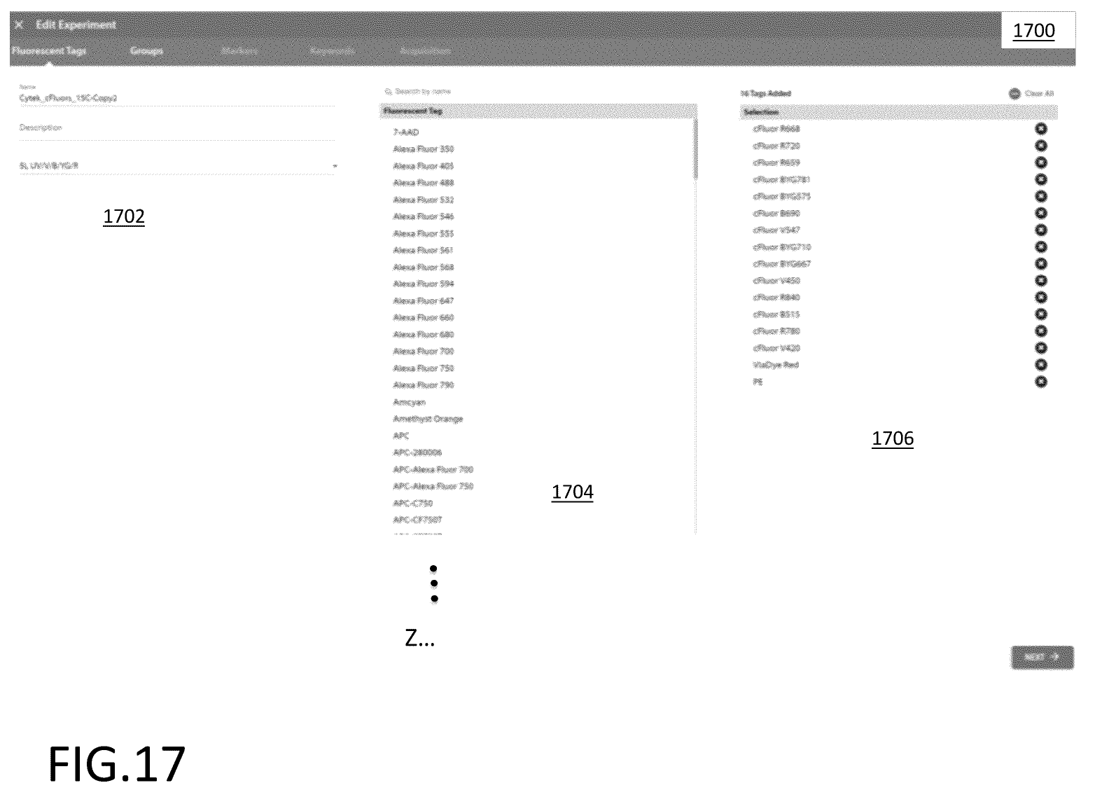

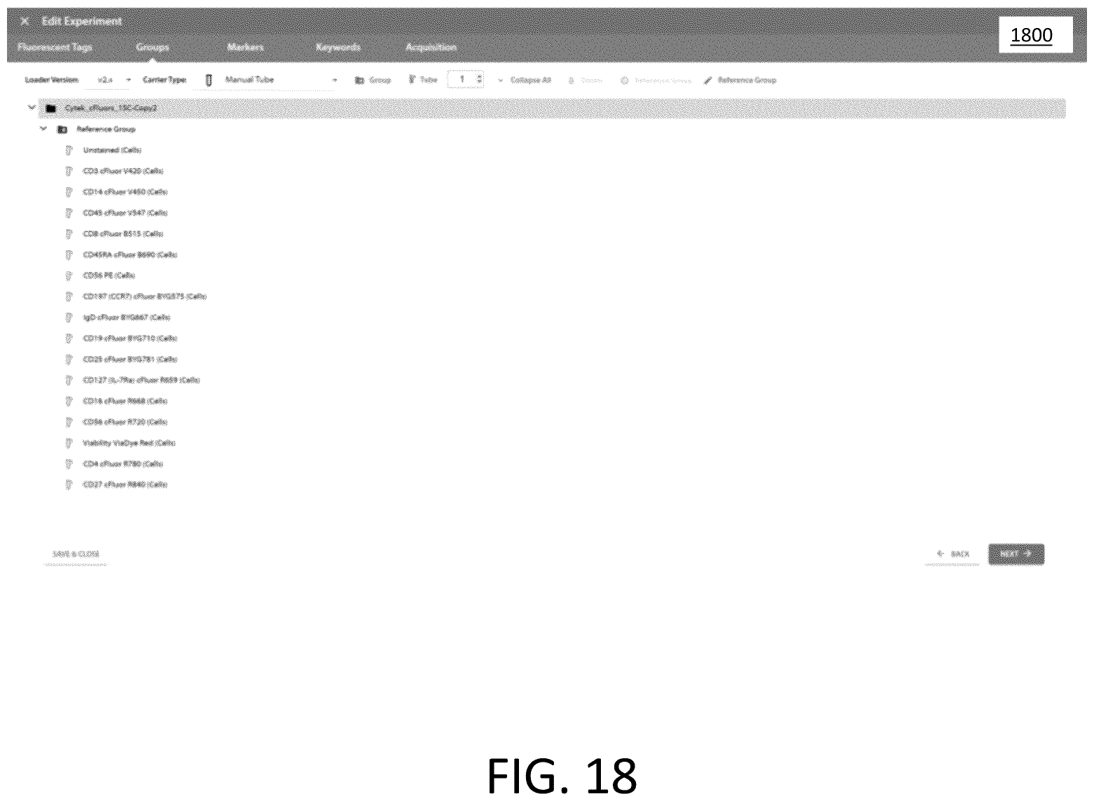

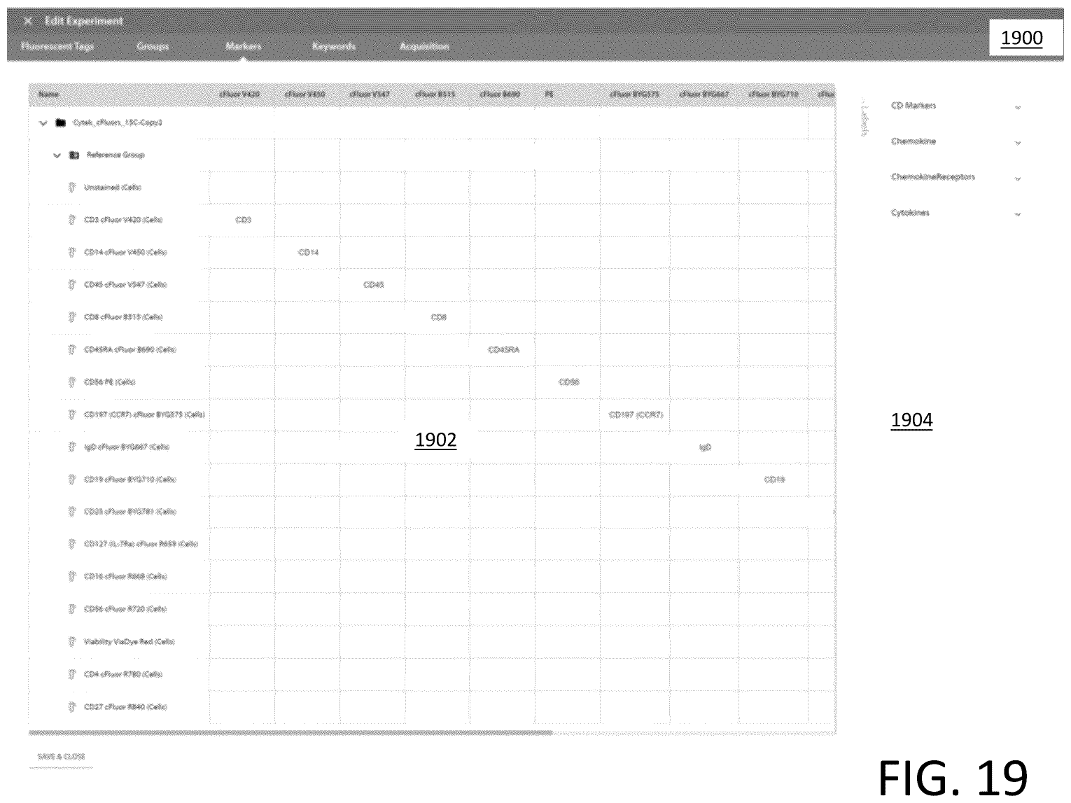

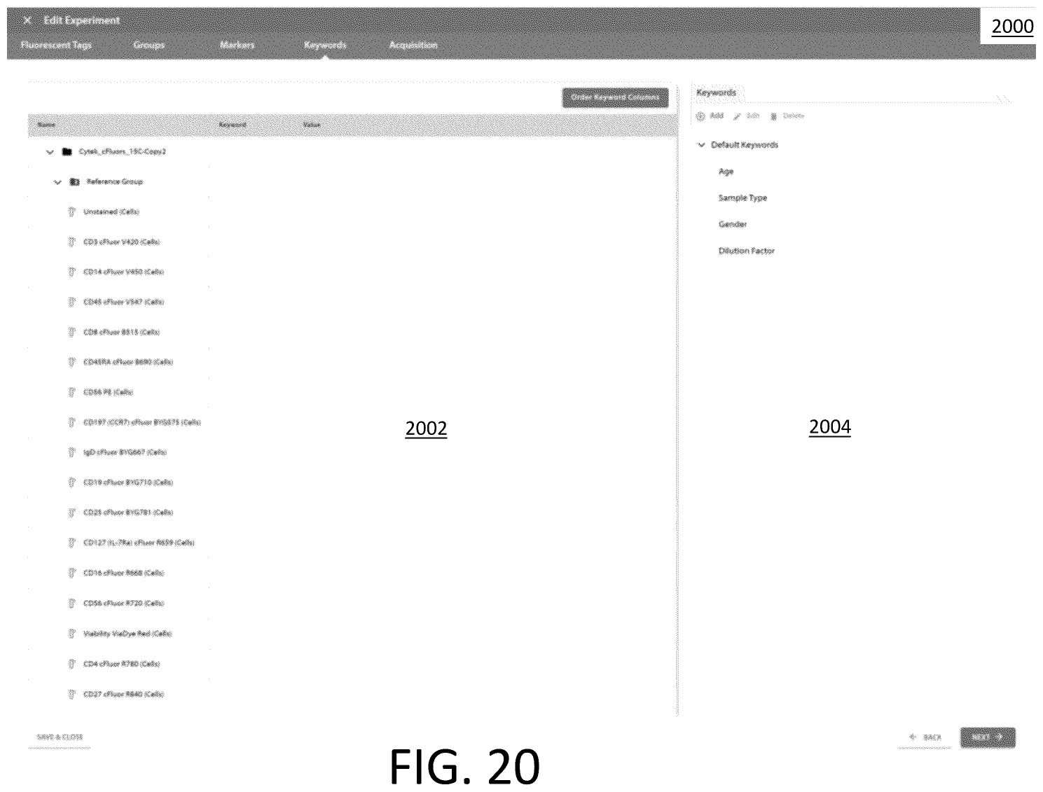

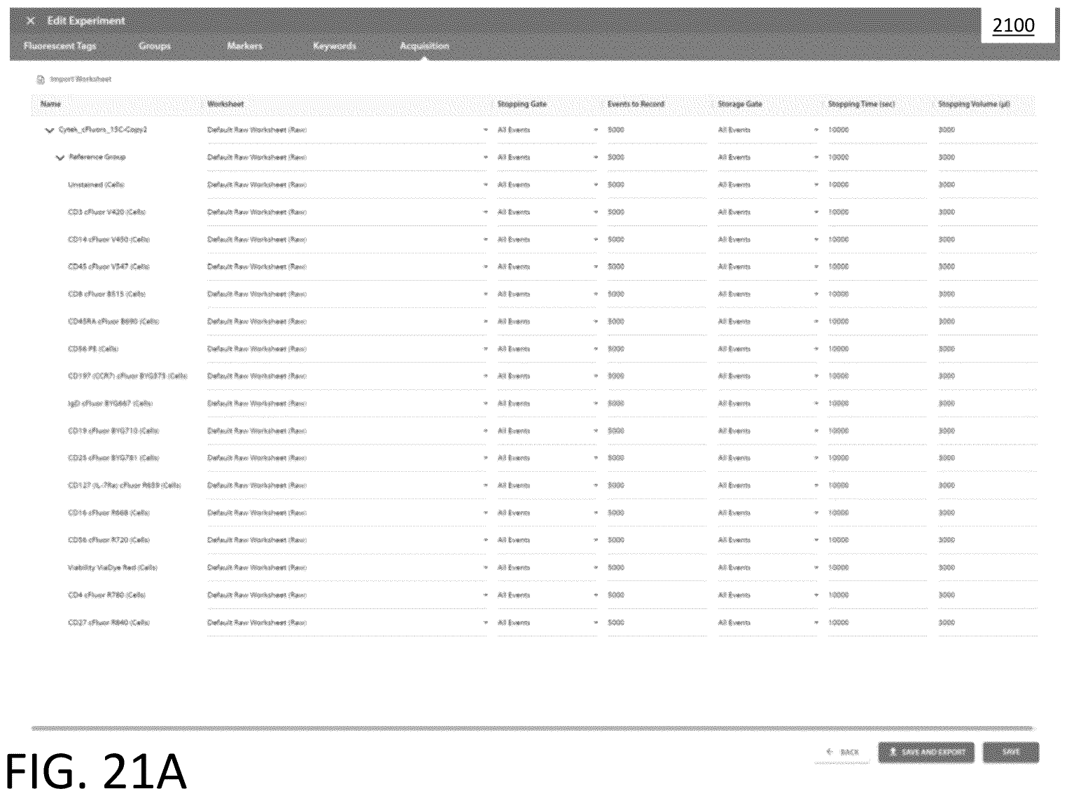

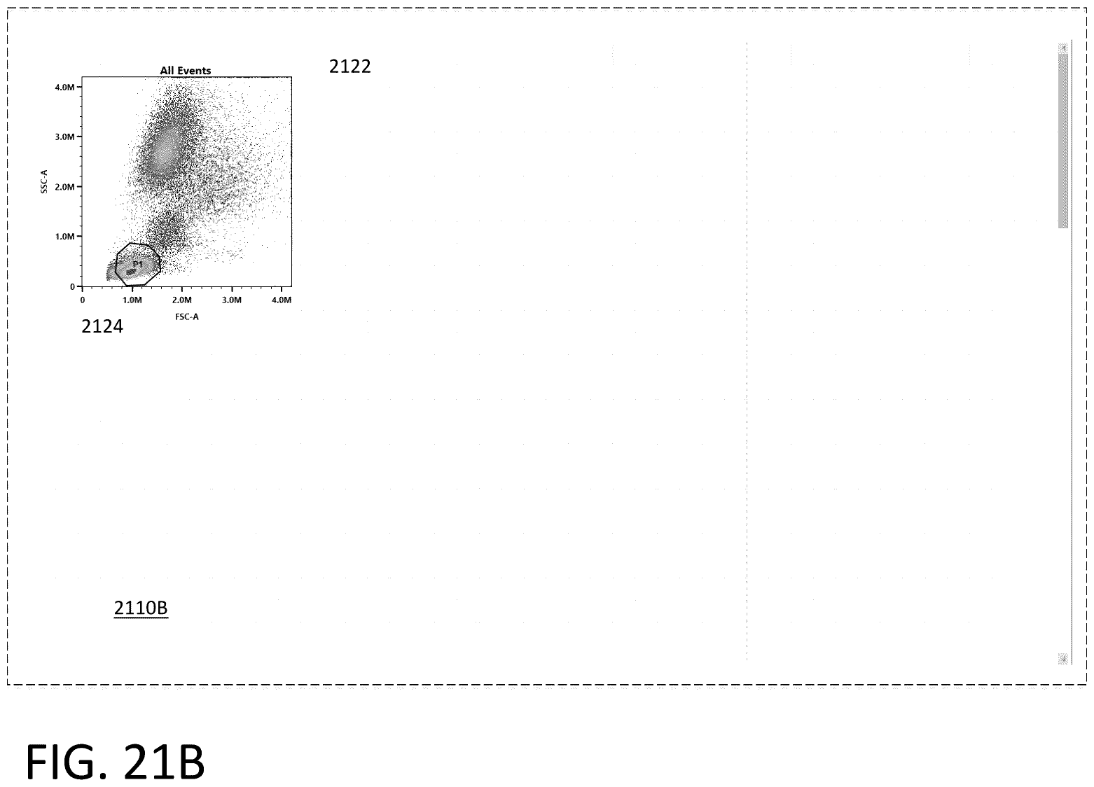

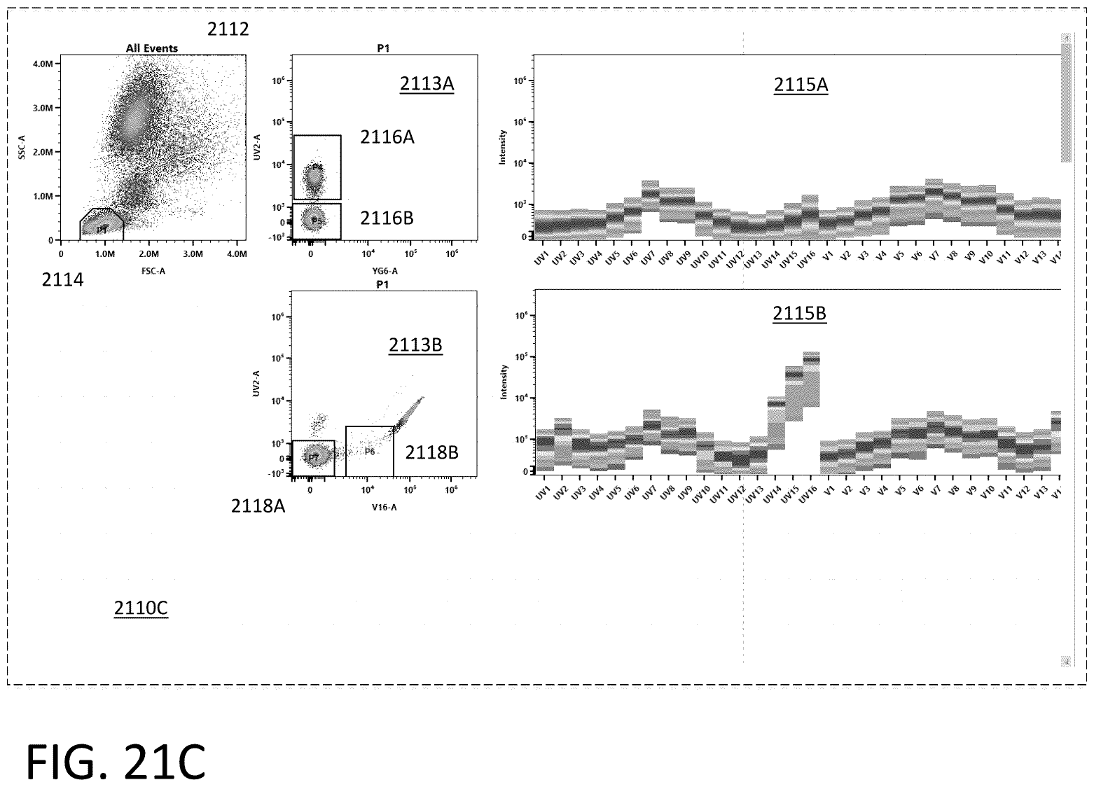

FIGS. 17-21 illustrate various graphical user interface (GUI) windows for the interactive experiment wizard generated by the flow cytometer cloud software for the experiment builder and displayed by the client computer through a web browser. A user account and the experiment editor (builder) software can communicate with the flow cytometer lab equipment through the cloud server if permissions are set appropriately with the associated instrument account. A generated experiment can be exported into the UADB through the cloud server and downloaded into a computer coupled to the lab instrument/equipment to run experiments. The data results (event data in FCS files) from the lab instrument/equipment is saved into the UADB through the cloud server for analysis by a user account. In some embodiments, experiment editor software can communicate with other types of lab equipment, such as a reagent cocktail mixer to prepare the reagents for the flow cytometer experiment. FIG. 17 illustrates a fluorescent assignment window under the fluorescent tag tab for the interactive experiment wizard. FIG. 18 illustrates the GUI window for a group tab of the interactive experiment wizard. FIG. 19 illustrates the GUI window for a markers tab of the interactive experiment wizard. FIG. 20 illustrates the GUI window for a keywords tab of the interactive experiment wizard. FIG. 21A illustrates the GUI window for an acquisitions tab of the interactive experiment wizard. FIGS. 21B-21C illustrate example gating worksheets for an experiment that is to be zipped (compressed) into a single file and saved in the cloud for exporting to a lab instrument such as a flow cytometer.

In FIG. 17, the fluorescent tag (fluorochrome) editor GUI window 1700 includes multicolor panel information 1702, an available fluorescent tags list 1704, and a selected fluorescent tag list 1706. The multicolor panel information 1702 indicates the multicolor panel that is selected to be edited by the experiment editor software. The selected fluorescent tag list 1706 is the current list of fluorochromes in the multicolor panel that is being edited. The available fluorescent tags list 1704 is the fluorochromes in the unified aggregated database that can be used to edit the set of selected fluorescent tags in the fluorescent tag list 1706. Above the available fluorescent tags list 1704 is a search by name field to reduce the list of available fluorescent tags to those of interest. Above the selected fluorescent tag list 1706 is a count (e.g., 16) of the number of fluorescent tags added to the selected fluorescent tag list 1706 and a clear all button that can be selected to do just that with the fluorescent tag in the selected fluorescent tag list 1706. Instead of deleting all selected fluorescent tags, each row listing a fluorescent tag in the selected fluorescent tag list 1706 includes an X icon delete button to selectively delete the fluorescent tags. The GUI window 1700 can include a save & close button, and a next button (not shown in FIG. 17, see FIG. 18) to take the user to the Groups tab.

A flow cytometer may not be available so a user may need to change the configuration for the available flow cytometer. A user may decide after a panel is generated to change fluorochromes out for one that is available for various reasons, such as lower costs or some other user preference.

In FIG. 18, the group GUI window 1800 is shown. The group GUI window 1800 includes a save & close button to save changes and close the multicolor panel, a back button to take the user to back to the Fluorescent Tags tab of the experiment editor, and a next button to take the user to the next tab, the Markers tab of the experiment editor.

The groups GUI window 1800 allows users to create the samples (in either tube or plate layout) which they will be running in their experiment. Under the top level folder is a reference group folder to run each fluorescent dye individually on a cell or particle or bead to obtain the reference full spectrum signature of each. Above the list, there are selectable menu fields for Loader Version (e.g., v2.x), Carrier Type (manual tube, tube rack, or well plate), Sample Tube No. (e.g., 1) to add. A collapse all button is provided to collapse the folders. A delete button is provided to delete tubes or group folders. An add Reference Group button can be provided to add a new Reference Group folder. An Edit Reference Group button is provided to edit a reference group folder.

The reference group button allows for user selection of a reference group. The reference group is for user selection of one or more reference controls. A pop up window is display to the user for user selection of one or more reference controls to form one or more single control sample for one or more fluorescent tags of the generated multi-color panel. In some cases, reference controls for fluorescent tags may have already been run with the flow cytometer. In other cases, they have not. After selection the one or more single control samples are displayed for the selected one or more reference controls.

After the one or more single control samples are displayed for the selected one or more reference controls, one or more biological samples can be added to the list of samples for the experiment. A user selection sample button (e.g., test tube icon) is displayed to add one or more biological samples to run in the experiment that is being generated. Selecting the sample button, one or more biological samples can be added to the list of samples to run within the given experiment with a flow cytometer. In some case, multiple tubes of the same sample with different fluorochromes and reagents is to be run to complete the experiment. A numeric input window is provided to add the number of samples to the list. After the reference control samples and the biological samples are added to the experiment list, a user can select the next button to go to the markers GUI window.

In FIG. 19, an interactive markers GUI window 1900 is shown for the markers tab of the experiment editor. The markers GUI window 1900 is for viewing, assigning, and/or editing the markers associated with the given selected multicolor panel. The markers GUI window 1900 has a matrix sub window 1902 and a labels sub window 1904. The markers GUI window 1900 includes a save & close button to save changes and close the multicolor panel and the associated experiment information, a back button to take the user to back to the Groups tab of the experiment editor, and a next button to take the user to the next tab, the Keywords tab of the experiment editor.

With the information of the generated multicolor panel, the matrix sub window 1902 in the markers GUI window 1900 can be pre-populated with the markers from the panel matrix for the multicolor panel. The matrix sub window 1902 chart the markers between the fluorescent tags (fluorochromes) along the X axis versus the reference control samples along the Y axis. This can assure that all reference controls are accounted for or have been previously run to generate reference control results. If a row is blank, generated. If for some reason, a user does not like a selected marker, the marker can be selected and edited to a different marker. For the biological samples that are listed below the reference group, if a single biological sample is being run with all markers, then for that row the columns would be filled with the respective markers. With more than one biological sample being run, a subset of the total markers can be used in each. If there is no marker in the matrix sub window 1902 indicating a relationship between a fluorescent tag and a sample, it may indicate that a selected fluorescent tag is not being used in that sample. If there are two different markers in the matrix sub window 1902 along the same column, it can indicate that the same fluorescent tag is being used on two different markers in the experiment.

The labels sub window 1904 provides a pre-populated list of markers which the user can use to drag and drop instead of manually typing the marker label in the matrix sub window 1902. After viewing the desired matrix sub window 1902 in the GUI window 1900, a user can select the Next button to go to the next tab and next GUI window (keywords GUI window) of the experiment wizard. If the samples all look correct, a user could optionally skip other windows and export the generated experiment to a flow cytometer for running the experiment. If something is amiss, one or more edits to the assignment of markers to fluorochromes in the interactive marker GUI window can be received to modify the experiment. The alteration of the experiment can also edit the generated multicolor panel to match that of the experiment.

If flow cytometer visualization (gating) worksheets are to be generated later or in the lab adjacent the flow cytometer, the experiment can be exported to a flow cytometer instrument with a default flow cytometer visualization (gating) worksheet. In which case, the exporting process includes generating a zip (compressed data) file of an experiment template and default visualization (gating) worksheets associated with the experiment template, saving the zip file into the UADB of the cloud server; and downloading the zip file into a computer associated with the flow cytometer instrument.

In FIG. 20, a keywords GUI window 2000 is shown for the Keywords tab of the experiment editor. The keywords GUI window 2000 is provided to allow the user to assign keywords (metadata tags and values) to samples. The keywords generally provide additional information about where the sample came from, such as the Patient ID, Drug Treatments, Patient Age, Patient Gender, etc. Additionally, the instrument can collect data related to the keywords.

The keywords GUI window 2000 includes a keywords chart sub window 2002 based on default or selected keywords and a keywords list sub window 2004. The keywords chart window displays the listing of samples for the experiment and a plurality of cells to associate one or more keywords of meta data to one or more samples in the sample list Column headings for the keywords chart 2002 includes a Name heading of names of the sample folders and samples, the keyword associated therewith, and the value for the associated keyword. Accordingly, each sample for each row can include a sample name, a keyword associated thereto, and a value thereof.

The keywords list sub window 2004 includes default keywords and user added keywords over which to search through the information regarding the reagents being used in the samples. The default keywords that are suggested to a user include Age, Sample type, Gender, and Dilution Factor. The keywords in the keywords list window 2004 can be dragged and dropped into a keyword cell under the keyword column heading in the chart 2002. Adjacent the keyword cell is a paired value cell under a value column heading to contain a value associated with the keyword. One or more keywords and one or more associated values can be received in the chart 2002 of the keywords GUI window.

Above the keywords list sub window 2004 is an add icon button, an edit icon button, and a delete button. The add icon button is selected and used to add user keywords to the keywords list in the sub window 2004. The edit icon button is selected after a keyword is selected and highlighted so it can be edited. The delete icon button is selected after a keyword is selected and highlight so it can be deleted. The keywords GUI window 2000 further includes a save & close button to save changes and close the multicolor panel, a back button to take the user to back to the Markers tab of the experiment editor, and a next button to take the user to the next tab, the acquisitions of the experiment editor.

In FIG. 21A, an acquisitions GUI window 2100 is shown for the acquisitions tab of the experiment editor. Generally, the acquisitions GUI window 2100 allows the user to assign the desired parameters which will be used when acquiring event data from the biological samples and reference samples run through the flow cytometer. The acquisitions GUI window 2100 includes a save & export button to save changes and export the saved experiment, a back button to take the user back to the Keywords tab of the experiment editor, and a save button to save the experiment with the multicolor panel and close the work without exporting. The save and export button can export the requisite files of the saved user experiment to use on a flow cytometer to set settings for running experiments on the various samples in the experiment being run. The acquisitions GUI window 2100 further includes an import worksheet button above the listing of experimental plans which can be used in the Worksheet column dropdown.

In each row, the acquisitions GUI window 2100 lists the name of experiment and associated sample, the worksheet for testing (e.g., default raw worksheet), a stopping gate (e.g., all events, or a specified number of events), events to record (e.g., 5000), storage gate (e.g., all events or a specified number of events), a stopping time (e.g., 10000 seconds or other specified number of seconds), and a stopping volume (e.g., 3000 microliters or other specified number of microliters). Large values for each can assure that more data is captured regarding the experiment to run on a given sample.

FIG. 21B illustrates a default raw gating worksheet (default visualization worksheet) 2110B with a dot plot 2122 showing a default stopping gate 2124 over the entire population of all events. The dot plot of all events is plotted with a side scatter (SSC-A) along the Y axis and a forward scatter along the X axis. The default stopping gate 2124 forms a first subpopulation P1 from all the events. The first subpopulation P1 can be further divided up using other gates to further reduce a population of events of interest. If no customization is done, the default raw gating worksheet 2110B is exported as part of the experiment and any further customization is done later by further editing which can be performed remotely or in the lab just before running the experiment with the flow cytometer.

FIG. 21C illustrates a customized gating worksheet 2110C with a dot plot 2112 showing a customized stopping gate 2114 over the entire population of all events. The dot plot of all events is plotted with a side scatter (SSC-A) along the Y axis and a forward scatter along the X axis. The default stopping gate 2114 forms a first subpopulation P1 from all the events. The first subpopulation P1 is further divided up using other gates to further reduce the events to a population of events of interest. The other gates for gating the first subpopulation P1 can be determined by viewing spectral signatures 2115A-2115B of fluorochromes and the detectors where peaks and valleys are found. The spectral signatures plot a log scale of light intensity along the Y axis and detector channel along the X axis. The detector channel indicates its number and typical laser related excitation even though there is likely to be spillover from fluorescence excited by a different laser.

In the dot plot 2113A, the first subpopulation P1 is further divided up using a pair of gates 2116A-2116B. The dot plot 2113A of the first subpopulation P1 is plotted with a logarithmic scale of light intensities captured by detector channel UV2 along the Y axis and a logarithmic scale of light intensities captured by detector channel VG6 along the X axis. The gate 2116A forms a cluster of a subpopulation P4 of events of interest by the flow cytometer. The gate 2116B forms a cluster of a subpopulation P5 of events of interest detected by the flow cytometer.

In the dot plot 2113B, the first subpopulation P1 is further divided up using a pair of gates 2118A-2118B. The dot plot 2113B of the first subpopulation P1 is plotted with a logarithmic scale of light intensities captured by detector channel UV2 along the Y axis and a logarithmic scale of light intensities captured by detector channel VG16 along the X axis. The gate 2118A forms a cluster of a subpopulation P7 of events of interest by the flow cytometer. The gate 2118B forms a cluster of a subpopulation P6 of events of interest detected by the flow cytometer.

A custom gating worksheet 2110C can be generated for each reference sample and each biological sample to be tested in the acquisition list. The reference gating worksheets are likely to be fairly simple to obtain a reference stain control. In FIG. 21A, a default gating worksheet is currently assigned in the worksheet column to each reference sample for subsequent editing.

The default worksheets and the one or more custom gating worksheets with its dot plots and defined gates for gating the various populations of events is saved with the experiment in the UADB and can exported in a zip file for use when setting up a flow cytometer to run an experiment. The exporting process includes generating a zip (compressed data) file of an experiment template and default visualization (gating) worksheets associated with the experiment template, saving the zip file into the UADB of the cloud server; and downloading the zip file into a computer associated with the flow cytometer instrument. The zip file is saved in the UADB for access in the lab by the user with a user account of the computer attached to the flow cytometer. Alternatively, the zip file can be shared with another user in the lab and have the experiment run on the flow cytometer by a third party.

If the one or more flow cytometer visualization (gating) worksheets have generated remotely, the experiment can be exported to a flow cytometer instrument with the one or mor customized flow cytometer visualization (gating) worksheets.

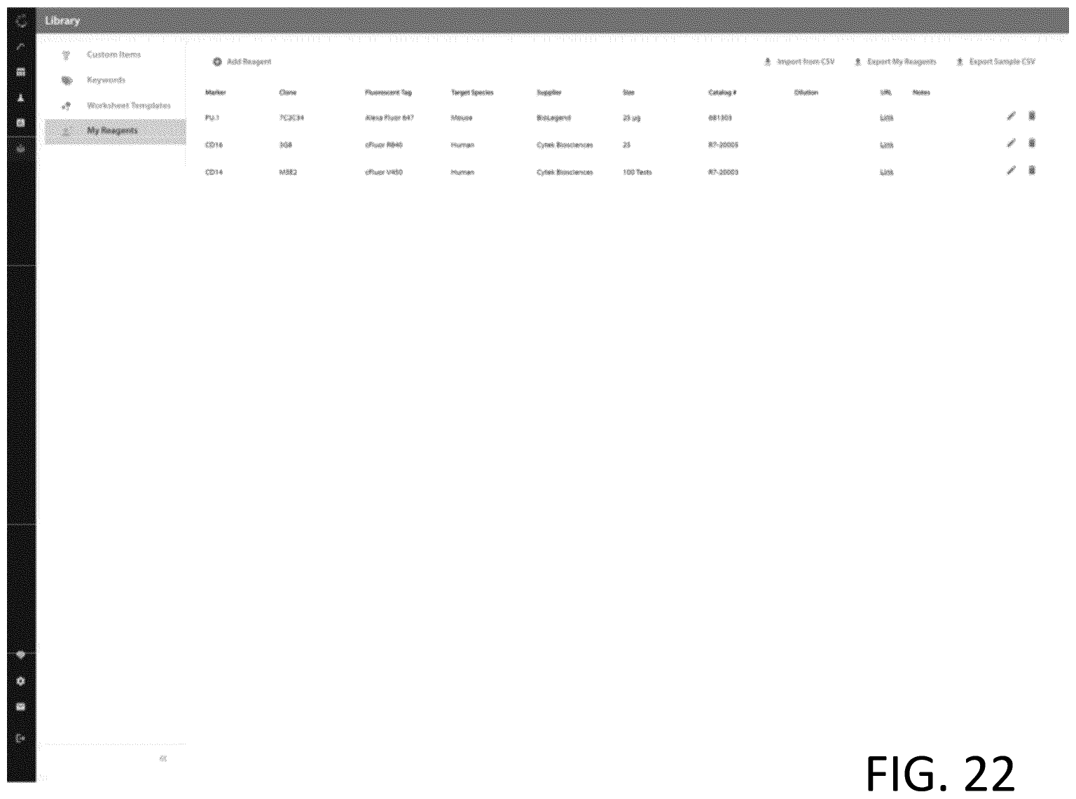

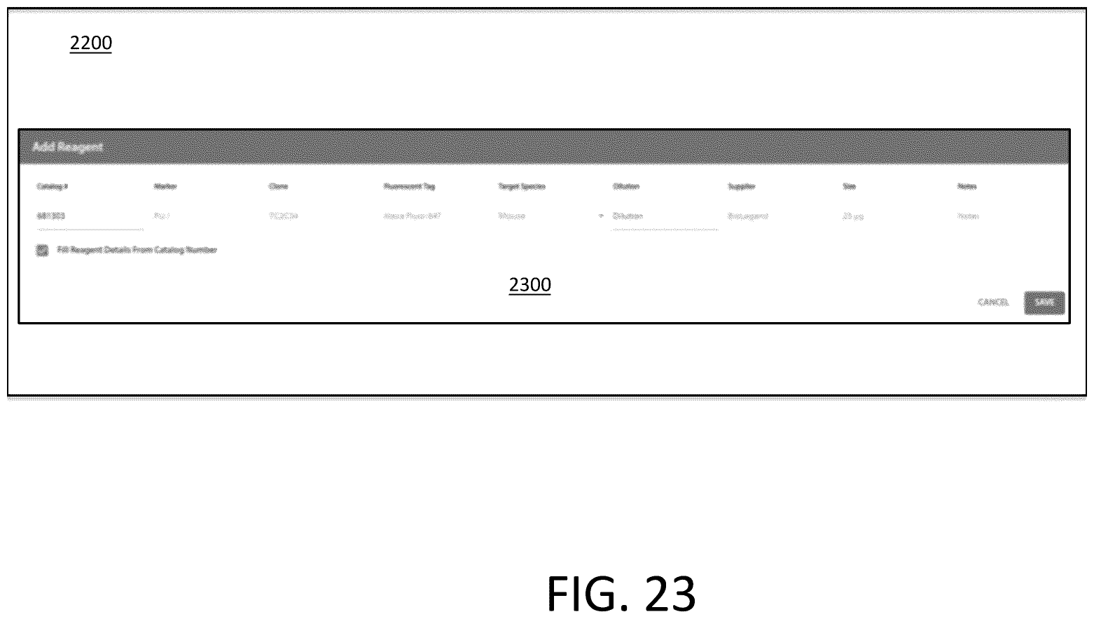

FIGS. 22-23 illustrate views of a library GUI window associated with library editor software. In FIG. 22, the library GUI window has a My Reagents tab selected. A library icon in the left side of the GUI window is selected. Three rows of reagents are listed in the user's library of reagents. Each row includes the marker number/name, the antibody clone name, the fluorescent tag name, the targe species (e.g., human or an animal), the supplier, the size (e.g., liquid volume, weight, number of test), Catalog No., dilution (liquid vol.), URL link from where to order. At the end of each row, an Edit icon button and a trash can icon button are provided to the user to select and edit a reagent row or delete the respective reagent row.

Besides the list of rows of reagents, the library GUI window includes an add reagent button, an import from csv (e.g., Excel spreadsheet) button, an export My Reagents button, and an export sample (e.g., Excel spreadsheet) CSV button. If a user started working using csv format files, they can be imported into the system with the import button. If a user wants to export a multicolor panel or list of reagents, the export buttons are provided. The add reagent button can be selected to add one or more new reagents to the users' library.

In FIG. 23, the add reagents button was selected and an Add Reagent pop up window 2300 is shown to the user in the foreground while the Library GUI window 2200 is in the background. While it was explained how to manually enter a reagent, a reagent can also be read into the user's save library by using a catalog number and searching the database and if not in the database, the system can search internet for the catalog number and download it to save in the user's library of reagents.

In the Add Reagent pop up window 2300, a check box stating “Fill Reagent Details from Catalog Number” is selected. The user inputs the catalog number, such as 681303 to call in the details of the associated reagent (marker, antibody clone, fluorescent tag), if available. The Add Reagent pop up window 2300 includes a cancel button and a save button near the bottom right corner. A user can select the cancel button to stop the adding process of a reagent. If the adding process of the reagent is successful, the user can the select the save button and save the added reagent.

### Spectrum Viewer

FIGS. 24A-24D illustrate various user interface windows generated by the full spectrum viewer software application for displaying a full spectrum view of the fluorochromes selected for a multicolor panel. The full spectrum viewer provides a series of tools which allow a user to review performance information (e.g., similarity matrix, stain index reduction matrix, signatures) and other calculations (complexity index) for individual fluorochromes and combinations thereof, which may be used in a multicolor panel.

The design of a flow cytometer can bring flexibility in selecting fluorochromes for labeling biological cells and particles. Full spectrum cytometry has the advantage of detecting the full spectrum signature for each fluorochrome with a full spectrum flow cytometer with at least five lasers and at least 64 detectors. Almost any commercially available fluorochrome can be excited by the lasers of a full spectrum flow cytometer.

With so many options, it is useful to provide a web-based user interface displayable on a monitor or display device to more quickly and more easily choose fluorochromes for use in experiments on biological samples with a full spectrum flow cytometer. A computer or other electronic device, including a processor and input/output devices, is coupled to the internet and the monitor or display device in order to generate and display the web-based user interface. The web-based user interface is generated by a spectrum viewer web-based software tool. The software tool can be executed on a client computer device locally with access to a remote database or remotely on a server computer in communication with the remote database.

With the full spectrum viewer web-based software tool, users can choose from commercially available fluorochromes that have been previously tested on different configurations (e.g., three or more lasers and 48 or more detectors) of a full spectrum flow cytometer.

The full spectrum viewer web-based software tool helps users figure out which fluorochromes could be used together on the various configurations of the full spectrum flow cytometer. The software tool can display full spectrum information for over 80 fluorochromes acquired using an assay setting across all of the configurations for the full spectrum flow cytometer.

The full spectrum viewer web-based software tool can use also display the similarity index and the complexity index to further assist a user in selecting fluorochromes than can be used together with the full spectrum flow cytometer in its various configurations.

FIG. 24A (FIGS. 24A-1 through 24A-4) illustrates the full spectrum view graphical user interface (GUI) window 2400 of the full spectrum viewer software application that can be displayed on the monitor or display device by a computer system that is in communication with the flow cytometer cloud server. There are a number of buttons and pull down menus that the full spectrum viewer GUI provides. In the lower right corner is an export options button.

Referring now to FIG. 24A-5, when the export options button 2480 is selected or hovered over by a user input device, such as a mouse, the user interface provides a pop up window 2482. The pop up window 2482 over the GUI window 2400 includes an export button and a Send to Experiment Builder button, each of which can be selected by the user with an input device, such as a mouse. When a user is satisfied with their multicolor panel, it can be exported into a CSV (spreadsheet) format using the export button or transferred to the Experiment Builder software tool of the flow cytometer cloud software. The data and information from the user's multicolor panel generated or edited with the Panel Builder software can be auto populated into the Experiment Builder software tool. The fluorochromes, markers, and reagents of the multicolor panel need not be reentered into another software tool. The software applications of the flow cytometer cloud software can communicate with each other. The multicolor panel information is interchanged between the software applications of the flow cytometer cloud software, so it need not be re-entered.

The full spectrum view graphical user interface (GUI) window 2400 includes a graph window 2406 that plots a normalized excitation/emission 2407 along a Y axis and an emission channel (emission wavelength) 2408 along the X axis. In the graph window 2406, a grid can be displayed to relate the axis to points on the plots of the selected fluorochromes. The normalized excitation/emission 2407 ranges from zero to 100 percent. The emission channels related to the expected wavelengths of light that the fluorochromes fluoresce. From left to right, the emission channels 2407 can include ultra violet channels UV1-UV16; violet channels V1-V16; blue channels B1-B14; yellow-green channels YG1-YG10; and red channels R1-R8. With fewer lasers and fewer detectors, the number of detector channels can decrease. With more lasers and more detectors, the number of detector channels can increase.

The GUI window 2400 further includes an available fluorescent tag (fluorochrome) list window 2475 that indicates all the fluorescent tags that are available in the UADB that can be used. Above the window 2475 are two search fields, search by name and search by peak channel, to find a fluorescent tag. An available fluorescent tag can be selected by double clicking on it in the list within the window 2475. This action adds it into the selected fluorescent tag window 2477 shown in FIG. 24A-4. The GUI window 2400 displays fluorochromes that are available for selection previously tested with the flow cytometer configuration. The fluorochromes may be browsed by way of a slider and displayed in a fluorochrome viewer window 2475. The fluorochromes may be searched by name using the search by name field 2473 or searched by peak channel using the search by peak channel input field 2474. The fluorochromes can be selected by double clicking through an input device (e.g., mouse clicks) the desired fluorochrome name in the window 2475. Once selected, a spectral graph for each fluorochrome/tag is drawn (plotted) in the chart window 2406 shown in FIG. 24B-1.

At the base of the window 2475 in the GUI window 2400, the cytometer configuration 2463 can be selected by a pull down menu to define the number of lasers and their respective colors. The flow cytometer configuration 2462 designates the number of excitation lasers and the number of detectors that the flow cytometer is configured with. This can be selected before or after the fluorochromes are selected. However, if one drops down to a lesser configuration, some fluorochromes may not be used and drop out, such as if a laser is dropped.

The GUI window 2400 further includes a selected fluorescent tag (fluorochrome) window 2477 that are selected for use in a multicolor panel experiment with a flow cytometer. The names of the fluorochromes selected are added into the selected fluorescent tag window 2477. A count of the number of current selected number of selected fluorochromes in the selection window 2477 can be provided for the panel. A user can select a selected fluorochrome in the selection window 2477 and delete it from the set. Alternatively, if a user wants to start completely over, a clear all button is provided by the GUI window 2400 for the selection window 2477. A sort button is provided for the selection window 2477 in order to sort the selected fluorescent tags by name or by Excitation and Emission order.

After selecting a set of fluorochromes for a multicolor panel, a sample run with a biological sample can be simulated by the graph window 2406. The GUI can export the graph and the choice of fluorochromes through the export options button. The similarity matrix and complexity value computation for the given set of selected fluorescent tags can also be printed out or exported into a PDF format through the export options button.

The GUI window 2400 further includes a sub window 2450 to display different information regarding the multicolor panel and the selected fluorescent tags (fluorochromes). One of a series of three buttons 2416 can be selected by the user to display different information in the sub window 2450.

FIGS. 24B-24D illustrate the full spectrum viewer user interface window 2400 and sub window portion 2450 that is responsive to the series of three buttons 2416. FIG. 24B-2, with the signatures button selected, illustrates the full spectrum viewer user interface window 2400 showing a plurality of spectral signatures of the selected fluorochromes 2450A in the variable sub window portion 2450. A scroll bar allows the signatures to be scrolled in the sub window to see them all. Spectral signatures are further explained herein with reference to FIGS. 28G-1, 28G-2, 30A and 30B. FIG. 24C-2, with the similarity index button selected, illustrates the full spectrum viewer user interface window 2400 with a similarity matrix 2450B displayed in the variable sub window portion 2450. The similarly matrix and complexity index are explained in more detail in U.S. Non-Provisional patent application Ser. No. 17/304,843 titled METHODS OF FORMING MULTI-COLOR FLUORESCENCE-BASED FLOW CYTOMETRY PANEL filed on Jun. 26, 2021, by inventors Maria Jaimes et al., incorporated herein by reference.

FIG. 24D-2, with the stain index reduction button selected, illustrates the full spectrum viewer user interface window 2400 with a stain index reduction matrix 2450C displayed in the variable sub window portion 2450. The stain index reduction matrix 2450C plots each selected fluorescent tag (fluorochrome) against each other in the Y and X axes. Generally, the values in the stain index reduction matrix 2450C show the amount of interaction between pairs of fluorochromes that are selected. More specifically, the values shown in the stain index reduction matrix 2450C quantifies the reduction in stain index of the fluorochrome in the column due to the spread imparted by the fluorochrome in the row. The values are between 0 and 100 percent. For example, the stain index reduction for cFluor B532 due to cFluorB515 has a value of 55 percent. This means cFluor B532 undergoes a 55 percent reduction in stain index when paired with cFluor B515 on the same biological cell. It would be better if these two fluorochromes were on attached different cells and likely different markers. The diagonal is not computed because there is no effective reduction when paired with the same fluorochrome.

Stain Index Reduction is calculated by computing the stain index for a given fluorochrome, resolution between the positive and negative, and computing the cross-stain index for that fluorochrome vs every other fluorochrome in the multicolor panel, resolution between the positive of fluorochrome and fluorochrome 2. The ratio between these two stain indices represent the Stain Index Reduction. More information can be found here: https://welcome.cytekbio.com/hubfs/Website%20Downloadable%20Content/White%20Papers/N9_20004_Rev_A_IL_Blue_Evaluate_Panel_Performance.pdf

There are a number of advantages to the flow cytometer cloud software and system. The user interfaces are updated in real time when changes are made. The panel builder uses a tabs to act as a wizard to walk a user into interactively entering selections and requirements for the desired multicolor panel. After marker selection and antibody pairing, the panel builder software can automatically select fluorochromes to generate a multicolor panel that is optimized to the user selections and performance requirements. After a multicolor panel has been generated, a user can easily edit the generated multicolor panel on the fly, see the results after the user edits in real time in order to further customize it to the user's liking. User customization can be locked. After the multicolor panel is generated, a user can easily purchase chemicals/reagents from suppliers by using the URL links. With the server periodically downloading data and information over the internet using the URLs, the availability of the supplier and chemicals/reagents is periodically confirmed with information being updated as needed.

### Web Based Flow Cytometer Data Analysis Software

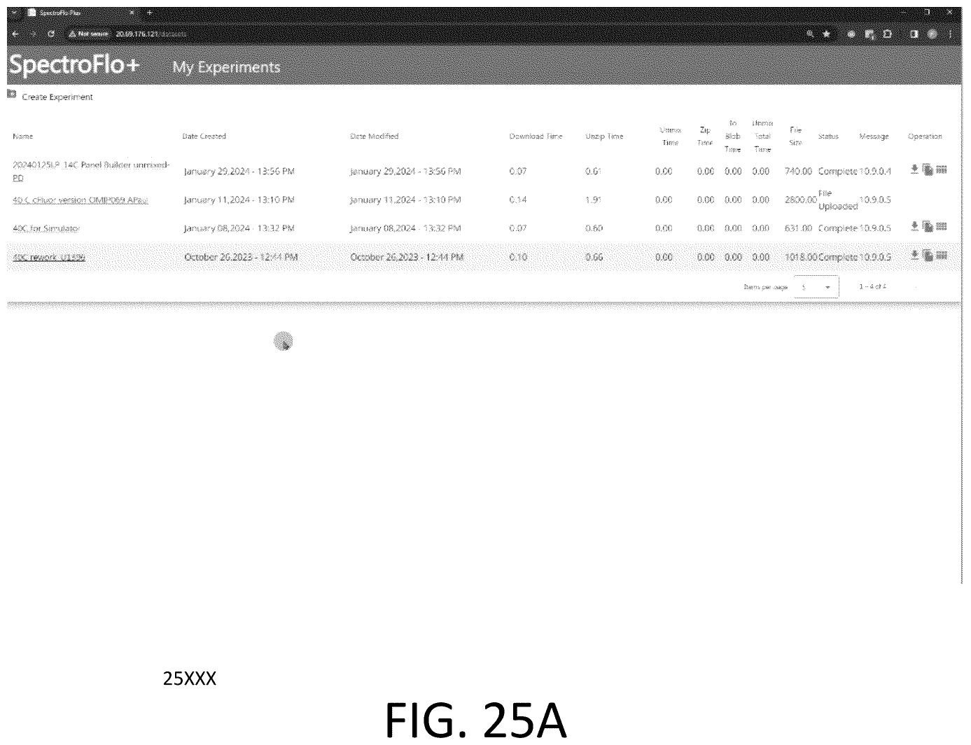

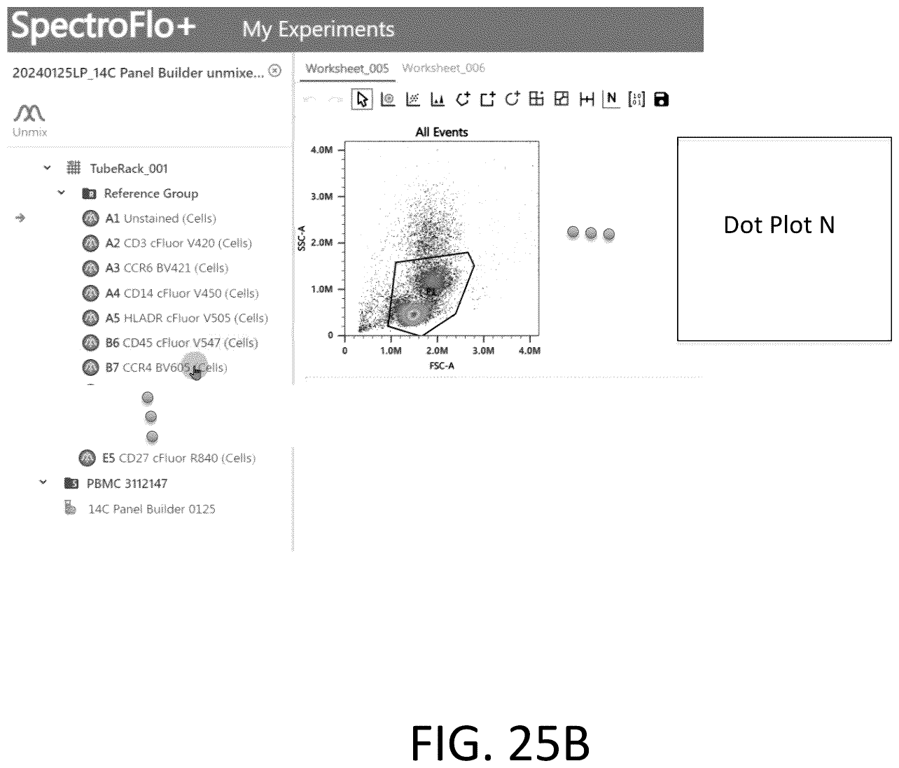

FIGS. 25A-25B illustrate graphical user interface (GUI) windows generated by a web based flow cytometer data analysis software application displayed on a monitor of a computer system. The web based flow cytometer data analysis software application is the data analysis software of the flow cytometer cloud server. Generally, the web based flow cytometer data analysis software application receives the saved digital event data (FCS) from a flow cytometer and generates a plurality of dot plots for a user to analyze the results of running biological cells through a flow cytometer using the experiment associated with the generated multicolor panel. Populations of interested can be gated and further analyzed.

With the flow cytometer cloud server and software in communication with the flow cytometers, the events captured by a flow cytometer after running the experiment associated with the multicolor panel can be automatically transmitted to the flow cytometer cloud server and uploaded into the UADB. A user can start up the web based flow cytometer data analysis software application and select the file that holds the stored event data in the UADB in order to read in (recall) the stored event data and start analyzing the results. Data analysis tools to analyze event data are well known to those of ordinary skill in the art. Results of the data analysis can be displayed on a display device such as in one or more dot plots with gates being used to further analyze the various populations of biological cells that may be found in biological samples. How data analysis results are used to generate dot plots from event data is also well known to those of skill in the art.

### Flow Cytometer

Full spectrum flow cytometry is a technology that enables the development of such highly multiparametric panels. A full spectrum flow cytometer measures the entire fluorescent emission of an excited fluorochrome (fluorescent tag), from ultra-violet to near infra-red, across multiple lasers using many more detectors compared to a conventional flow cytometer. It produces very specific spectral fingerprints that are used to mathematically distinguish one fluorophore from another, even when their maximum emissions (the primary component measured by a conventional flow cytometer) are very similar. Leveraging this full spectrum technology, the ability to combine 30 or more fluorescently labeled antibodies becomes possible using a fluorescence-based flow cytometer.

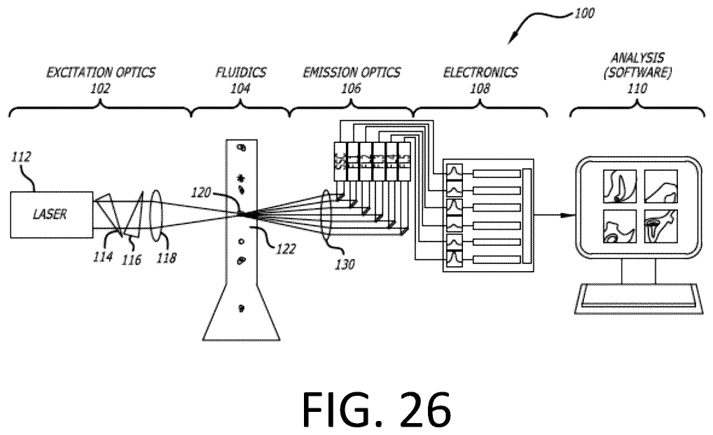

Referring now to FIG. 26, a basic conceptual diagram of a flow cytometer system 2600 is shown. Various embodiments of the flow cytometer 2600 may be commercially available. Five major subsystems of the flow cytometer system 2600 include an excitation optics system 2602, a fluidics system 2604, an emission optics system 2606, an acquisition system 2608, and an analysis system 2610. Generally, a “system” includes hardware devices, software devices, or a combination thereof.

The excitation optics system 2602 includes, for example, a laser device 2612, an optical element 2614, an optical element 2616, and an optical element, 2618. Example optical elements include an optical prism and an optical lens. The excitation optics system 2602 illuminates an optical interrogation region 2620. The fluidics system 2604 carries fluid samples 2622 through the optical interrogation region 2620. The emission optics system 2606 includes, for example, an optical element 2630 and optical detectors SSC, FL1, FL2, FL3, FL4, and FL5. The emission optics system 2606 gathers photons emitted or scattered from passing particles. The emission optics system 2606 focuses these photons onto the optical detectors SSC, FL1, FL2, FL3, FL4, and FL5. Optical detector SSC is a side scatter channel. Optical detectors FL1, FL2, FL3, FL4, and FL5 are fluorescent detectors may include band-pass, or long-pass, filters to detect a particular fluorescence wavelength. Each optical detector converts photons into electrical pulses and sends the electrical pulses to the acquisition system 2608. The acquisition system 2608 processes and prepares these signals for analysis in the analysis system 2610.

The analysis system 2610 can store digital representations of the signals for analysis after completion of acquisition. The analysis system 2610 is a computer with a processor, memory, and one or more storage devices that can store and execute analysis software to obtain laboratory results of biological samples (or other types of samples, e.g., chemical) that are analyzed. The analysis system 2610 can be further used to calibrate the flow cytometer with compensation controls when initialized, before running a reference sample through the flow cytometer. Reference samples can be formed in different ways to determine spillover vectors for a fluorescent dye or fluorochrome. A fluorochrome can be conjugated with an antibody and then attached to a biological cell or attached to a bead or particle.

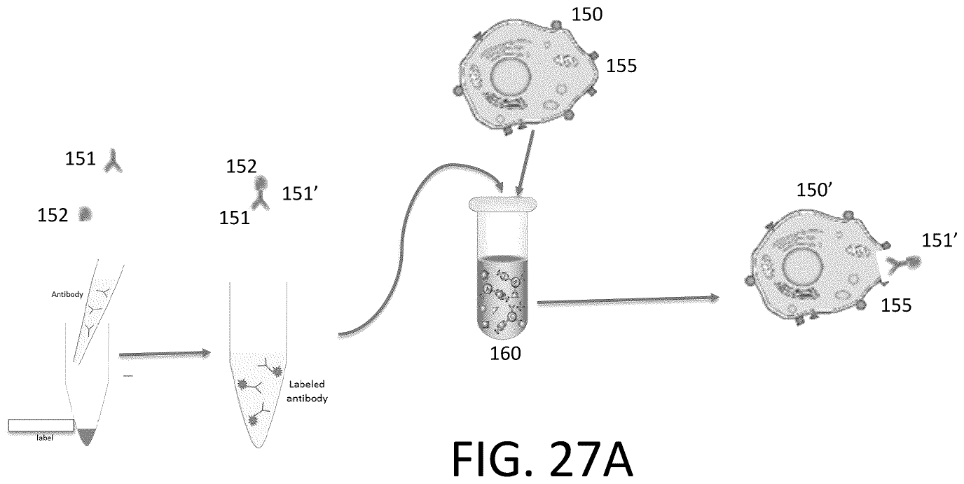

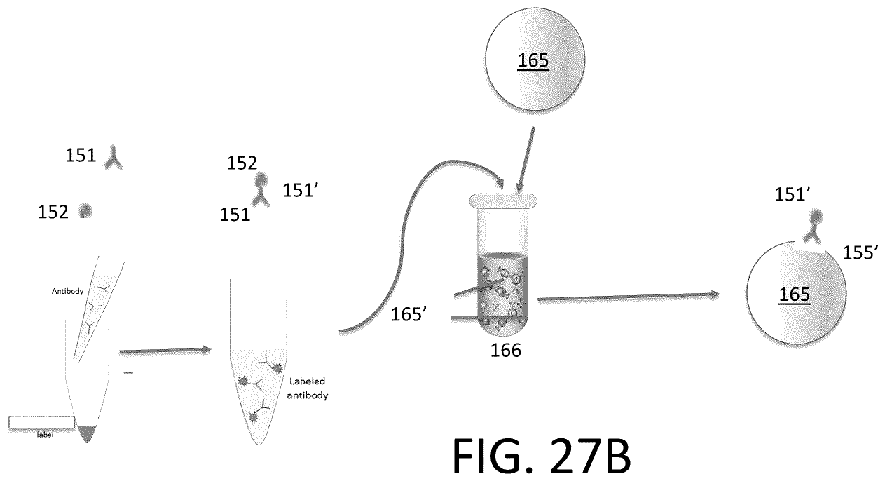

Referring now to FIG. 27A, a cell 2750, an antibody 2751, and a fluorochrome (dyc) 2752 are coupled together to form a reference sample with direct marking or staining of a cell. The cell 2750 has one or more cell marker 2755 sites to which an antibody can attach. The fluorochrome (dye) 2752 is conjugated with the antibody 2751 in advance to form a conjugated antibody 2751′. For a reference sample, a single fluorochrome (dye) 2752 is conjugated with a single antibody to generate a spillover vector. Subsequently, when analyzing a biological fluid with different unknown counts of cells in the biological fluid, multiple conjugated antibodies with different antibodies and different fluorochrome, can be used and add into the same biological sample.

The conjugated antibodies 2751′ and the cells 2750 are mixed together in a test tube 2760 so the conjugated antibodies 2751′ can attached to the desired cell marker sites 2755 for the given type of cells 2750 to form marked or stained cells 2750′ in the sample biological fluid. When run through the flow cytometer, the fluorochromes can be excited by laser light to fluoresce so that the fluorescence can be detected by detectors as events generating an event vector. The event vector can be used to generate a spill over matrix for the fluorochrome. When running a sample biological fluid with unknown counts, the cells counted by a flow cytometer by analyzing the events.

Referring now to FIG. 27B, a conceptual diagram of forming a reference sample with a bead 2765 is shown. A bead 2765, an antibody 2751, and a fluorochrome (dye) 2752 are coupled together to form a reference sample with a bead. The bead 2765 may have one or more cell marker 2755′ sites to which an antibody can attach. As with the cell, the fluorochrome (dye) 2752 is conjugated with the antibody 2751 in advance to form a conjugated antibody 2751′. For a reference sample, a single fluorochrome (dye) 2752 is conjugated with a single antibody to generate a spillover vector.

The conjugated antibodies 2751′ and the beads 2765 are mixed together in a test tube 2766 so the conjugated antibodies 2751′ can attached to the desired marker sites 2755′ for the beads 165 to form marked beads 2765′ in a reference sample. When run through the flow cytometer, the fluorochromes can be excited by laser light to fluoresce so that the fluorescence can be detected by detectors as events generating an event vector. The event vector can be used to generate a spill over matrix for the fluorochrome. In this manner, either cells or beads can be used to test and fluorochrome for suitability to be used with a flow cytometer.

### Reference Sample Run

Referring now to FIG. 28A, a flowchart of a method 2800 for a flow cytometer is shown. The flow cytometry system 2600 shown in FIG. 26 disclosed herein, or other flow cytometer systems (e.g., system 2850 shown in FIG. 28E-1), can carry out the method 2800. Flow cytometry allows for data collection and analysis of data on single cells or particles of a plurality that are in a sample fluid.

In step 2801, the system starts up the flow cytometer. In step 2802, the system checks the performance of the flow cytometer and performs calibration if and as needed with calibration beads. If the flow cytometer was recently calibrated (e.g., same day or same hour), this step can be skipped.

In step 2803, multiple experiments are setup to run to generate spillover vectors for each dye. A reference sample is prepared (fluorochrome conjugated to an antibody that is attached to a cell or a bead) to initially run to generate event vectors that can be converted into a spillover vector.

In step 2804, the reference sample fluid with one fluorochrome is run through the flow cytometer for analysis with the data captured from N detectors being recorded. Multiple runs through the flow cytometer with the same reference sample fluid may be performed to be sure measurements are well understood. The data from N detectors is recorded for each run of the reference sample through the flow cytometer.

In step 2805, after the sample fluid or calibration beads are run through the flow cytometer, the recorded data can be analyzed to determine results from the analysis by the flow cytometer.

Each spillover vector for one fluorochrome can be subsequently compared with another spillover vector for another fluorochrome to determine how different combinations of pairs of fluorochromes (dyes) and markers interact and spectrally interfere. The spillover vectors for each dye can be subsequently combined together into a spillover matrix for a total number and types of dye being used together to identify cells/particles in a single sample. Combinations of pairs of spillover vectors (columns) in the spillover matrix can be compared together to determine a similarity index between the two fluorochromes. For each reference sample, the light intensity density for each channel can saved as a reference vector and the data can be binned and plotted to form a full spectrum signature for the given fluorochrome.

The flow cytometer can also be shut down if no further samples or calibration beads are to be run. Alternatively, another sample or more calibration beads can be run through the flow cytometer to obtain and record (save) data and subsequently analyze the recorded data.

In step 2805, the system performs single stained compensation controls to generate an initial spillover matrix or reference matrix. When performing multicolor flow cytometry, the system uses single stained samples (reference samples) 2810A-210E (collectively referred to by reference number 2810) run through a flow cytometer 100,250 to determine the levels of compensation, such as shown in FIG. 28B. Single staining of the particles 2810A-210E can reveal the respective spectral profile or signature 2812A-212E of respective fluorochromes to the fluorescent photodetectors of the instrument. The information obtained from the single stained particles 2810 can be subsequently used to determine a simplicity index and a complexity index of a set of fluorochromes attached to the particles 2810. The information obtained from the single stained particles 2810 can also be subsequently used to determine a reference full spectrum signature for a fluorochrome useful for unmixing data from a mixed sample labeled with multiple fluorochromes.

The staining of the compensation control usually should be as bright or brighter than the sample. Antibody capture beads can be substituted for cells and one fluorophore conjugated antibody for another, if the fluorescence measured is brighter for the control. The exceptions to this are tandem dyes, which cannot be substituted. Tandem dyes from different vendors or different batches must be treated like separate dyes, and a separate single-stained control should be used for each because the amount of spillover may be different for each of these dyes. Also, the compensation algorithm should be performed with a positive population and a negative population. Whether each individual compensation control contains beads, the cells used in the experiment, or even different cells, the control itself must contain particles with the same level of auto-fluorescence. The entire set of compensation controls may include individual samples of either beads or cells, but the individual samples must have the same carrier particles for the fluorophores. Also, the compensation control uses the same fluorophore as the sample. For example, both green fluorescent protein (GFP) and Fluorescein isothiocyanate (FITC) emit mostly green photons, but have vastly different emission spectra. Accordingly, the system cannot use one of them for the sample and the other for the compensation control. Also, the system must collect enough events to make a statistically significant determination of spillover (e.g., about 5,000 events for both the positive and negative population).

During calibration in a conventional flow cytometer, the system obtains an initial spillover matrix from single stained reference controls. In a conventional flow cytometer, the fluorescence signals (e.g., colors) are separated out into discrete fluorescent bands using a series of edge filters and dichroic mirrors. The system detects (e.g., measures) each individual channel with a photo multiplying tube (PMT). During detection of the fluorescent signals, “spillover” can occur between fluorescent bands, which ideally are completely discrete, such as shown in the combined profile 2826. The system defines the spillover (e.g., spillover 2828 in the combined profile 2826 in FIG. 28C) between the fluorescent bands with a spillover matrix [S].

Alternatively, during calibration in a spectral flow cytometer, the system obtains an initial reference matrix from single stained reference controls 2810. Spectral flow cytometry is a technique based on conventional flow cytometry where a spectrograph and multichannel detector (e.g., charge-coupled device (CCD)) is substituted for the traditional mirrors, optical filters and photomultiplier tubes (PMT) in conventional systems. In the spectral flow cytometer, the side scattered light and fluorescence light is collected and coupled into a spectrograph or coarse wavelength divisional multiplexer (WDM), either directly or through an optical fiber, where the whole light signal is dispersed or demultiplexed and coupled into one or more detector modules with multichannel detectors for detection.

In process step 2804 of FIG. 28A, the sample 2820 shown in FIG. 28C is run through the flow cytometer 100,250. The sample 2820 includes a plurality of marked cells or particles 2822A-222E that flow through each laser beam of each laser and generates fluorescent light and/or scattered light referred to as an event. The fluorescent light and/or scattered light is captured and detected in order to identify the particle and generate counts for the various types of particles in the sample 2820. For each particle in the sample fluid 2810 passing by the laser beam(s) and fluorescing light and/or scattering light, the system generates, obtains, and/or records data (e.g., event data) representing the overall spectral profile 2826. For example, fluoresced cells in the sample fluid flowing through the flow cytometer are detected. An event occurs per particle/cell. Each full spectrum detection of a fluoresced cell by the detector modules excited by the lasers is an event. The event data for a particle/cell may be defined according to a measured sample event vector.

In step 2805, the system generates a compensated sample event vector (for conventional flow cytometer) or an unmixed sample event vector (for spectral flow cytometer) to count the number of various types of cells or particles in a sample 2822 to obtain a measure of concentration. Generally as shown in FIG. 28D, an inverse matrix 2834 (determined from the initial spillover matrix and/or the initial reference matrix with fine adjustments) is used on the event data representing the spectral profile 2826 to generate the compensated sample event vector or the unmixed sample event vector representing separate spectral profiles or signatures 2836A-236E of the various auto-luminescence (generated by the cells or particles themselves) or luminescence given off by the fluorochromes tagged to the various cells 2822A-222E in the sample 2820. For the conventional flow cytometer, the system calculates the compensated event vector based on the initial spillover matrix and the measured sample event vector. For the spectral flow cytometer, the system calculates the unmixed sample event vector based on the initial reference matrix and the measured sample event vector. Additional steps can be taken to obtain even more accurate results using the initial spillover matrix and a reference matrix.

### Full Spectrum Flow Cytometer

Referring now to FIG. 28E (FIGS. 28E-1 and 28E-2), a schematic diagram of a full spectrum flow cytometer 2850 is shown. U.S. patent application Ser. No. 15/659,610 titled COMPACT DETECTION MODULE FOR FLOW CYTOMETERS filed on Jul. 25, 2017, by inventors Ming Yan et al., and U.S. patent application Ser. No. 15/498,397 titled COMPACT MULTI-COLOR FLOW CYTOMETER filed on Apr. 26, 2017, by David Vrane et al. describes further details of flow cytometers and are incorporated herein by reference.

The full spectrum flow cytometer 2850 can be variably configured with different numbers of lasers and different numbers of detector modules. In one embodiment, the full spectrum flow cytometer 2850 can include five lasers (Red 640 nm, Yellow-Green 561 nm, Blue 488 nm, Violet 405 nm, and UV 355 nm) 2851A-2851E and five detector modules 2852A-2852E as shown in FIG. 28E to provide full spectrum analysis. With five detector modules, each of the detector modules (Red, Yellow-Green, Blue, Violet, and UV) 2852A-2852E can be associated with one of the five lasers as shown in FIG. 28E. Each of the five lasers generate laser light of five different wavelengths such as ultraviolet (UV) 355 nm, Violet 405 nm, Blue 488 nm, Yellow Green 561 nm, and Red 640 nm. Equipped with five lasers and five detectors, the full spectrum flow cytometer 2850 can be used to develop multicolor panels with 28 or more colors.

The optical paths of the laser light for each of the five lasers (UV 355 nm, Violet 405 nm, Blue 488 nm, Yellow Green 561 nm, and Red 640 nm) is shown in FIG. 28E. The lasers are spatially separated, each having an independent optical path to the flow cell 2855. One or more optical components 2854, such as mirrors, lenses, and filters, can be used to direct the laser light of each laser into the flow cell 2855 to strike particles/cells in the sample fluid as they pass by an interrogation region.

After striking a particle in the flow cell 2855, the fluorescent light is collected and directed through a plurality of optical fibers 2857 and one or more optical elements (e.g., lenses) 2858 into each of the individual detector modules 252A-2852E. Each of the detector modules 2852A-2852E uses a sequential array of a plurality of avalanche photodiodes (APD) as the photodetectors. The full spectrum flow cytometer 2850 can further include a plurality of scatter detectors, including a forward scatter (FSC) detector 2856A near the flow cell, a blue side scatter detector 2856B near the lens/filters for the red detector module, and a violet side scatter detector 2856C near the lens/filters for the blue detector module. The plurality of scatter detectors are typically used to control data capture by the detector modules in the flow cytometer and data storage in a storage device. Each of the detector modules 2852A-2852E can capture a plurality of raw digital data for a given particle/cell as each laser beam of the plurality of lasers strike the same particle. The plurality of raw digital data is captured at slightly different times (laser delay) as the marked particle/cell passes by each laser beam in the flow channel. For example, the yellow/green laser may first strike the particle generating a first set of raw digital data, the violet laser second generating a second set of raw digital data, the blue laser third generating a third set of raw digital data, the red laser fourth generating a fourth set of raw digital data, and the UV laser lastly generating a fifth set of raw digital data for the same particle. If the plurality of lasers are arranged in a different order along the flow channel, the sequential order of generation of raw digital data by the same particle will be different. While an associated detector module is capturing light from its associated lasers, data from detectors in the other detector modules can be ignored. For example, at the time when the red laser strikes the particle/cell, the data from the red detector module is captured while the data from the UV, violet, yellow green, and blue detector modules can be ignored.

With the addition of the UV laser 2851A and having five detector modules providing sixty-four (64) fluorescence detectors (see FIG. 28G), the full spectrum flow cytometer 2850 has the power to take highly multiplexed assays beyond thirty (30) colors. The incorporation of the UV laser 2851A allows the full spectrum flow cytometer 2850 to perform at a different wavelength and discriminate different colors than those systems without. The UV laser enables the use of UV light excited fluorochromes, such as BUV737 and BUV395 fluorochromes, giving researchers additional flexibility on how they design experiments for a sample of particles.

FIG. 28F illustrates the configuration of each photodetector in each of the five detector modules 2852A-2852E used in the embodiments of a full spectrum flow cytometer 2850. Each detector has a bandpass filter in front of it to filter out light. The bandpass filter allows predetermined wavelengths through to the photo detector for detection while filtering out other wavelengths. The detector number (also referred to herein as channel number) and wavelength information of the bandpass filters associated with each photodetector is shown. The ultraviolet (UV) detector module 2852E has sixteen (16) detectors labeled as channels UV1-UV16 based on their position in the sequential array of detectors in the module. The violet detector module 2852D has sixteen (16) detectors labeled as channels V1-V16 based on their position in the sequential array of detectors in the module. The blue detector module 2852C has fourteen (14) detectors labeled as channels B1-B14 based on their position in the sequential array of detectors in the module. The yellow green detector module 2852B has ten (10) detectors labeled as detector channels YG1-YG10 based on their position in the sequential array of detectors in the module. The red detector module 2852A has eight (8) detectors labeled as detector channels R1-R8 based on their position in the sequential array of detectors in the module.

The multiple lasers in the flow cytometer are slightly spaced apart and sequentially strike the same particle/cell as it flows through the flow channel. This sets up a small amount of time delay between each subsequent laser strike (laser intercept) of the same particle/cell. There is a similar amount of time delay in the respective signal detected by the detectors and the generation of digital data from each laser strike (laser intercept) for the same particle/cell. The small amount of time is referred to as laser delay time and is predetermined by running a quality control experiment (e.g., daily QC runs) before running an experiment with a biological sample or other control. The full spectrum of fluorescence light from each laser striking the particle/cell is sent to each detector module by the fiber optic cables 2857. Based on the laser delay time, the data generated by the detectors from each laser strike (laser intercept) can be associated with a given laser. For example, at one point in time a blue laser strikes the particle/cell and the detectors in the blue detector module can detect fluorescence and generate data for the blue laser strike. After a predetermined laser delay time between blue and red lasers, the same particle is struck by the red laser. Based on the time of the red laser strike, the detectors in the red detector module can detect fluorescence and generate data associated with the red laser strike. The laser delay time between the different lasers can be different but predetermined in order to be able to associate the captured data with the appropriate laser. Furthermore, the arrangement of the lasers can be in a different sequential order such that the sequence of laser strikes can differ. Moreover, the associated laser delay time can differ between laser strikes between power cycles of the flow cytometer. In any case, the data generated by each respective module that is delayed from the first data generated, is aligned together in time and associated with the particle/cell of a single event. The captured data from each detector module may be tagged with a particle/cell number count in the sample run and temporarily stored in a storage device, such as a register, memory or hard drive, for subsequent alignment together as a single event.

Fluorochromes are excited over a wavelength range (excitation wavelength range) associated with the wavelength of the laser and when excited, can emit fluorescence over a different wavelength range (emission wavelength range). The wavelength range of each detector module is associated with the expected emission wavelength range from the excitation of fluorochromes for the associated laser.

With reference to FIG. 28F, the bandpass filter before each detector is used to selectively pass the desirable wavelengths in the pass band range to be detected at a given photo detector for the associated excitation laser. The band bass filter rejects the wavelengths of light outside the pass band range of wavelengths. For example, the first red detector channel (R1 detector channel), the band pass filter has a center wavelength of 661 nanometers (nm) and a bandwidth of 17 nanometers around the center wavelength. Accordingly, in the band pass of wavelengths, a detector can reliably detect a wavelength range around a center wavelength and plus and minus one half the bandwidth. In the case of the R1 detector channel shown in FIG. 28F, the wavelength range is from the center wavelength minus one half the bandwidth (661 nm−8.5 nm=652.5 nm) to the center wavelength plus one half the bandwidth (661 nm+8.5 nm=669.5 nm). In the case of the R8 detector channel, the wavelength range is from the center wavelength minus one half the bandwidth (811.5 nm−17 nm=794.5 nm) to the center wavelength plus one half the bandwidth (811.5 nm+17 nm=828.5 nm). Accordingly, the red detector module detects fluorescent light over a wavelength range from 625 nm to 828.5 nm for fluorescent particles excited by the red laser. The yellow green detector module detects fluorescent light over a wavelength range from 567 nm to 828.5 nm for fluorescent particles excited by the yellow green laser. The blue detector module detects fluorescent light over a wavelength range from 498 nm to 828.5 nm for fluorescent particles excited by the blue laser. The violet detector module detects fluorescent light over a wavelength range from 420 nm to 828.5 nm for fluorescent particles excited by the violet laser. The ultra violet detector module detects fluorescent light over a wavelength range from 365 nm to 828.5 nm for fluorescent particles excited by the ultra violet laser. This detection range includes the full visible light (electromagnetic) spectrum from 380 nm to 780 nm, a portion (365 nm to 379 nm) of the non-visible UV light spectrum, and a portion (781 nm to 828.5 nm) of the non-visible infrared light spectrum.

If even more than 64 detectors are used, an increased granularity in the data at various wavelengths can be captured. The compactness of photo detectors (e.g., avalanche photodiodes) and the detector array in the detector module has led to embodiments of up to 64 detectors and can lead to a further increase in the numbers of available detectors. A larger number of detectors can lead to increased numbers of colors that can be detected (discriminated) and an increased number of fluorochromes that can be used to examine particles within a single sample by a single run through a flow cytometer. The use of compact photodetectors in a compact photo detector array as the detector modules in the full spectrum flow cytometer 2850 has improved the efficiency of running samples through a flow cytometer and examining the resultant data.

While a single particle has been described passing through each laser, a sample fluid run through a flow cytometer can have thousands of cells/particles per micro liter with hundreds of thousands or more of particles in a sample fluid size of hundreds of microliters (e.g., 500,000 particles in a 500-microliter sample size). The same sample can have different types of cells with hundreds of thousands or more. With a multi-color experiment, different fluorochromes are attached to different particles/cells to count different types of particles in the same sample. In a single run through the flow cytometer, the intensity and wavelength of each color of fluorescent light generated by the excited fluorochrome on the labeled cells can be detected and plotted on a chart by wavelengths to indicate the spectrum of light captured by the sample run. Furthermore, the intensity of fluorescent light for each given color/detector channel can be binned into count ranges with the particle count falling into these ranges being summed up together and plotted on the chart to show the particle cell density for the wavelengths of light.

In FIG. 28E, the charts 2860A-2860E of data, normalized intensity (Y axis) versus wavelength (X axis), represents the range of light spectral components captured by each respective detector module for all events (each cell passing through the lasers) in a sample, such as a reference control with a single fluorochrome being used to generate a reference full spectrum signature. In FIG. 28G, the raw channel data captured for each detector module 2852A-2852E can respectively be plotted, based on the detector channel number, as a portion (individual detector module spectrum signature) 2861A-2861E of a full spectrum (spectral) signature of the sample run. In the plots of the individual detector module spectrum signature portions 2861A-2861E associated with each color laser 2851A-2851E and associated detector module 2852A-2852E pairing, the intensity (Y axis) and binned density count are plotted as a function of the detector channel number (X axis). Each of the individual detector module spectrum (spectral) signatures is formed out of a channel spectrum signature, such as channel spectrum signature 2865 for the detector module spectrum (spectral) signature 2861D for example.

The channel spectrum signature is plotted based on a plurality of binned intensity levels and the particle counts within those bins. For example, the greatest count (highest density) at the binned intensity level range for the channel is given a first color (e.g., red) located at the center intensity level range 2866 of the channel spectrum signature 2865. For each channel spectrum signature, the other binned intensity levels are either above 2867P, 268P, 269P or below 2867M, 268M, 269M the center intensity level 2866 having the greatest particle/cell count. The second intensity levels 2867P,267M respectively just above 2867P and below 2867M the center intensity level 2866 are assigned a second color differing from the first color of the center intensity level. The third intensity level 2868P above the second and center intensity levels and the third intensity level 2868M below the second and center intensity levels are assigned a third color differing from the first and second colors. The fourth intensity level 2869P above the third, second, and center intensity levels and the fourth intensity level 2869M below the third, second and center intensity levels are assigned a fourth color differing from the first, second, and third colors. In this manner, intensity density information can be communicated to the user for a given detector channel.

After generating plots of the individual detector module spectrum (spectral) signatures 2861A-2861E, the plots of the individual detector module spectrum (spectral) signatures can then be merged together. In FIG. 28G, the individual detector module spectrum (spectral) signatures 2861A-2861E are merged together along an X axis of detector channel number to form a plot of a full spectrum (spectral) signature 2862 of the exemplary sample run through the full spectrum flow cytometer. Along the X axis, from right to left, are the red detector module spectrum signature 2861A, the yellow green detector module spectrum signature 2861B, the blue-detector module spectrum signature 2861C, the violet detector module spectrum signature 2861D, and the ultraviolet detector module spectrum signature 2861E merged together forming the full spectrum signature for a given sample run. Different labeled samples run through the flow cytometer 2850, will generate different detector module signatures and accordingly different merged full spectrum (spectral) signatures. Single stained control samples (reference controls) are run through the full spectrum flow cytometer used to determine the full spectrum signature of each fluorochrome before being used with other fluorochromes to label a particle/cell in a mixed sample of a plurality of particles/cells.

Instead of just looking at peak intensity levels, the full spectrum signature for one fluorochrome can be used to distinguish from noise and another fluorochrome having a different full spectrum signature. Detecting light intensity over the full spectrum is an advantage of a full spectrum flow cytometer over that of a conventional flow cytometer that just looks at peak intensity levels. When a conventional flow cytometer shows overlap in the spectrum plots of fluorescent dies, the full spectrum signatures of each when run through a full spectrum flow cytometer can be distinguishable. In planning an experiment, it is desirable to select different fluorochromes that can be distinguishable from each other by their full spectrum signatures. Fluorochromes with similar emission but different spectral signatures can be distinguished from each other. The mathematical method to differentiate between multiple fluorophores (mixed fluorescent light) is called spectral unmixing and results in an unmixing matrix that is applied to the captured data of the sample.

Particles/cells may auto-fluoresce (autofluorescence) when struck by the five lasers and have its own full spectrum signature. Accordingly, the autofluorescence of the various particles/cells can also be unmixed, based on the autofluorescence full spectrum signature, and be used to distinguish it from other particle/cell types and the fluorochrome attached to other cells in a mixed sample.

### Optimized Multicolor Immunofluorescence Panel (OMIP)

A 28 color Optimized Multicolor Immunofluorescence Panel (OMIP) is illustrated in FIG. 29. The 28 color OMIP was developed using a full spectrum five laser cytometer as in embodiments of the invention. Markers are listed in the SPECIFICITY columns and corresponding fluorochromes are listed under the FLUOROCHROME columns. Markers and fluorochromes are further grouped under the laser that will optimally excite the fluorochrome.

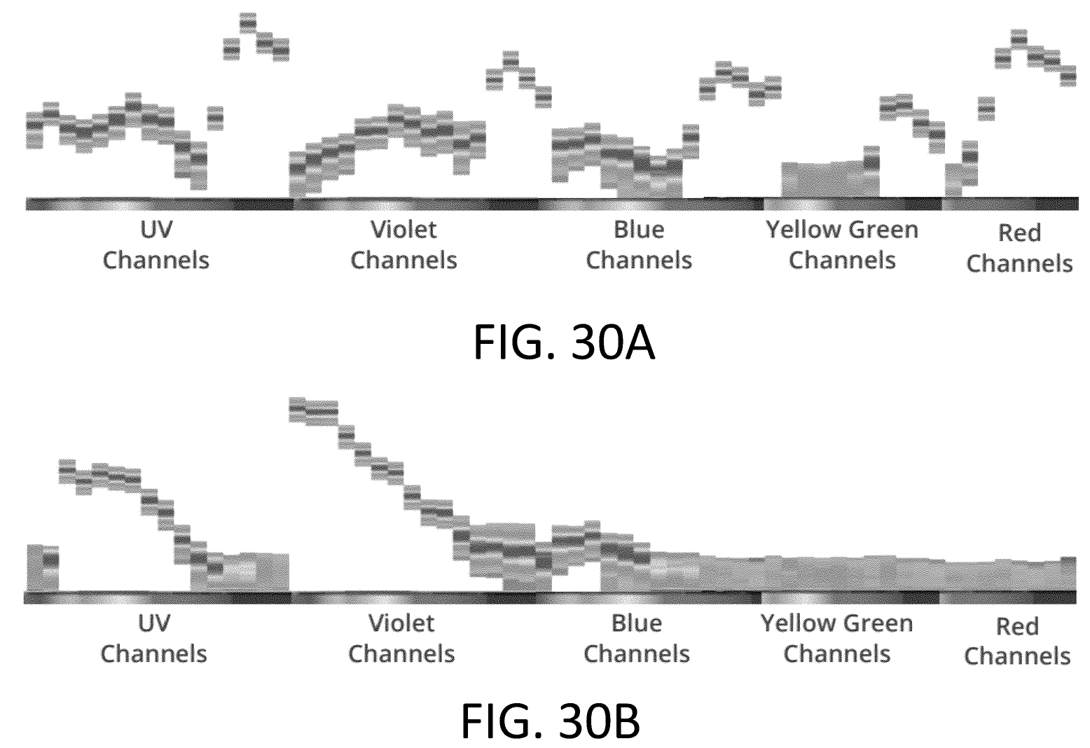

The UV lasers adds an additional 16 fluorescence channels over the full emissions spectra, allowing the invention to extract even more information from each fluorochrome. The full spectrum signature of BV737 and BV 421 are respectively shown in FIGS. 30A and 30B respectively. In this example, 16 UV channels gives the BV421 spectrum signature a whole new look. The UV laser allows for a more defined spectrum, allowing for more fluorochromes to be used in the same sample tube minimizing color bleed.

### Configurable Flow Cytometer.

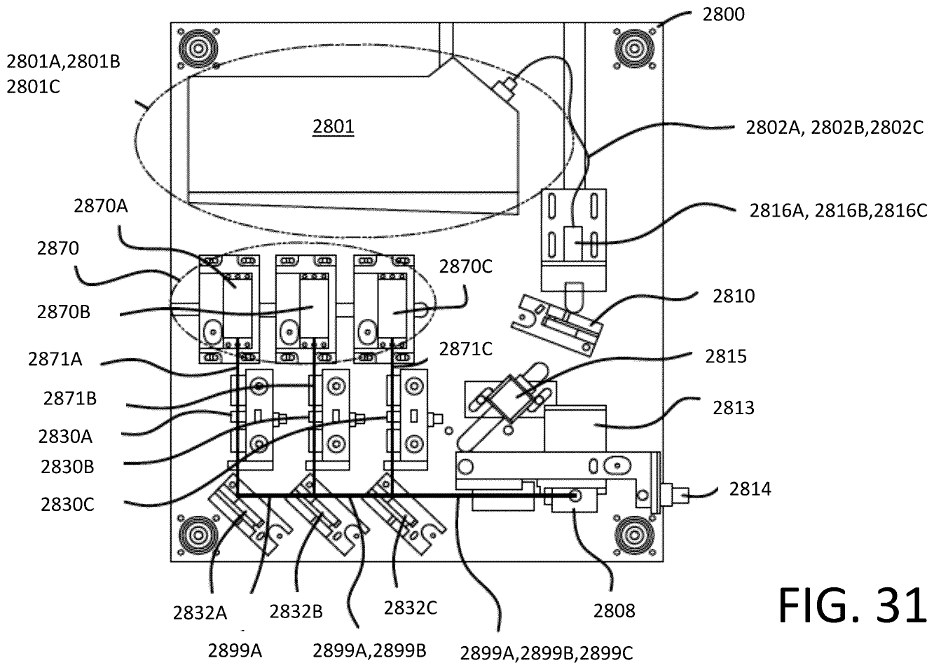

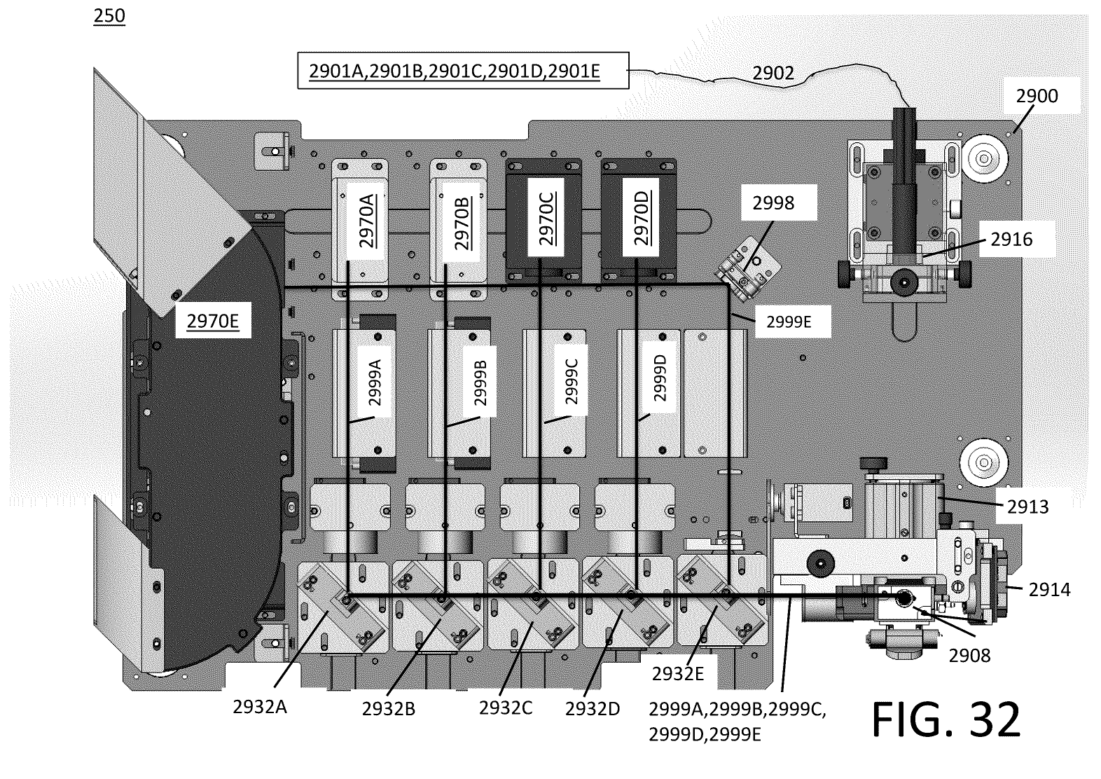

Referring now to FIGS. 31 and 32, a portion of the optical analysis system of modular flow cytometers are shown. The top view of an optical plate assembly 3100,3200 in a modular configurable flow cytometry system is shown. A modular configurable flow cytometer system is configurable in that different combinations of numbers of lasers (e.g., 1, 2, 3, 4, 5) and numbers of detectors (e.g., 14, 16, 22, 30, 32, 38, 48, 54, 64, 128, 256) can be chosen and installed in the flow cytometer. A flow cytometer can be configured with a combination of one, two three, four, five (5) or more lasers and fourteen, sixteen, twenty-two, thirty, thirty-eight, forty-eight, fifty-four, sixty-four (64) or more detectors. With four or more lasers and forty-eight or more detectors, a flow cytometer can act as a full spectrum flow cytometer capturing more electromagnetic spectra than that of a three laser and a thirty-eight-detector configuration.

FIG. 31 shows a top view of an optical plate assembly 3100 for a modular flow cytometry system 100. The optical plate assembly 3100 includes a laser system 3170 having three semiconductor lasers 3170A,3170B,3170C that direct excitation into a flow cell assembly 3108 where a sample fluid flows with sample particles. The laser system 3170 attempts to direct the multiple (e.g., three to five) laser beams in a parallel manner toward the flow cell assembly 3108. The multiple laser beams are slightly offset from one another. The laser system 3170 includes semiconductor lasers 3170A,3170B,3170C. The semiconductor laser generate laser beams having different wavelengths, such as 405 nanometers (nm), 488 nm, and 640 nm for example. The output power of the semiconductor lasers can differ as well. For example, a 405 nm semiconductor laser can generate a laser beam that with an output power that is usually larger than 30 milliwatts (mW). The output power of a 488 nm semiconductor laser is usually greater than 20 mW. The output power of a 640 nm semiconductor laser is usually greater than 20 mW. Controller electronics in the flow cytometer control the semiconductor lasers to operate at a near constant temperature and a near constant output power.

An optical system spatially manipulates the optical laser beams 3171A,3171B,3171C generated by the semiconductor lasers 3170A,3170B,3170C respectively. The optical system includes lenses, prisms, and steering mirrors to focus the optical laser beams onto a fluidic stream carrying biological cells (bio cells). The focused optical laser beam size is typically focused for 50-80 microns (μm) across the flow stream and typically focused for 5-20 μm along the stream flow in the flow cell assembly 3108.

In FIG. 31, the optical system includes beam shapers 3130A-3130C that receive the laser light 3171A,3171B,3171C from the semiconductor lasers 3170A-3170C, respectively. The laser light output from the beam shapers 3130A-3130C are coupled into mirrors 3132A-3132C respectively to direct the laser light 3199A,3199B,3199C towards and into the flow cell assembly 3108 to target particles (e.g., biological cells) stained with a dye of fluorochromes. The laser light 3199A,3199B,3199C is slightly separated from each other but directly substantially in parallel by the mirrors 3132A-3132C into the flow cell assembly 3108.

The laser light beams 3199A,3199B,3199C strike the particles/cells as they pass by in the flow stream in the flow cell assembly 3108. The laser light beams 3199A,3199B,3199C are then scattered by the particles/cells in the flow stream causing the fluorochromes to fluoresce and generate fluorescent light, and the particles/cells to autofluorescence. A forward scatter diode 3114 gathers on-axis scattered light. A collection lens 3113 gathers the off axis scattered light and the fluorescent light and directs them together to a dichromatic mirror 3110. The dichromatic mirror 3110 focuses the off axis scattering light onto a side scatter diode 3115. The dichromatic mirror 3110 focuses the fluorescent light onto at least one fiber head 3116. At least one fiber assembly 3102 routes the fluorescent light toward at least one detector module 3101.

For a more detailed analysis of a biological sample using different fluorescent dyes and lasers wavelengths, multiple fiber heads 3116,3216, multiple fiber assemblies 3102,3202 and multiple detector modules 3101,3201 can be used. For example, three or more fiber heads can be used (e.g., see FIG. 31 with three, and FIG. 32 with five) with three or more detector modules associated with three or more lasers.

FIG. 31 shows three fiber heads 3116A,3116B,3116C situated in parallel to receive the fluorescent light and three fiber assemblies 3102A,3102B,3102C can be used to direct the fluorescent light to three detector modules 3101A,3101B,3101C (only one of which is shown in FIG. 31). The first detector module 3101A is located on the optical plate 3100 while the other detector modules are located on a different level. The three fiber heads 3116A,3116B,3116C (and three fiber assemblies 3102A,3102B,3102C) for the three different detector modules paired with the three laser light beams 3199A,3199B,3199C which are slightly offset from each other (e.g., not precisely co-linear). Accordingly, three fiber heads 3116A,3116B,3116C can collect light beam data separately fluorescent light generated by the three laser light beams 3199A,3199B,3199C, having three different wavelengths to excite fluorochromes. The three fiber assemblies 3102A,3102B,3102C then direct light into three different detector modules (e.g., three different detector modules 3101A, 3101B, 3101C), one of which is located on the optical plate 3100 with others located below the optical plate on a lower level of the flow cytometer.

FIG. 32 shows an optical plate 3200 for a full spectrum flow cytometer having a configuration of five lasers and five detector modules with sixty-four photodetectors. The optical plate 3200 has some similar elements to the optical plate 3100. The optical plate 3200 has five fiber heads 3216 for five detector modules (detector modules located off the optical plate). The optical plate 3200 has five lasers 3270A-3270E, one of which is a violet laser 3270D and another one of which is a UV laser 3270E, for exciting and detecting light over the full visible spectrum, including a portion of the UV wavelength spectrum. The laser light beams 3299A,3299B,3299C,3299D are generated in parallel by the lasers 3270A,32070B,32070C,3270D. The UV laser light beam 3299E is generated by the UV laser 3270E spaced apart and initially perpendicular to the laser beams 3299A,3299B,3299C,3299D. The UV laser light beam 3299E is reflected by a first mirror 3298 on the optical plate and directed to run in parallel to the laser beams 3299A-3299D generated by the respective lasers. The mirrors 3232A,3232B,3232C,3232D,3232E respectively receive the laser beams 3299A-3299E along their parallel but different paths, and reflect the laser beams to the flow cell assembly 3208 spaced apart in parallel along the same path.

The optical plate 3200 includes a forward scatter detector 3214 that gathers on-axis scattered light from the particles/cells. A collection lens 3213 coupled to the flow cell assembly 3208 gathers the off axis scattered light, the fluorescent light, the auto fluorescent light and directs them together to the fiber heads 3216.

The violet and UV lasers and violet and UV detectors differ from the lasers and detectors of the flow cytometer with the optical plate 3100. The violet and UV detector modules have more photodetectors and therefore detect a wider range of wavelengths of fluorescence light when violet and UV lasers strike a particle/cell. With the UV laser 3270E on the optical plate 3200, the detector modules 3201A,3201B,3201C,3201D,3201E (collectively referred to as detector modules 3201) are moved off the optical plate 3200. With a plurality of fiber assemblies 3202 and fiber heads 3216, the light from the flow cell 3208 can be directed into the plurality of different detector modules 3201 in different locations of the flow cytometer.

Not only can the excitation be modular (and configurable) in a modular flow cytometry system, but the detection can also be modular. The modular flow cytometry system can also use one or more detector modules 3101,3201 to collect the light beam data. For example, one or more fiber assemblies can direct light from a flow cell into one or more differing detector modules with different arrays of photodetectors and bandpass filters. For full spectrum signatures, a plurality of (four or more) different detector modules can be used. With the selection of detector modules, the total number of photo detectors (e.g., 16, 32, 64, 128) can differ. The differing detector modules may use different numbers of photodetectors to capture light. Generally, the more detectors one has, the more data can be analyzed, and the increased spectral resolution can be achieved.

With a spectral flow cytometer, separation of the light beam data in a mixed sample is handled as a data processing operation over the different detector modules and their respective detectors. The data processing operations can be somewhat complex because separation of the light beam data requires more data manipulation (e.g., identifying different wavelengths and separating light beam data accordingly).

Cell geometric characteristics can be categorized though analysis of the forward and side scattering data. The cells in the fluidic flow are labeled by dyes of visible wavelengths ranging from 400 nm to 900 nm or dyes that fluorescent with ultraviolet non-visible wavelengths when excited by an ultraviolet laser. When excited by lasers, the dyes produce fluorescent light, which are collected by the fiber assembly and routed toward a detector module. The modular flow cytometry system maintains a relatively small size, partly with the optical plate assembly using compact semiconductor lasers in the visible spectrum, a multipower collection lens 3113,3213, and compact image detector arrays in the detector modules. That is, the collection lens 3113,3213 contributes to the design of the compact detector modules.

The collection lens can have a short focal length for its multipower factor (e.g., 11.5X power). The collection lens, an objective lens, has a high numerical aperture (NA) facing the fluorescence emissions to capture more photons in the fluorescence emissions over a wide range of incident angles. The collection lens has a low NA of about facing the fibber head and its collection fiber to launch the fluorescent light into the fiber over a narrow cone angle. Accordingly, the collection lens converts from a high NA on one side to a low NA on the opposite side to support a magnification M in the input channel of each detector module.

The diameter of the core of the collection fiber assembly is between about 400 μm and 800 μm, and the fiber NA is about 0.12 for a core diameter of about 600 μm. The fiber output end can be tapered to a core diameter of between about 100 μm and 300 μm for controlling the imaging size onto the receiving photodiode.

The input end of the collection fiber can also include a lensed fiber end to increase the collection NA for allowing use of a fiber core diameter that is less than about 400 μm. Because the collection fiber has the flexibility to deliver the light anywhere in the flow cytometer system, the use of fiber for fluorescence light collection enables optimization of the location of the receiver assembly and electronics for a compact flow cytometer system.

To manufacture a low-cost flow cytometer, lower cost components can be introduced. An image array in each detector module can be formed out of a solid transparent material to provide a detector module that is reliable, low cost, and compact. Furthermore, the flow cytometer can use low cost off the shelf components, such as thin outline (TO) can photodetectors in the detector modules.

The design of a flow cytometer can bring flexibility in selecting fluorochromes for labeling biological cells and particles. Full spectrum cytometry has the advantage of detecting the full spectrum signature for each fluorochrome with a full spectrum flow cytometer with at least five lasers and at least 64 detectors. Almost any commercially available fluorochrome can be excited by the lasers of a full spectrum flow cytometer.

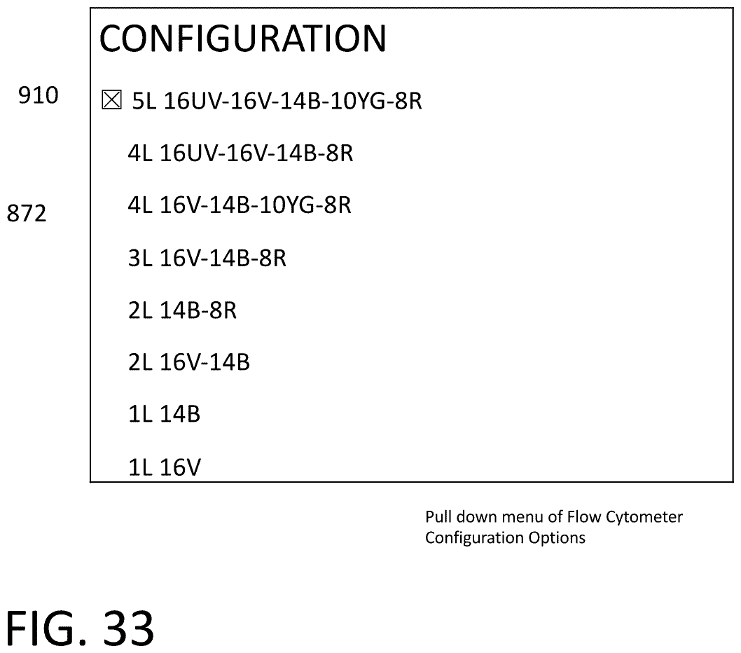

FIG. 33 illustrates a plurality of configurations 3372 that can be selected for forming the modular flow cytometer. A checkmark 3310 illustrates the configuration of 5L 16UV-16V-15B-10YG-8R. The number in front of L indicates the number of lasers in the modular flow cytometer. For the configuration of 5L, there are five lasers present in the modular flow cytometer with the different lasers of the different wavelengths. The number in front of the UV indicates the number of ultra-violet detectors over the UV channels of wavelengths. The number in front of the V indicates the number of violet detectors over the violet channels of wavelengths. The number in front of the B indicates the number of blue detectors over the blue channels of wavelengths. The number in front of the YG indicates the number of yellow-green detectors over the yellow-green channels of wavelengths. The number in front of the R indicates the number of red detectors over the red channels of wavelengths.

The emission channels are related to the expected wavelengths of light that the fluorochromes fluoresce. From left to right, the emission channels can include ultraviolet channels UV1-UV16; violet channels V1-V16; blue channels B1-B14; yellow-green channels YG1-YG10; and red channels R1-R8. With fewer lasers and fewer detectors, the channels can decrease. With more lasers and more detectors, the number of channels can increase.

FIG. 34A illustrates a block diagram of a computing system 3400 that can execute the software instructions to control a flow cytometer and/or interface to a cloud server through a computer network. The computing system 3400 can execute a web browser to graphically display a graphical user interface (GUI) 2400 to assist a user in selecting fluorochromes that can be used together with the full spectrum (spectral) flow cytometer in its various configurations.

FIG. 34B is a block diagram illustrating the computing system 3400 coupled to a remote computer server 3489 over the cloud or internet 3488. Monitor 3402 illustrates a GUI window 2400 generated by the server 3489 and displayed by the computing system 3400. The server 3489 is in communication with a database 3490 that stores information about the available fluorochromes for use with various configurations of a flow cytometer. The information is determined by running each fluorochrome as a reference sample alone through the flow cytometer. A spillover over vector for each fluorochrome is added into a spillover matrix stored in the database 3490. A user can then access the database and select one or more fluorochromes with their underlying data and have graphs charted and the similarity indexes and the complexity index determined.

In one embodiment, the computing system 3400 includes a computer 3401 coupled in communication with a graphics monitor 3402, and one or more input devices, such as a mouse pointer 3403 and a keyboard text entry device 3404. The computer 3401 can couple to other external devices through a plurality of network interfaces 3461A-3461N, a plurality of radio transmitter/receivers (transceivers) 3462A-3462N; and a parallel serial I/O interface 3460.

In accordance with one embodiment, the computer 3401 can include one or more processors 3410, memory 3420; one or more storage drives (e.g., solid state drive, hard disk drive) 3430,3440; a video input/output interface 3450A; a parallel/serial input/output data interface 3460; a plurality of network interfaces (network interface controllers) 3461A-3461N; a plurality of radio transmitter/receivers (transceivers) 3462A-3462N. The graphics monitor 3402 can be coupled in communication with the video input/output interface 3450.

The data interface 3460 can provide wired data connections, such as one or more universal serial bus (USB) interfaces and/or one or more serial input/output interfaces (e.g., RS232). The data interface 3460 can also provide a parallel data interface. The plurality of radio transmitter/receivers (transceivers) 3462A-3462N provide wireless data connections such as over WIFI, Bluetooth, and/or cellular. The one or more audio video devices can use the wireless data connections or the wired data connections to communicate with the computer 3401.

The computer 3401 and computing system 3400 can interface with an remote computer server 3489 in the cloud over the internet 3488 through one or more of the plurality of network interfaces 3461A-3461N and/or the plurality of radio transmitter/receivers (transceivers) 3462A-3462N. Each of these network interfaces can support one or more network connections.

One or more computing systems 3400 and/or one or more computers 3401 (or computer servers) can be used to perform some or all of the processes disclosed herein. The software instructions that perform some of the functionality described herein, are stored in the storage device 3430,3440 and loaded into memory 3420 when being executed by the processor 3410.

In one embodiment, the processor 3410 executes instructions residing on a machine-readable medium, such as the hard disk drive 3430,3440, a removable medium (e.g., a compact disk 3499, a magnetic tape, etc.), or a combination of both. The instructions may be loaded from the machine-readable medium into the memory 3420, which may include Random Access Memory (RAM), dynamic RAM (DRAM), etc. The processor 3410 may retrieve the instructions from the memory 3420 and execute the instructions to perform operations described herein.

### END NOTES

The embodiments of the invention are thus described. While embodiments of the invention have been particularly described, they should not be construed as limited by such embodiments, but rather construed according to the claims that follow below. While certain exemplary embodiments have been described and shown in the accompanying drawings, it is to be understood that such embodiments are merely illustrative of and not restrictive on the disclosed embodiments, and that the disclosed embodiments are not limited to the specific constructions and arrangements shown and described, since various other modifications may occur to those ordinarily skilled in the art.

While this specification includes many specifics, these should not be construed as limitations on the scope of the disclosure or of what may be claimed, but rather as descriptions of features specific to particular implementations of the disclosure. Certain features that are described in this specification in the context of separate implementations may also be implemented in combination in a single implementation. Conversely, various features that are described in the context of a single implementation may also be implemented in multiple implementations, separately or in sub-combination. Moreover, although features may be described above as acting in certain combinations and even initially claimed as such, one or more features from a claimed combination may in some cases be excised from the combination, and the claimed combination may be directed to a sub-combination or variations of a sub-combination. Accordingly, the claimed invention is limited only by patented claims that follow below.

1-93. (canceled)

94. A computer network comprising:
a cloud server in communication with a wide area network, the cloud server including a processor at least one processor, a memory, and a storage device to execute web based applications associated with flow cytometry and provide a plurality of web pages to web browsers to prepare and carry out one or more biology experiments with one or more flow cytometers and store results therefrom;
a unified aggregated database coupled in communication with the cloud server, the unified aggregated database storing user data and information for the cloud server to prepare and carry out the one or more biology experiments with the one or more flow cytometers and store the results therefrom; and
at least one client device coupled in communication with the cloud server over the wide area network to receive the plurality of web pages, the at least one client device including at least one processor, a memory, a display device, and an input/output device, the at least one processor to execute a web browser to display a series of one or more of the plurality of web pages on the display device received from the cloud server in a flow cytometry graphical user interface window including information to prepare the one or more biology experiment,
wherein the series of web pages of the flow cytometry graphical user interface window comprising a panel builder wizard to provide the information and to receive a sequence of user data to generate a multi-color panel for the one or more biology experiments for a preselected configuration of a flow cytometer, wherein the generated multi-color panel is stored in the unified aggregated database.

95. The computer network of claim 94, wherein:
at least one of the one or more flow cytometers is a spectral flow cytometer.

96. The computer network of claim 95, wherein:
a last web page of the panel builder wizard includes an export option to export the generated multi-color panel to an experiment builder; and
at least one of the plurality of web pages displayed on the display device is the experiment builder to generate and display a biology experiment template based on the preselected configuration of the spectral flow cytometer and the generated multi-color panel.

97. The computer network of claim 94, further comprising:
at least one spectral flow cytometer coupled in communication with the cloud server over the wide area network to receive the one or more biology experiments associated with the generated multi-color panel, the at least one spectral flow cytometer having the preselected configuration associated with the one or more biology experiments, the at least one spectral flow cytometer to execute the one or more biology experiments on a biology sample having a plurality of biological cells to obtain event results associated with the one or more biology experiments, the at least one spectral flow cytometer to transmit the event results to the cloud server for storage in the unified aggregated database associated with the generated multi-color panel and the one or more biology experiments.

98. The computer network of claim 97, wherein:
the at least one spectral flow cytometer is a full spectrum flow cytometer.

99. The computer network of claim 98, wherein:
the at least one user interface displayed by the at least one client device requests the cloud server perform a data analysis on stored event results; and
the cloud server recalls the stored event results associated with the one or more biology experiments from the unified aggregated database and performs data analysis on the stored event results under direction of the at least one client device and displays results of the data analysis on the display device of the at least one client device.

100. The computer network of claim 99, wherein:
the at least one processor of the cloud server executes a data analysis software application to perform the data analysis on the stored event results stored in the unified aggregated data base and display them in the flow cytometer graphical user interface window displayed on the display device of the at least one client device.

101. The computer network of claim 94, further comprising:
at least one laboratory equipment; and
a lab computer coupled in communication with the least lab equipment and the cloud server over the wide area network, the lab computer having a processor executing instructions for an instrument cloud account coupling the least one laboratory equipment in communication with the cloud server over the wide area network to synchronize data and information regarding the at least one laboratory equipment stored in the unified aggregated data base in order to support flow cytometry biology experiments with a flow cytometer or cell sorter (sorting flow cytometer).

102. The computer network of claim 101, wherein:
the generated multi-color panel and the biology experiment are generated with a first user account; and
the generated multi-color panel and the biology experiment are shared with a second user account to read and run the biology experiment with the flow cytometer to obtain event results with a biological sample.

103. The computer network of claim 102, wherein:
the cloud server communicates with the computer associated with the at least one lab equipment to download the generated multi-color panel and the biology experiment to the computer associated with the at least one lab equipment to prepare the biology experiment.

104. The computer network of claim 102, wherein:
the cloud server to upload the generated multi-color panel and biology experiment to the at least one lab equipment to prepare the biology experiment.

105. The computer network of claim 104, wherein:
the at least one lab equipment to upload the event results of the biology experiment to the cloud server for data analysis.

106. The computer network of claim 102, wherein:
the wide area network is a world wide web network;
the cloud server is located in a data center coupled in communication with the world wide web network;
the at least one laboratory equipment is remotely located in a laboratory coupled in communication with the world wide web network to communicate with the cloud server; and
the at least one client device is remotely located and coupled in communication with the world wide web network to communicate with the cloud server.

107. A computer server for preparing biology experiments for laboratory equipment, the computer server comprising:
at least one microprocessor to execute software instructions;
at least one memory device coupled to the at least one microprocessor to store software instructions for execution by the at least one microprocessor;
a network interface device coupled to the at least one microprocessor to couple the computer server in communication with a wide area network, wherein the wide area network is a world wide web network; and
a storage drive coupled to the at least one microprocessor, the storage drive to store at least portions of a unified aggregated data base for a flow cytometry lab equipment network and a plurality of software instructions for flow cytometer server applications executed by the at least one microprocessor, the flow cytometer server applications including
a periodic downloader to periodically search the world wide web network for suppliers of chemicals and reagents for flow cytometer biology experiments, the periodic downloader to download specifications and information regarding a plurality of reagent antibodies and a plurality of fluorochromes used in the flow cytometer biology experiments, wherein the information includes a supplier name, an ordering name or number, and a uniform resource locator (URL) or internet protocol (IP) address to order the respective reagent antibody and/or fluorochrome, and
a specification translator in communication with a periodic web crawler and the unified aggregated data base, the specification translator to translate the specifications of the plurality of reagents into a universal reagent specification format and store the translated specifications of the plurality of reagents into the unified aggregated data base, the specification translator to further translate the specifications of the plurality of fluorochromes into a universal fluorochrome specification format and store the translated specifications of the plurality of fluorochromes into the unified aggregated data base.

108. The computer server of claim 107, wherein:
the periodic downloader periodically downloads specifications and information regarding a plurality of buffer chemicals, wherein the information includes a supplier name, an ordering name or number, and a uniform resource locator (URL) or internet protocol (IP) address to order the respective buffer chemical; and
the specification translator to further translate the specifications of the plurality of buffer chemicals into a universal buffer specification format and store the translated specifications of the plurality of buffer chemicals into the unified aggregated data base.

109. The computer server of claim 107, wherein the flow cytometer server applications further include:
a flow cytometer multicolor panel builder to generate a flow cytometer multicolor panel based on user selected cell surface markers specifying reagent antibodies that attach to the cell surface marker, user selected fluorochrome requirements, and a full spectrum flow cytometer configuration, wherein the generated flow cytometer multicolor panel includes a plurality of user selected cell surface markers, a plurality of reagents associated with the user selected cell surface markers, and a plurality of automatically chosen fluorochromes associated with the plurality of reagents.

110. The computer server of claim 109, wherein the flow cytometer server applications further include:
a flow cytometer spectrum viewer to generate a chart, for display on a display device, of spectral signatures of all of the chosen fluorochromes in the generated flow cytometer multicolor panel, wherein the chart displays normalized intensity versus detector channel for plots of each spectral signature of all the chosen fluorochromes.

111. The computer server of claim 109, wherein the flow cytometer server applications further include:
an experiment editor to receive the generated flow cytometer multicolor panel and form an experiment template for the configuration of the full spectrum flow cytometer based on the generated multicolor panel, wherein the experiment template indicates calibration test tubes and sample test tubes with the respective reagents and the respective fluorochromes run through the configuration of the full spectrum flow cytometer.

112. The computer server of claim 111, wherein the flow cytometer server applications further include:
an auto populator executed in a background process instead of a foreground process to receive one or more user changes and calculate output results in real time based on the one or more user changes, and populate the one or more user changes and respective output results to each of the flow cytometer server applications so that output results can be displayed in real time in an interactive graphical user interface.

113. The computer server of claim 110, wherein the flow cytometer server applications further include:
an experiment editor to receive the generated flow cytometer multicolor panel and form an experiment template for the configuration of the full spectrum flow cytometer based on the generated multicolor panel, wherein the experiment template indicates calibration test tubes and sample test tubes with the respective reagents and the respective fluorochromes run through the configuration of the full spectrum flow cytometer.

114. The computer server of claim 113, wherein the flow cytometer server applications further include:
an auto populator software application executed in a background process instead of a foreground process to receive one or more user changes, to calculate output results in real time based on the one or more user changes, and to populate the one or more user changes and respective output results to each of the flow cytometer server applications so that output results can be displayed in real time in an interactive graphical user interface.
